(19) United States
(12) Patent Application Publication
(10) Pub. No.: US 2004/0236598 A1
(43) Pub. Date: Nov. 25, 2004

(54) System and method for providing occupational information

(76) Inventor: David J. Thomsen, Newport Beach, CA (US)

Correspondence Address: PERKINS COIE LLP, PATENT-SEA, P.O. BOX 1247, SEATTLE, WA, 98111-1247, US

(21) Appl. No.: 10/806,044

(22) Filed: Mar. 22, 2004

Related U.S. Application Data
(60) Provisional application No. 60/456,838, filed on Mar. 21, 2003.

(51) Int. Cl. G06F 17/60

(52) U.S. Cl. 705/1

(57) ABSTRACT

A system and method for providing occupational information provides users with access to occupational information. The system includes a raw data storage component by which job descriptions, job titles, job-related skills, job demands, and other work measures are collected, analyzed, and reported. The system also includes a job availability component where counts of specific jobs are created and maintained. The system collects data from multiple sources including end-user applications running on client computers and server applications running on peripheral servers. The system may also collect data from other sources associated with occupational information. Use of the system may result in the system being updated.

### CROSS-REFERENCE TO RELATED APPLICATIONS

The present application claims priority to commonly assigned U.S. Provisional Patent Application No. 60/456,838, filed Mar. 21, 2003, which is herein incorporated in its entirety by reference.

The present application is related to U.S. patent application Ser. No. 09/849,455, filed May 4, 2001, and U.S. patent application Ser. No. 09/849,454, filed May 4, 2001, both herein incorporated in their entirety by reference.

### BACKGROUND

During the Depression of the 1930s, the United States Government employed job analysts who visited American businesses to identify and describe over 17,000 specific jobs. This effort resulted in a collection of job descriptions entitled the “Dictionary of Occupational Titles” (“DOT”). In 1965 the DOT was enhanced to include seventy-two work measures and fields, and it was last fully updated in the 1970s (with modest updates up until 1991). Since then, the DOT has been replaced by the U.S. Government's O*NET-SOC database in which many thousands of specific jobs are compressed into 950 job categories or “job families” and made available to the public. Typically, data used to feed the O*NET-SOC database and similar systems is obtained by surveying job incumbents who answer questions in a paper-based format. The information on paper is compiled manually into published norms.

While such “read only” job data systems are, in some ways, an improvement over the outdated and superceded DOT, their use of wide-sweeping “job families” prevents them from providing specific job information, such as job content information or incumbent counts. Moreover, such systems lack effective mechanisms for keeping job data up-to-date. In addition, such systems have failed to address the changing nature of the American workplace. Further, the existing job data systems lack techniques for bringing a community of professional users (e.g., job analysts, counselors, and managers assisting employees in a career transition, those engaged in disability determinations, etc.) into a common communication. Many other problems exist with the existing systems.

### BRIEF DESCRIPTION OF THE DRAWINGS

FIG. 1 is a block diagram showing an example of a system on which the invention can be implemented in one embodiment.

FIG. 2 is a block diagram showing a conceptual view of the system of FIG. 1 and the flow of data throughout the system.

FIG. 3 is a block diagram showing an example of the client computer of FIG. 1 in one embodiment.

FIG. 4 is a display diagram showing an example of the various sources of information for feeding the system of FIG. 1 in one embodiment.

FIG. 5 is a flow diagram showing an example of a process or routine performed by the client computer application of FIG. 3.

FIG. 6 is a display diagram showing various data elements of the system of FIG. 1.

FIG. 7 is a display diagram showing a raw data site into which data is contributed in the system of FIG. 1 in one embodiment.

FIGS. 8A and 8B are display diagrams showing a job availability survey that may be used to collect data contributions in the system of FIG. 1.

FIG. 9 is a flow diagram showing various users of the system of FIG. 1.

FIG. 10 is a display diagram showing an example of an introduction screen to a platform library associated with the client computer application of FIG. 3.

FIG. 11 is a display diagram showing a submit new data screen that can be used to collect data in the system of FIG. 1.

FIGS. 12A-12F are display diagrams showing portions of a generic job analysis form that can be used to collect data in the system of FIG. 1.

FIGS. 13A-13C are display diagrams showing an example of a job analysis form for the State of Washington as provided by the client computer application of FIG. 3 in one embodiment.

FIGS. 14A-14D are display diagrams showing an example of a job analysis form for the State of Ohio as provided by the client computer application of FIG. 3 in one embodiment.

FIGS. 15A and 15B are display diagrams showing examples of job analysis input forms that can be used in various applications associated with the system of FIG. 1.

FIGS. 16A and 16B are display diagrams showing a screen from which users of the client computer application of FIG. 3 can contribute skill information in one embodiment.

FIG. 17 is a display diagram showing a screen from which a user of the client computer application of FIG. 3 may modify industry codes in one embodiment.

FIG. 18 is a display diagram showing an example of a home page screen for an Internet accessed server application or working site configured for collecting data on behalf of the system of FIG. 1.

FIG. 19 is a display diagram showing an example of a direct analysis questionnaire that may be accessed by a user via the home page screen of FIG. 18.

FIGS. 20A and 20B are display diagrams showing a job board Internet server application from which users can contribute information to the system of FIG. 1.

FIGS. 21A-21D are display diagrams showing screens from a salary expert server application that can be accessed via the Internet and used to collect information for the system of FIG. 1.

FIG. 22 is a display diagram showing an example of a screen from a salaries review server application that users can access via the Internet to contribute data to the system of FIG. 1.

FIG. 23 is a display diagram showing an example of a job availability wizard accessed from the home page of FIG. 18.

FIG. 24 is a display diagram showing an example of a query by position screen from an executive database application that can be used to contribute data to the system of FIG. 1.

FIG. 25 is a display diagram showing an example of a database downloads home page from which researchers can access data collected by the system of FIG. 1.

FIG. 26 is a display diagram showing an example of a page or screen from which raw data can be reviewed.

FIG. 27 is a display diagram showing an illustration of an application of data collected by the system of FIG. 1.

FIG. 28 is a display diagram showing various editions for the client computer application of FIG. 3.

FIG. 29 is a display diagram showing an example of an archive edition of the client computer application of FIG. 3.

FIG. 30 is a display diagram showing an example of a career interest edition of the client computer application of FIG. 3.

FIG. 31 is a display diagram showing an example of an administrative edition of the client computer application of FIG. 3.

FIGS. 32A-32C are display diagrams showing screens of a transferable skills edition of the client computer application of FIG. 3.

FIGS. 33A-33C are display diagrams showing an example of a workers' compensation edition of the client computer application of FIG. 3.

FIG. 34 is a display diagram showing an example of a custom edition of the client computer application of FIG. 3.

FIG. 35 is a display diagram showing an example of a basic filter by text of the client computer application of FIG. 3.

FIG. 36 is a display diagram showing a basic filter by industry of the client computer application of FIG. 3.

FIG. 37 is a display diagram showing an example of a basic filter by job codes associated with the client computer application of FIG. 3.

FIG. 38 is a display diagram showing an advanced filter with various subfilters associated with the client computer application of FIG. 3.

FIGS. 39A-39F are display diagrams showing an example of enhanced filters associated with the client computer application of FIG. 3.

FIG. 40 is a display diagram showing an example of a job tabs screen of the client computer application of FIG. 3.

FIG. 41 is a display diagram showing an example of an individual data tab screen of the client computer application of FIG. 3.

FIG. 42 is a display diagram showing an example of a transferable analysis assessment performed by the client computer application of FIG. 3.

FIG. 43 is a display diagram showing an example of a listing of alternative jobs as performed by the client computer application of FIG. 3.

FIG. 44 is a display diagram showing a job availability listing as performed by the client computer application of FIG. 3.

FIG. 45 is a display diagram showing an example of a potential employers screen of the client computer application of FIG. 3.

FIG. 46 is a display diagram showing a job research screen provided as a link from the client computer application of FIG. 3.

FIGS. 47A-47D are display diagrams showing a worker characteristics screen of the client computer application of FIG. 3.

FIG. 48 is a display diagram showing an example of a position crosswalk screen of the client computer application of FIG. 3.

FIG. 49 is a display diagram showing an example an industry crosswalk screen of the client computer application of FIG. 3.

FIG. 50 is a display diagram showing an example of the results of a crosswalk performed by the client computer application of FIG. 3.

FIG. 51 is a display diagram showing an example of a generic browse function performed by the client computer application of FIG. 3.

FIG. 52 is a display diagram showing an example of a job trained for screen of the client computer application of FIG. 3.

FIG. 53 is a display diagram showing an example of a video feature available via the client computer application of FIGS. 1 and 3.

FIG. 54 is a display diagram showing an example of a job family information data site screen accessed via a link of the client computer application of FIG. 3.

FIG. 55 is a display diagram showing an example of a job certificate analyst program screen associated with the client computer application of FIG. 3.

FIG. 56 is a display diagram showing a distance learning course listing provided in association with the client computer application of FIG. 3.

The headings provided herein are for convenience only and do not necessarily affect the scope or meaning of the claimed invention.

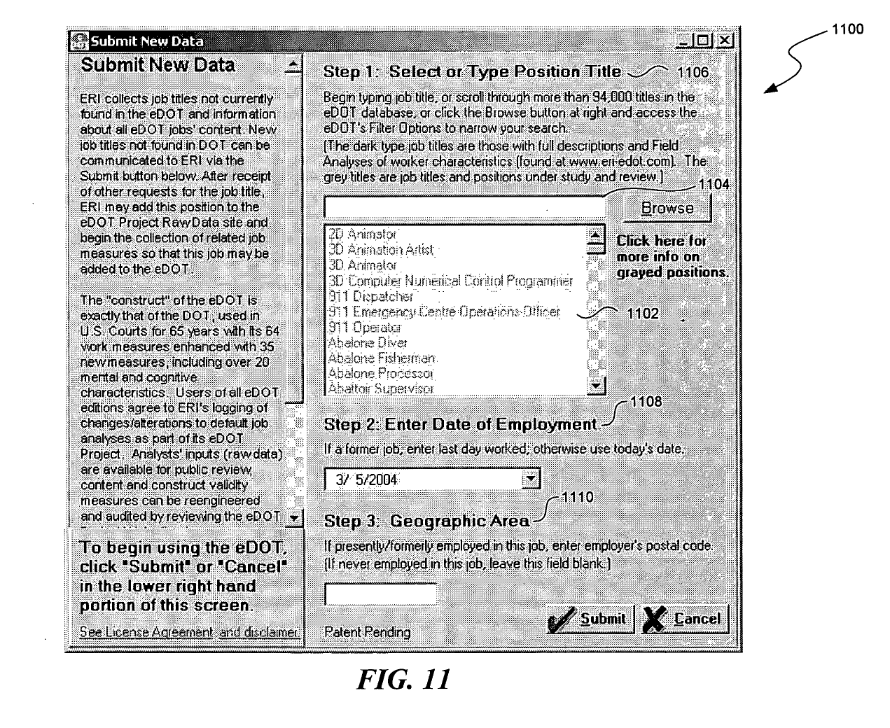

In the drawings, the same reference numbers and acronyms identify elements or acts with the same or similar functionality for ease of understanding and convenience. To easily identify the discussion of any particular element or act, the most significant digit or digits in a reference number refer to the Figure number in which that element is first introduced (e.g., element 1104 is first introduced and discussed with respect to FIG. 11).

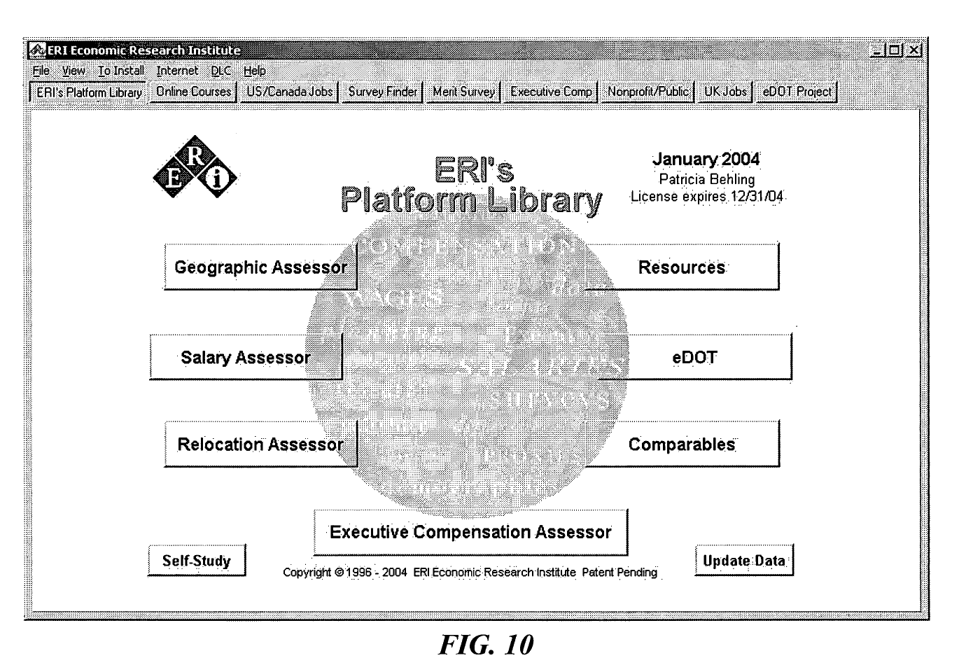

Figure numbers followed by the letters “A,” “B,” “C,” etc. indicate either (1) that two or more Figures together form a complete Figure (e.g., FIGS. 10A and 10B together form a single, complete FIG. 10) but are split between two or more Figures because of paper size restrictions, amount of viewable area within a computer screen window, etc., or (2) that two or more Figures represent alternative embodiments or methods under aspects of the invention.

Sizes of various depicted elements are not necessarily drawn to scale and these various elements may be arbitrarily enlarged to improve legibility.

A portion of this disclosure contains material to which a claim for copyright is made. The copyright owner has no objection to the facsimile reproduction by anyone of the patent document or patent disclosure (including Figures), as it appears in the U.S. Patent and Trademark Office patent file or records, but reserves all other copyright rights whatsoever.

### DETAILED DESCRIPTION

I. Overview

A facility for collecting, providing, and reporting up-to-date occupational data, skills information, and job population estimates is provided using a combination of the Internet, PC programming, and database management technology. In some embodiments, the facility employs data measures related to specific jobs, including both statistics relating to active employment numbers for specific jobs and various worker measures related to those specific jobs. These worker measures may include accurate job titles, descriptions, required job skills, and physical and mental job demands. The facility is “cybernetic” in that it is self-regulating, self-correcting, and easily updated, taking advantage of modern technologies in its delivery and upkeep. In some embodiments, the facility is configured to provide information appropriate for use as courtroom evidence, including rates of error.

The facility includes a collection of occupational information (“the collection”) that is made accessible to, and is continuously updated by, users of the facility. In some embodiments, a noncopyrighted historical collection of occupational descriptions (e.g., the DOT) functions as a starting point for the collection. This historical collection is enhanced and updated using various measures, scales, and methods, resulting in an updated collection. For example, the facility identifies out-of-date descriptions from the historical collection and updates or compresses them, as appropriate, to reflect current occupational environments in a country, state, or city. The facility may also update the collection of occupational information by adding new jobs found in the current workforce. In addition, by allowing users to review data corresponding to previous or historic approaches used in collecting the data, the facility creates a means by which researchers can gauge changes in data collection methods that have occurred over time.

The collection of occupational information includes updated work measures that provide information above and beyond the information provided in the historical collection. Work measures are generally reported as averages; every job has its own unique characteristics that may vary from the reported averages. For example, new stress-related work measures provide information on stressful conditions that prevail in America's workplaces. Examples of other updated work measures include new specific skill collections, new industry definitions, new job descriptions, etc. Each time a field job analyst or other expert uses the facility to review a job and finds that the initial work measure is inaccurate, the job analyst may note this inaccuracy on an input form. This change is automatically communicated to a server computer's fileservers.

The facility may provide lists of alternative occupations for each job described in the collection. Likewise, the facility may use statistical information about job availability, listings of potential employers, and statistical measures, including standard errors and deviations, to supplement the occupational descriptions in the historical collection.

Besides job descriptions, worker measures, and related job analysis materials, the facility incorporates job availability surveys to identify actual numbers of incumbents in specific jobs. In some embodiments, the facility supports the creation of job availability reports using individual job descriptions (rather than “job family-style” reports). The facility may also provide data useful in educational programs, career planning, disability determinations, organizational planning, personal planning, and litigation matters.

In addition to providing descriptions of occupations and other job-related information as described above (and in more detail below), the facility provides multiple filters for searching and extracting desired information from the collection. In this way, different users may use the information in the collection for different purposes. In some embodiments, the facility provides special “editions” for particular users. For example, some users may wish to conduct a transferable skills analysis, while others may simply be seeking information to facilitate career decisions, disability determinations, job availability assessments, vocational rehabilitation opportunities, or unemployment or workers' compensation analyses. In such cases, the user may benefit by selecting one of the special editions most suited to his or her needs.

The facility may reside, at least in part, on both a client computer (e.g., a personal computer (PC)) and a server computer (e.g., a centralized Internet fileserver). In some embodiments, users may access the collection from either the World-Wide-Web (“Web”) or from a client computer application running on a personal computer or other device. The facility may account for each access of the collection and use this information as a potential tool for updating and enhancing a master raw data file or other storage means. In some embodiments, the master raw data file is located on the server computer and available for public review and manipulation via the Internet. Quarterly “snapshots” of the server computer database may be taken and transcribed onto a client computer application update and sent out to subscribers via a periodically released CD-ROM, allowing fast access to the information. A combination of access techniques may also be used. For example, during the analysis of a particular job, the client computer may use the quarterly inscribed data from the CD-ROM as well as more up-to-date inputs (smaller data streams) provided by the server computer via a network.

The facility updates the collection of occupational information and other related data using various information sources. In some embodiments, one such information source includes user input from a user of the client computer application. Because the facility collects and makes use of data provided by its own users, the facility can be thought of as an automatic feedback loop (a cybernetic system); the more it is used, the more data regarding jobs is collected and the more robust the facility's data sets become. For example, when an inquiry is performed on a specific job, that inquiry is logged along with various other types of input provided by the user during the inquiry.

In addition to information drawn from user input associated with the client computer application, the facility may also collect and make use of raw information extracted from applications running on Internet servers, including those offering occupational data (e.g., sites offering salary information, purchased reports, etc.). Internet server applications and other external data collection tools may also collect information about populations of specific jobs reported by private and public salary surveys. For example, each time a query regarding a specific job is made, an interest in that job is logged to a job availability survey.

An example of a server application source may include a working site for field job analysts. In addition to viewing raw data, field job analysts who use the working site may provide a steady stream of data through their continuous use of the application running on the server computer. This access may occur, for example, via a client computer Web browser application. In some embodiments, the working site also includes recorded answers to a job analysis questionnaire (“JAQ”) or, similarly, a direct analysis questionnaire (“DAQ”). Questionnaires of this type are designed to obtain input from professionals and experts such as field job analysts (e.g., researchers who analyze data, present subscribers, forensic economists who wish to review underlying field input and standard deviation information, etc.). The information collected from the questionnaires is then logged into a raw data site (described below), which is used directly or aggregated with other information. The raw data site is a publicly available forum where users can contribute data (e.g., through the use of questionnaires) and review contributed data. In some embodiments, the raw data site reflects nearly instantaneous processing of contributions made to the site, and supplements this information with rate of error information.

In some embodiments, the working site and its associated data is available for public review, including expert witness resource analyses. While the working data site may be accessed externally from a specified Internet site, it is also possible for a user to access working site data and make contributions via, for example, a tab on the interface of the client computer application.

Not only does the facility provide and collect information, but it may also provide references to the sources of the information. In this way, various users can qualify and/or verify the information provided by the facility for certain uses. For example, work measure and skills data may be available for review on a raw data site. In this way, users such as researchers, attorneys, and expert witnesses can review the input of field analysts, the input from free Web inquiry sites, the input from salary surveys, workers' compensation analyses, any uses or changes to worker measures on a client computer, or other contributions. Their review of this data in itself provides additional contributions. For example, each time an average measure is changed to reflect recent input on a client computer application, this change is ultimately contributed to the content raw data site and a job availability count for the specific job is increased.

The facility may implement a mathematics-based categorization of the requirements of specific jobs, skills, and job title matches. The facility may employ a mathematical computation to identify other jobs for which a user might be qualified. The facility may also support the process of interviewing or submitting written questions to multiple job holders or managers about the compensation being paid for a specific job. The facility may then use the results of those interviews/answers to develop a range of compensation (including such factors as geographic location, industry, experience, etc.) for a specific job, as well as a range and average values for other work measures. Likewise, the facility may allow users to match skills of studied occupations with resumes found on Internet or other job boards. The facility may also use the mathematics-based algorithm to identify various placements of specific jobs into industry and job groupings. This may be implemented via the use of various “crosswalks” that allow the user to view industry and job groupings across a range of classification systems.

The invention will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

II. System Architecture and Data Collection Overview

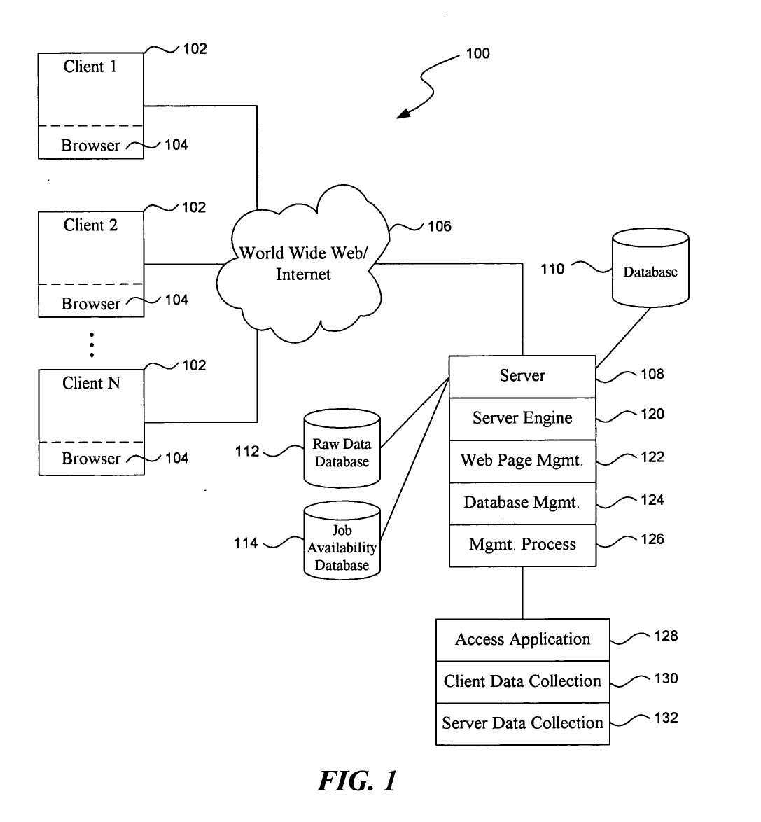

FIGS. 1-10 provide an overview of the facility and its associated system and data collection scheme. The system is configured to optimize data gathering from numerous sources, including its own applications, and thus functions as a cybernetic system. Unless described otherwise below, aspects of the invention may be practiced with conventional systems. Thus, the construction and operation of the various blocks shown in FIG. 1 may be of conventional design and need not be described in further detail herein to make and use the invention because such blocks will be understood by those skilled in the relevant art. One skilled in the relevant art can readily make any modifications necessary to the blocks in FIG. 1 (or other embodiments or Figures) based on the detailed description provided herein.

Referring to FIG. 1, a data retrieval and display system 100 includes one or more client computers 102, each of which includes a browser program module 104 that permits the computer to access and exchange data via a network 106, such as the Internet. Each client computer 102 may include one or more central processing units or other logic processing circuitry, memory, input devices (e.g., keyboards and pointing devices), output devices (e.g., display devices and printers), and storage devices (e.g., fixed, floppy, and optical disk drives, magnetic cassettes, flash memory cards, digital video disks (“DVDs”), Bernoulli cartridges, RAMs, ROMs, smart cards, etc.), all well known but not shown in FIG. 1. The client computers 102 may also include various program modules, such as an operating system, one or more local application programs (e.g., a client computer application, word processing or spread sheet applications, etc.), and the like. These local application programs may include programs stored at the client computer in permanent memory (e.g., hard drive, RAM, ROM, etc.) or removable memory (e.g., floppy, CD-ROM, etc.). A user, such as a job analyst or person seeking a career change, can operate the client computers 102 to seek desired occupational information.

A server computer 108 coupled to the Web 106 performs some or all of the data retrieval and display processes as well as some or all of the data collection process. In some embodiments, the system includes or is associated with multiple peripheral servers (not shown), each associated with one or more server applications that collect raw data for incorporation into the collection.

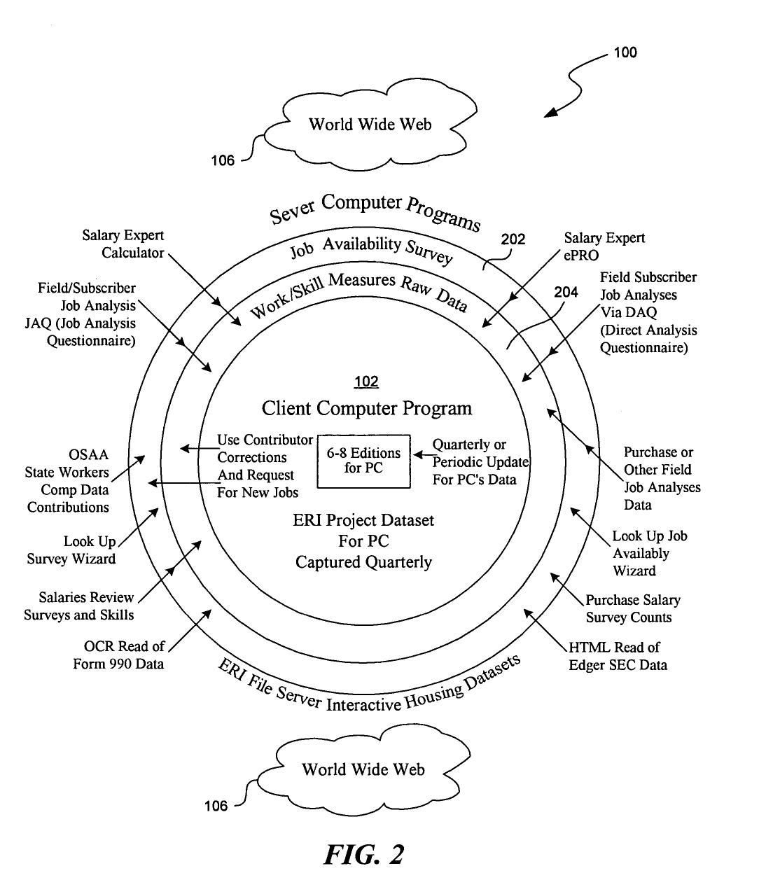

A primary database 110 coupled to the server computer 108 stores much of the data exchanged between the client computers 102 and the server computer 108. A raw data database 112 stores information about job measures, skills, etc., and a job availability database 114 stores job count information. As illustrated in FIG. 2, a conceptual system diagram of the system 100 of FIG. 1, these two databases (112 and 114) can be viewed as implementing separate aspects or rings (202 and 204) of the system.

The server computer 108 includes a server engine 120, a Web page management component 122, a database management component 124, a management process component 126, and other components not shown in FIG. 1. The server engine 120, the Web page management component 122, the database management component 124, and the management process component 126 operate together to retrieve information from the databases (110, 112, 114) and provide the information to the client computers 102. In one embodiment, the server computer 108 and the databases (110, 112, 114) can form a single computing platform. Alternatively, the functions performed by the server computer 108 and/or the databases (110, 112, 114) can be distributed over a plurality of platforms and hardware components. The foregoing components can also operate together to receive information from the client computers (102) and update the database 110 with the information, as described in greater detail below with reference to FIGS. 11 through 40.

In one embodiment, the system 100 can include an access application 128 (for allowing users to access the collection of occupational information) as well as various data collection components (130 and 132) to enable collecting and analyzing occupation information. For example, a client data collection component 130 receives input information from users of client computers running a client computer application, including the collection of occupational information. A server data collection component 132 collects data from peripheral servers (both internal and external to the system) and other systems, which also function to collect data relating to the collection. The Web 106 or another network allows for the sharing of information in various ways and combinations.

FIG. 2 is a conceptual system diagram that shows the cybernetic flow of data within the system 100 of FIG. 1. As shown by the arrows representing the flow of data, the collection of occupational information is in a continual state of update and enrichment. The operation of this system is very different from systems that operate to collect job family data (which typically use written forms and manual data entry to input information into a database).

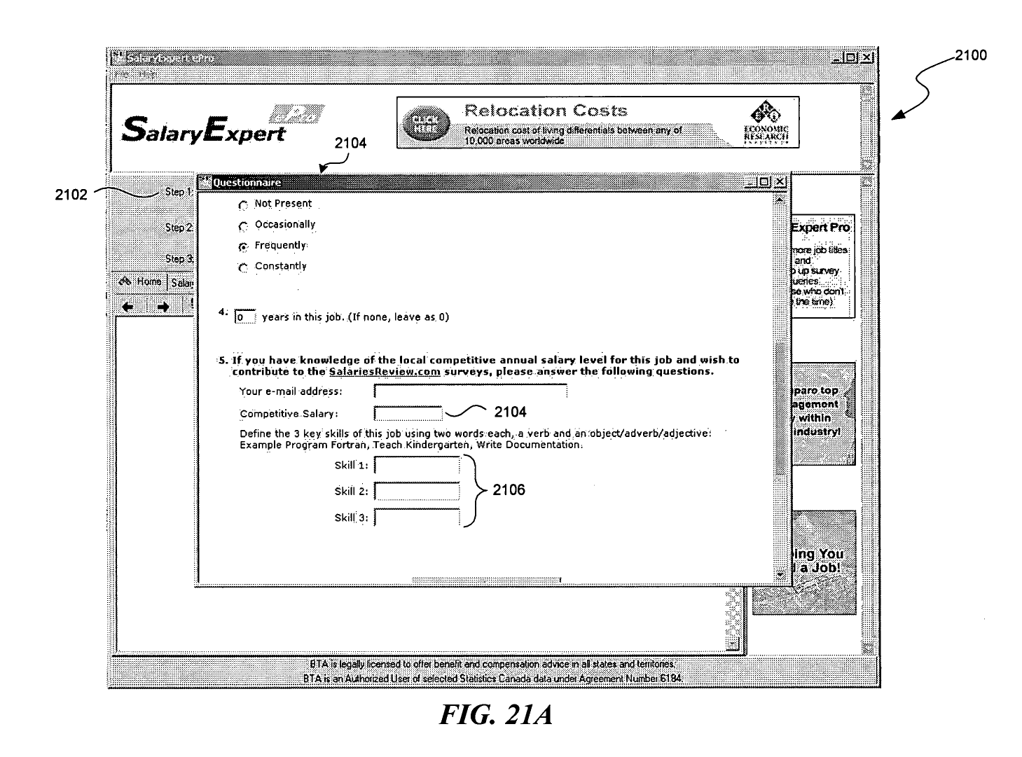

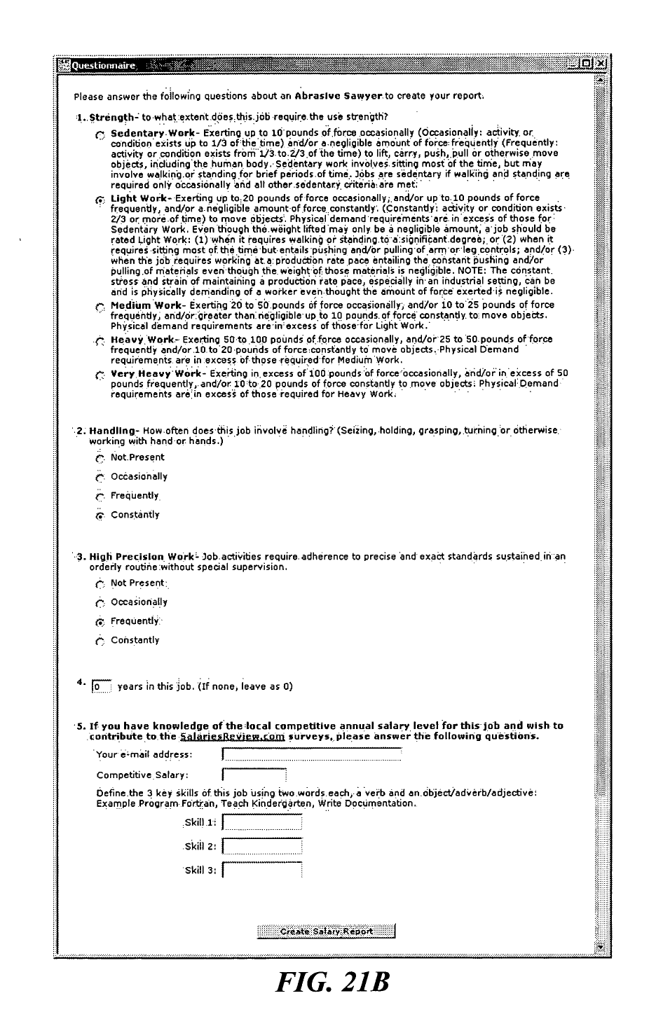

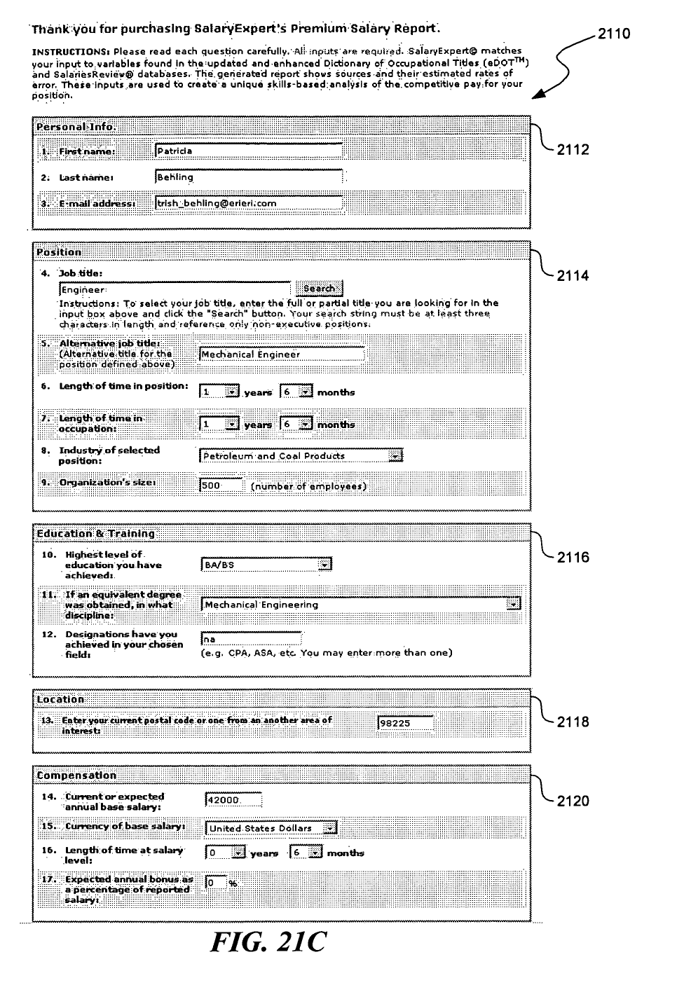

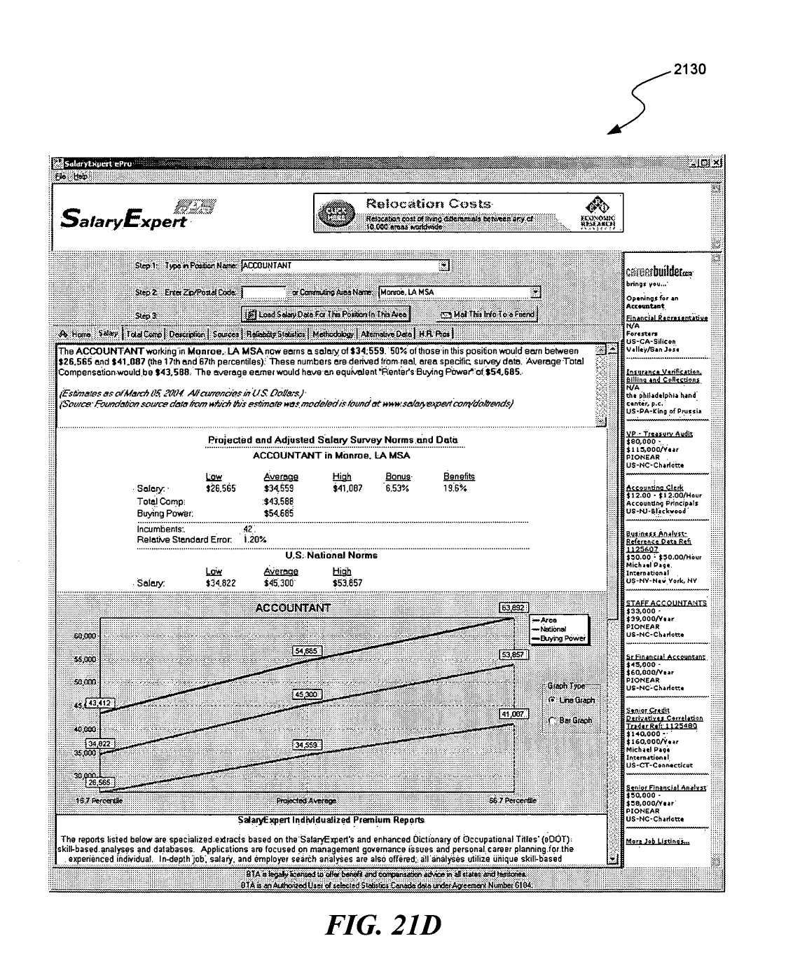

As shown, the system includes two outer concentric rings (202 and 204), each implemented as a database in some embodiments (e.g., databases 112 and 114 of FIG. 1). The outermost ring 202 corresponds to job count data. Job count data includes quantitative data about the availability of specific jobs. The second outermost ring 204 corresponds to a raw data database where worker measures, descriptions, titles, skills, and other measures are collected, analyzed, and reported. As illustrated, both the outermost 202 and second outermost 204 rings receive “server” data fed from peripheral servers and other external systems (described in more detail with respect to FIGS. 21-40). Such sources include, for example, a salary expert calculator, job analysis questionnaires, state workers' compensation contributions, salary review data sites, a job availability wizard, salary survey counts, Security and Exchange Commission (“SEC”) information, etc. At the same time, the database rings (202 and 204) receive “client” data from the one or more client computers 102 running applications associated with the collection of occupational information (described in more detail with respect to FIGS. 11-20). The applications on the client computers may be updated quarterly or via the Web 106. In many cases, the users of such applications are professional users.

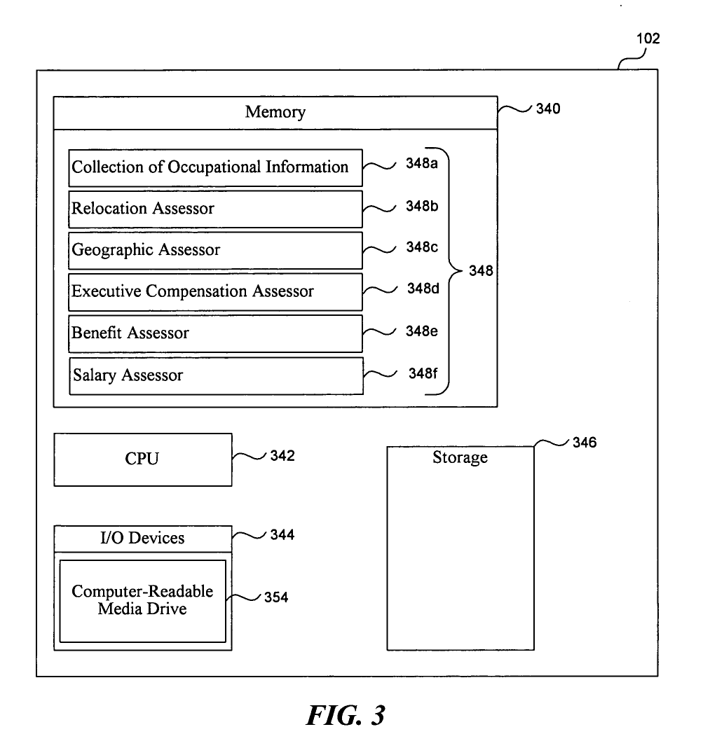

FIG. 3 is a schematic block diagram illustrating in further detail components of one of the client computers 102 shown in FIG. 1. In one embodiment, the computer 102 can include a memory 340, a CPU 342, input/output devices 344, and a storage device 346. The memory 340 can include software or other computer instructions for implementing a method in accordance with an embodiment of the invention (i.e., client computer applications). For example, the software can include one or more client computer application modules 348, such as a collection of occupational information 348a, an existing relocation assessor product 348b for providing cost-of-living data, a geographic assessor 348c, an executive compensation assessor 348d, a benefit assessor 348e, and a salary assessor 348f with a wage perspective via an existing salary assessor product, etc. In general, client computer application modules 348a-348f are sister applications that can contribute or gather data as a group. While the collection of occupational information may operate on the client computer 102 without interacting with sister applications (e.g., it may be downloaded from the Web and run as a stand-alone program, or it might even be accessed directly from the Web), the speed and power of the program may be increased by utilizing Windows' unique “threading” capabilities, which access multiple datasets at one time, including information off the Web. Accordingly, the collection of occupational information application module 348a may access other existing databases and programs, including those shown in 348b-348f and others, such as governmental data related to job family information (e.g., descriptions, wages, and job populations).

The input/output devices 344 can include devices such as a computer-readable media drive 354. Accordingly, the input/output devices 344 can read computer-readable media having the software for the modules 348. For example, the modules 348 can be contained on a CD and read by a CD drive. The software can also be accessible from the memory 340, as described above. Alternatively, the modules 348 can be accessed over the Web 106 from the server computer 108 of FIG. 1 and can be installed on the client computer 102. The storage device 346 can include file storage for data generated and/or accessed by or from the modules 348.

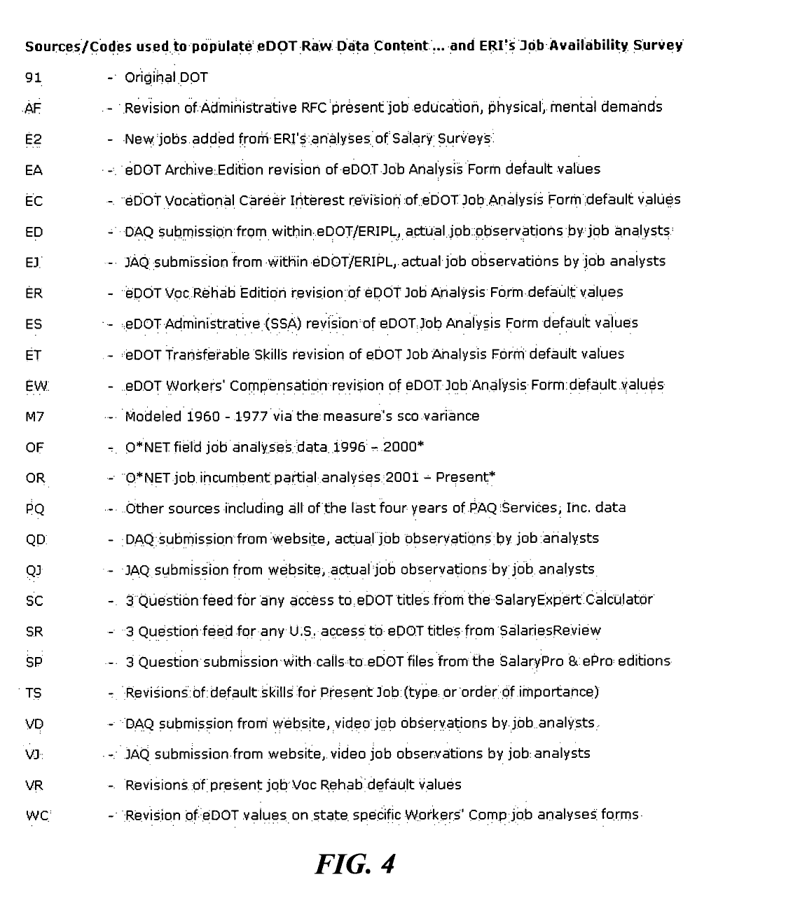

Referring to FIG. 4, a spreadsheet provides an outline of information sources that may be used to update the collection of occupational information and their associated codes. Each time a submission is made via one of these sources, the submission is tagged using the associated code. Using these tags, the data collected by the facility may be organized, weighted, and placed according to its source.

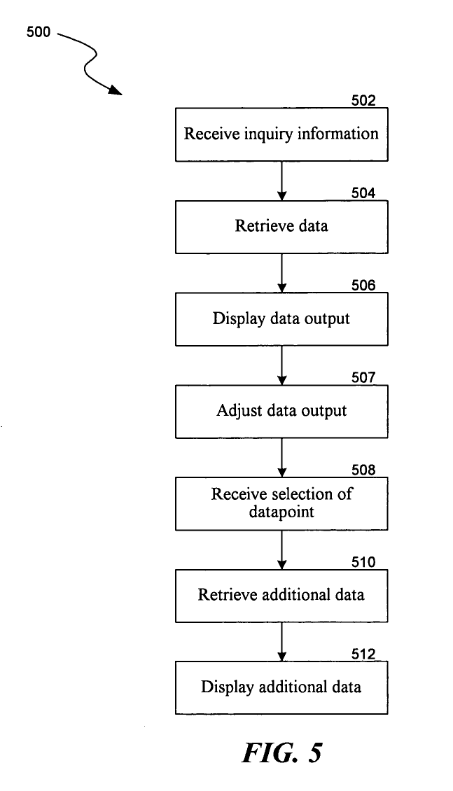

FIG. 5 is a representative flow diagram that depicts a process used in some embodiments. This flow diagram does not show all functions or exchanges of data, but instead it provides an understanding of commands and data exchanged under the system. Those skilled in the relevant art will recognize that some functions or exchange of commands and data may be repeated, varied, omitted, or supplemented, and other (less important) aspects not shown may be readily implemented. Referring to FIG. 5, the system 100 of FIG. 1 and, in particular, one or more of the client computer application modules 348 described above with reference to FIG. 3, may perform a retrieval and display routine 500. Beginning with block 502, the routine 500 receives input information or criteria at the client computer 102. For example, when the routine 500 is performed by any one of the client computer application modules 348a-348f, the user can initiate operation of the application or applications and the system 100 can display an introductory page. In one aspect of this embodiment, at block 504, the data can be retrieved from a CD or other computer-readable medium coupled directly to the computer 102. In other embodiments, the data can be retrieved from other sources, for example, the database 110 coupled to the server computer 108 via the Web 106. In either embodiment, at block 506, the retrieved data is displayed to the user on an output page.

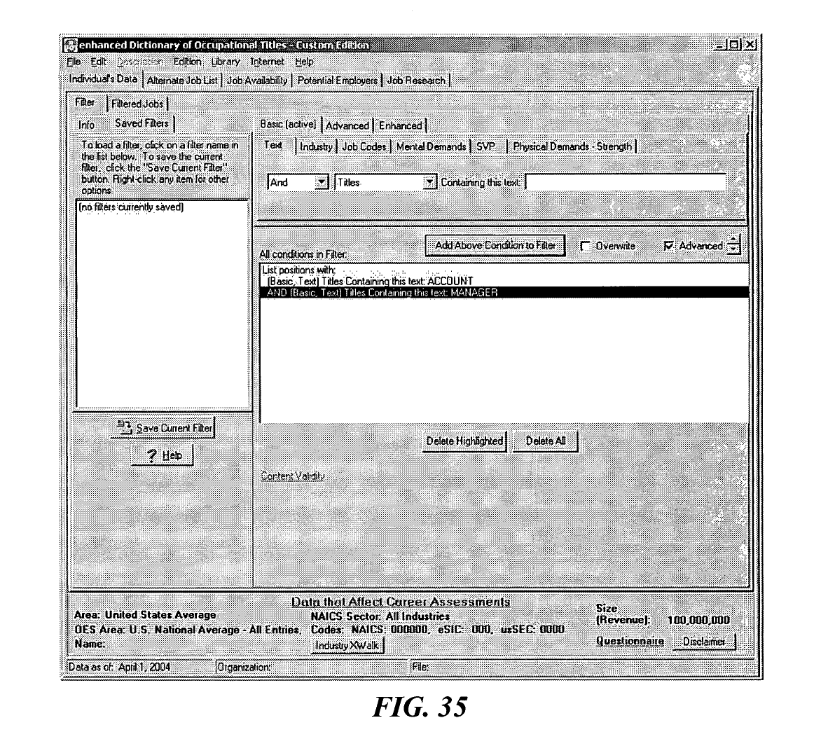

At block 507, the user can filter or adjust the default data to be more specific (for example, see FIGS. 35-39, which describe the use of various filters). At block 508, the routine receives data from the user in the form of input, thereby contributing to the cybernetic system. At block 510, the routine retrieves additional information based on the user input. At block 512, the additional data is displayed to the user.

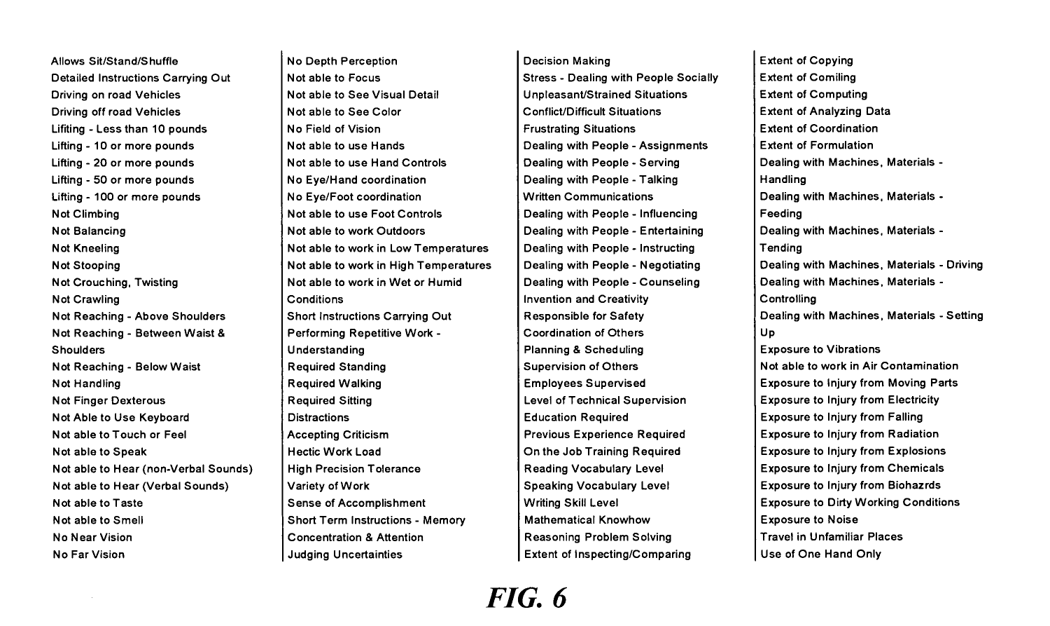

FIG. 6 shows various database elements of the facility, and illustrates crosswalks and new measures. As illustrated, external Internet data, industry and job code crosswalks, a historical DOT construct, questionnaire data, purchased field analyses data, a collection of skill statements, and other inputs are blended together in a common database (or collection of databases) that is continually updated and enhanced. The database provides a foundation for processes of the client computer application. The database also functions as a construct by which various sister applications (e.g., 348a-348f of FIG. 3) access the database to enhance their presentations. The various measures shown in the database include work place stress factors (e.g., unpleasant/strained situations).

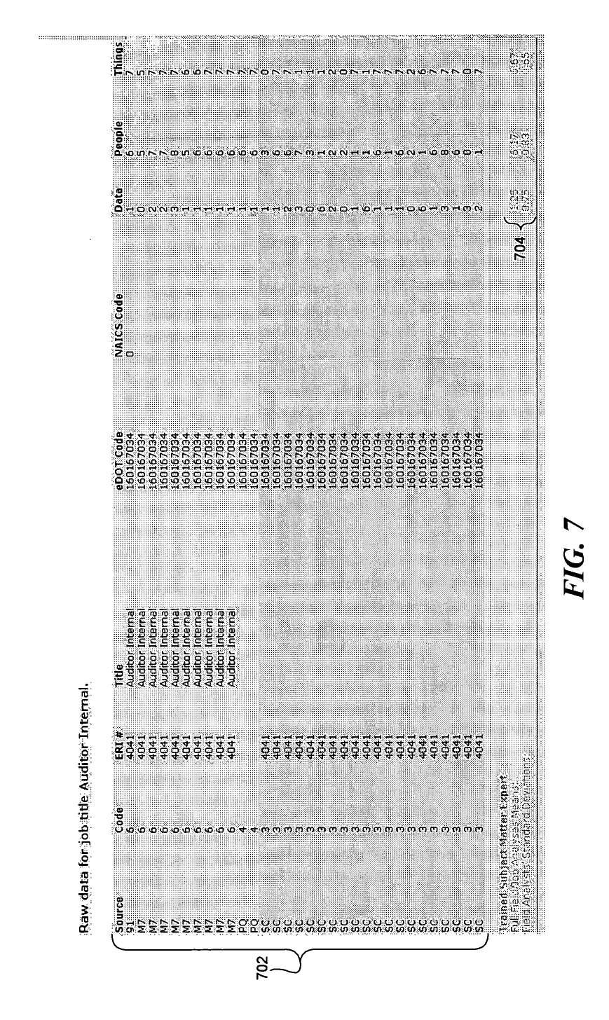

FIG. 7 is a screen shot showing an example of an Internet-based working raw dataset that is available for review by researchers (data intended for use in the public domain). From this dataset, the client computer application takes a “snapshot” (at least quarterly) and uses defined average measures and rates of error over a given time period. In this manner, specific job content is continually being updated and enhanced. As illustrated, various codes 702 identify the source of the raw data inputs for each measure (e.g., data, people, things, etc.). The provided data is then combined into averages 704 (shown as partial and full analyses) along with their respective standard deviations (e.g., from the average computation for Federal Court Daubert challenges). Because some types of analyses performed by job analysts focus on particular aspects of a job (e.g., workers' compensation analyses only focus on those parts of a job that are affected by an injury), such analyses are labeled as “partial job analyses.”

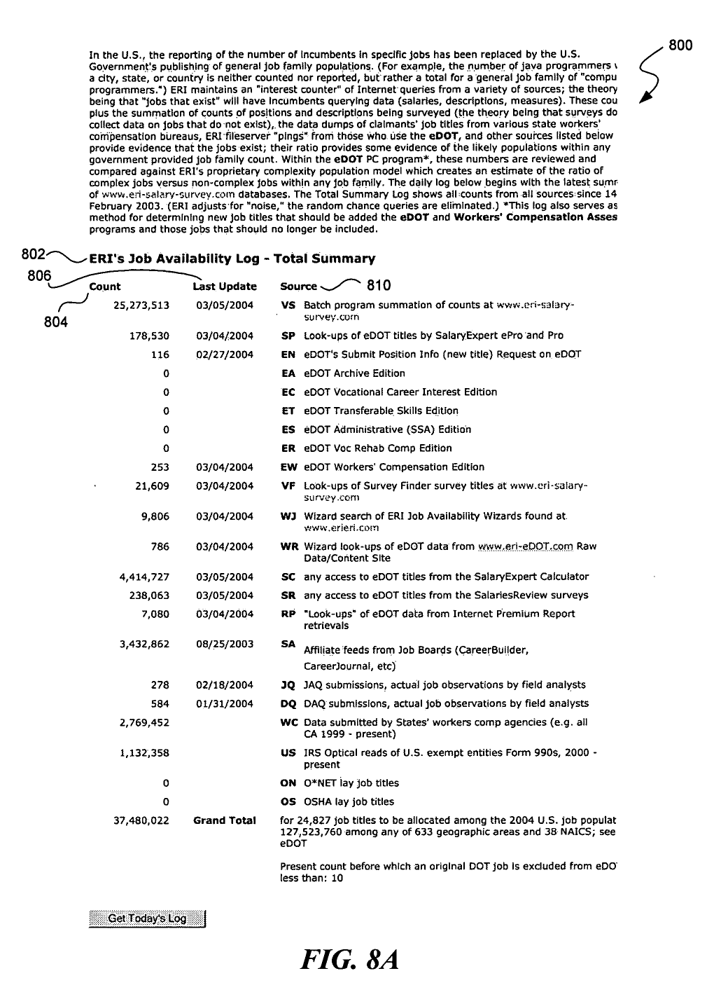

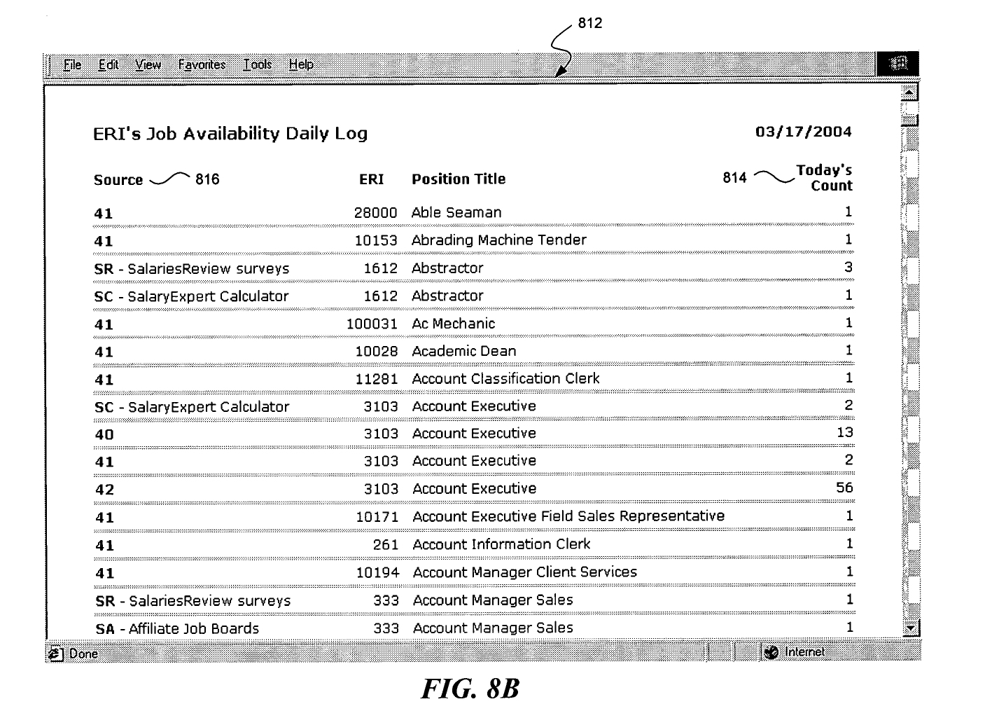

Referring to FIGS. 8A and 8B, the facility may support a job availability survey 800 (also shown as the outermost ring 202 of FIG. 2) that identifies new jobs that can then be included in the collection of occupational information. The job availability survey 800 may also identify old jobs that have disappeared and create a ratio comparing existing specific jobs within a job family to all the jobs in that job family so that an estimate of available jobs might be made. The survey summary section 802 includes a count 804 and a last update date 806 for each information source 810 (e.g., see sources depicted in FIG. 4). Every count 804 may correspond to an input event by a user of the information source 810. A daily log 812 located on the bottom portion of the screen provides a listing of the daily log for the day the screen shot was taken. This provides a view of a day's counts 810 for each job of the collection, which is broken down by source 816.

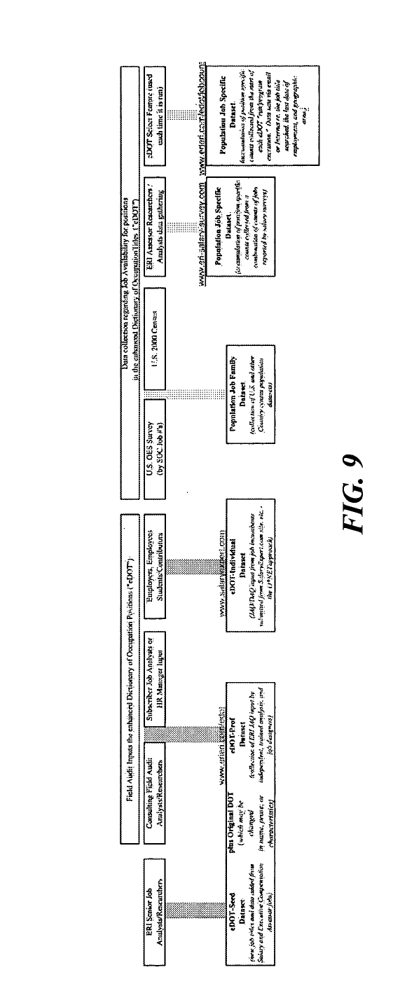

FIG. 9 is an outline flow chart that outlines field analysts' inputs into the job availability survey. The facility uses these inputs to provide interactivity to the job availability survey. As shown, there may be several different types of job analysts that make use of the system, such as senior job analysts/researchers, consulting field audit analyst inputs, human resources managers, etc. An example of the resulting survey is illustrated in FIG. 9.

Referring to FIG. 10, the client computer application or applications associated with the facility may be incorporated into a platform library, with other related projects or sister applications (e.g., 348b-348f of FIG. 3) or used alone. In some embodiments, the top tab of the client computer application may be used in conjunction with information in a Web site and contained in a browser. To support these techniques, Windows “threads” and multiple data streaming may be used. Details about these and similar techniques are discussed further in U.S. patent application Ser. Nos. 09/849,455 and 09/849,454 (incorporated herein by reference). Using these and similar techniques, both incumbent self-analysts and professional job analysts may more easily perform job analysis. In some embodiments, a Web application may be used alone to provide partial or complete access to the collection of information. Accordingly, a user may access the information provided by the system for personal use, such as for a career or disability assessment, without the need to install the client computer application.

III. Collecting and Maintaining Occupational Information

The following Figures show example screens or pages for collecting information for use by the facility and the collection of occupational information. For example, FIGS. 11-20 illustrate examples of collecting information via the use of a client computer application associated with the facility. FIGS. 21-27 go on to illustrate server application information sources and other sources existing outside the client computer application (e.g., raw data sets and the job availability survey). Representative computer displays or Web pages will now be described with respect to the facility. The screens or Web pages may be implemented in C++ or as Web pages under XML (Extensible Markup Language), HTML (HyperText Markup Language), or any other scripts or methods of creating displayable data, such as the Wireless Access Protocol (“WAP”). The screens or Web pages provide facilities to receive input data, such as a form with fields to be filled in, pull-down menus or entries allowing one or more of several options to be selected, buttons, sliders, hypertext links, or other known user interface tools for receiving user input. While certain ways of displaying information to users are shown and described with respect to certain Figures, those skilled in the relevant art will recognize that various other alternatives may be employed. The terms “screen,” “Web page” and “page” are generally used interchangeably herein.

When implemented as Web pages, the screens are stored as display descriptions, graphical user interfaces, or other methods of depicting information on a computer screen (e.g., commands, links, fonts, colors, layout, sizes and relative positions, and the like), and the layout and information or content to be displayed on the page is stored in a database. In general, a “link” refers to any resource locator identifying a resource on a network, such as a display description provided by an organization having a site or node on the network. A “display description,” as generally used herein, refers to any method of automatically displaying information on a computer screen in any of the above-noted formats, as well as other formats such as email or character/code-based formats, algorithm-based formats (e.g., vector-generated), or matrix or bit-mapped formats. While aspects of the invention are described herein using a networked environment, some or all features may be implemented within a single-computer environment.

In general, for ease in describing features of the invention, aspects of the invention will now be described in terms of a user interacting with the client computer application or the server computer via his or her user computer. As implemented, however, the user computer receives data input by the user and transmits such input data to the server computer. The server computer then queries the database, retrieves requested pages, performs computations, and/or provides output data back to the user computer, typically for visual display to the user.

A. Data Collected from Client Computer Application

FIG. 11 is a display diagram showing an example of a submit screen 1100 where data can be contributed when a user provides job data for analysis via the client computer application. The user interface may include various self-explanatory input fields that, if an Internet connection exists, submits data to a job availability survey and identifies new jobs that might be added to the databases. The submit screen may be displayed each time a user opens the application and allows for the input of new jobs. For example, if a user provides a job title that is not identified by the system, the submission is logged and may result in a new job title being incorporated into the system.

From the submit screen 1100, the user may input job information by selecting a job from a pull down menu 1102, or the user may query for jobs that may or may not be included in the collection using a blank text field 1104. The data collected from the submit screen 1100 may include position type or title 1106, date of employment 1108, or geographic area 1110. The information inputted by the user in the submit screen 1100 may be incorporated into the system. For example, a new position name (not initially included in the collection) may be entered to both the raw data and job availability surveys. Job titles from the pull down menu 1102 shown in bold text (not shown) exist on both the client computer application and various server applications. Input from this module may be used by both.

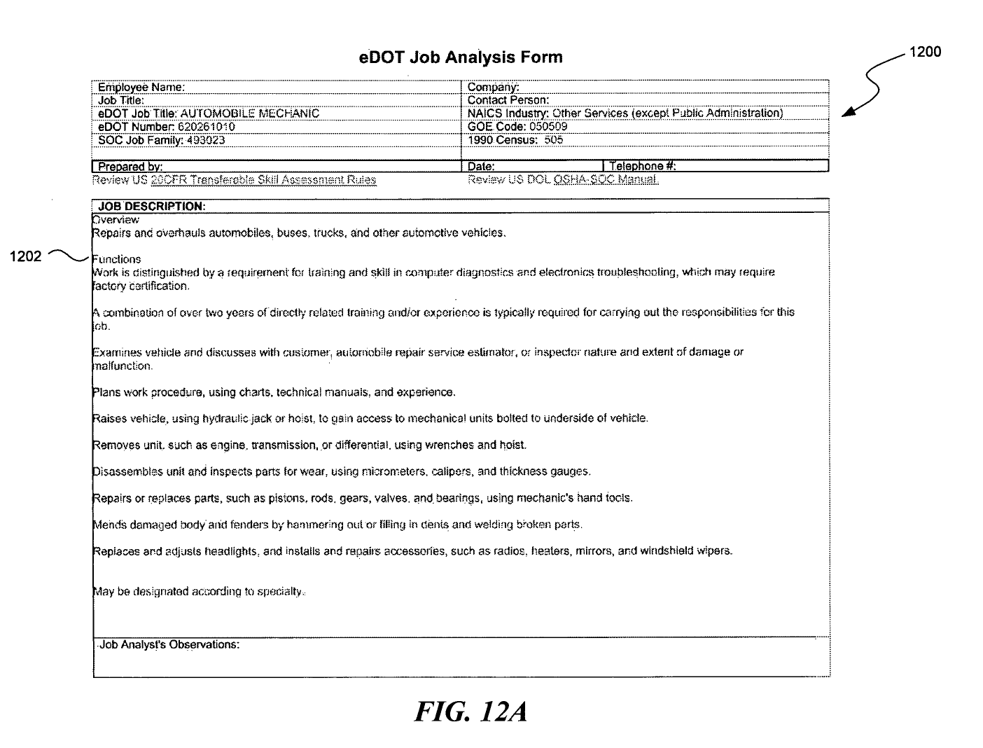

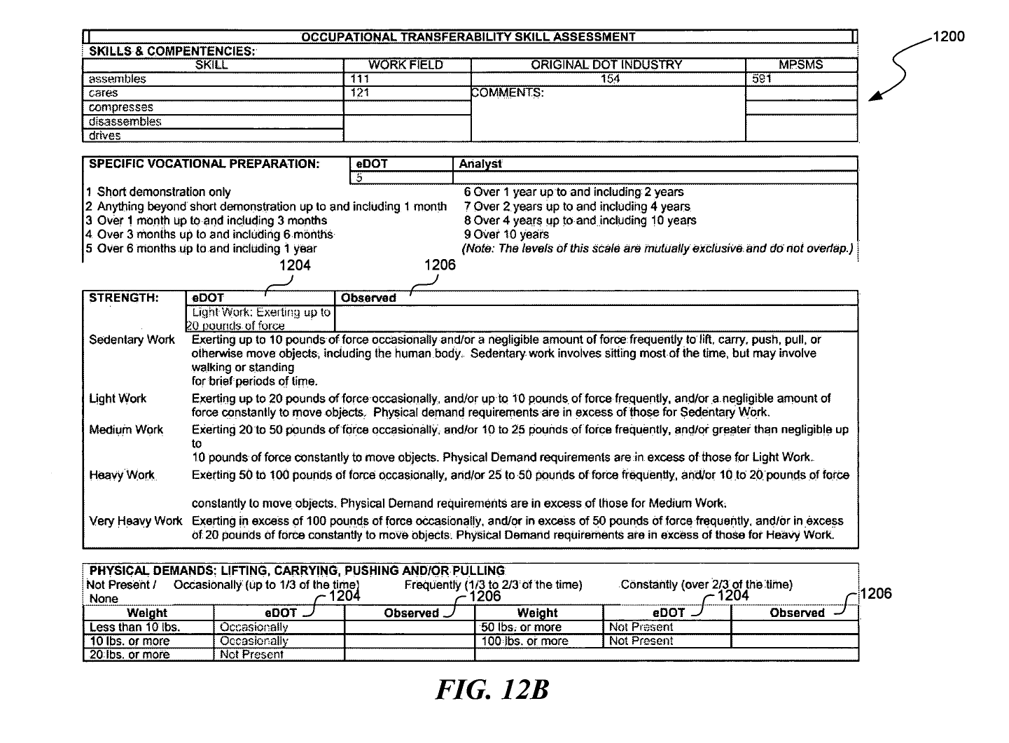

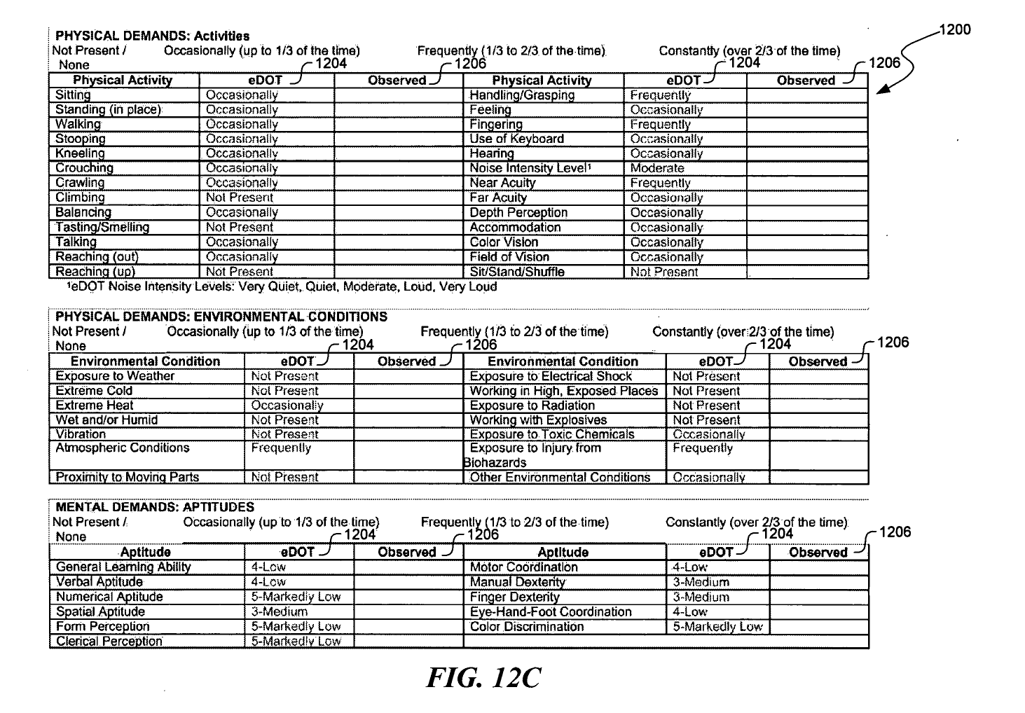

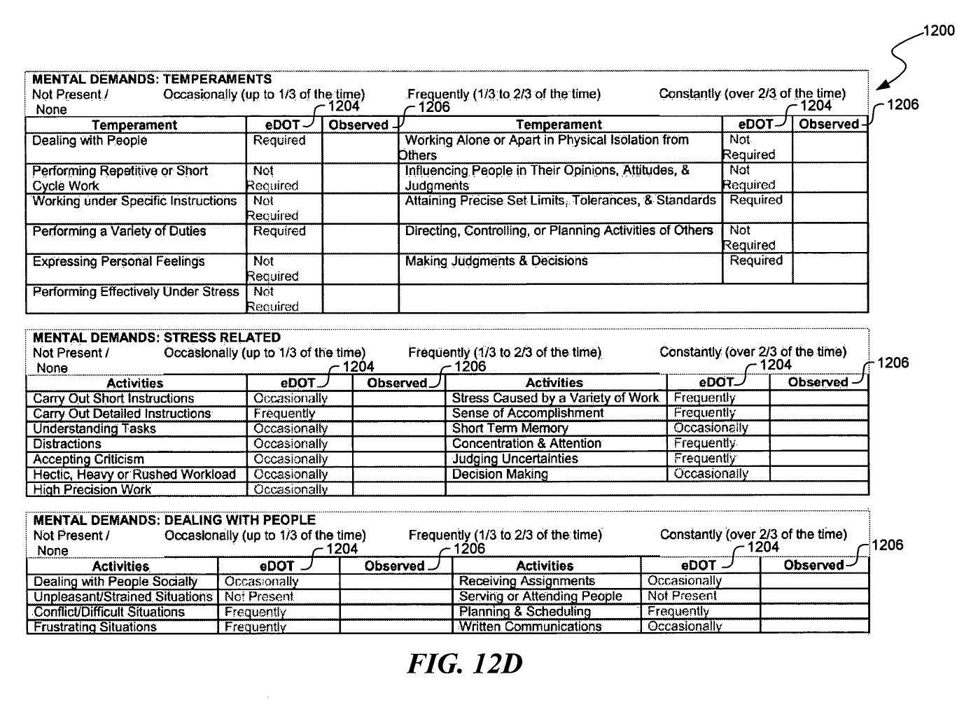

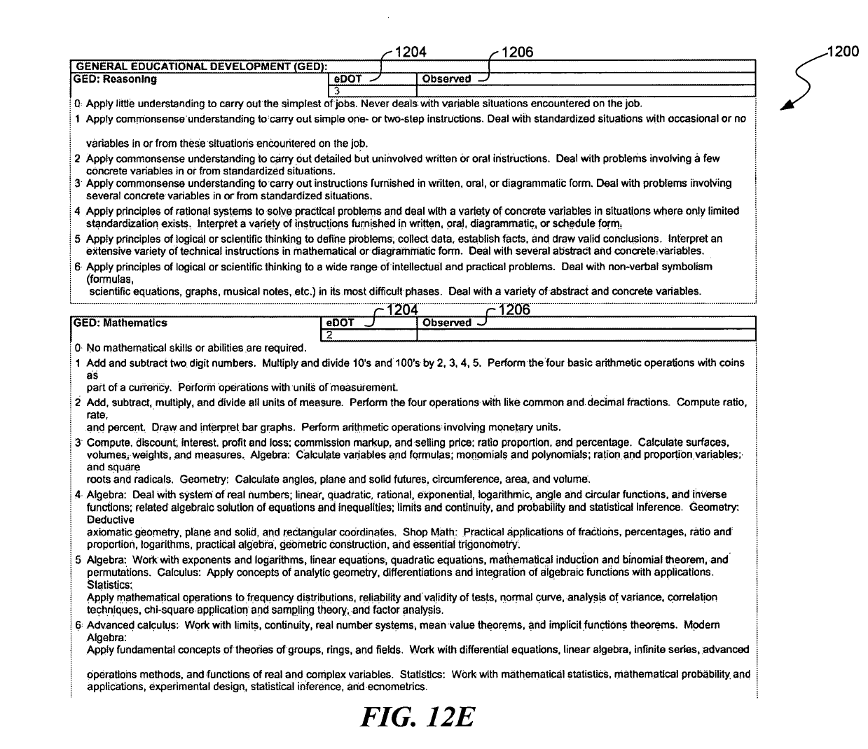

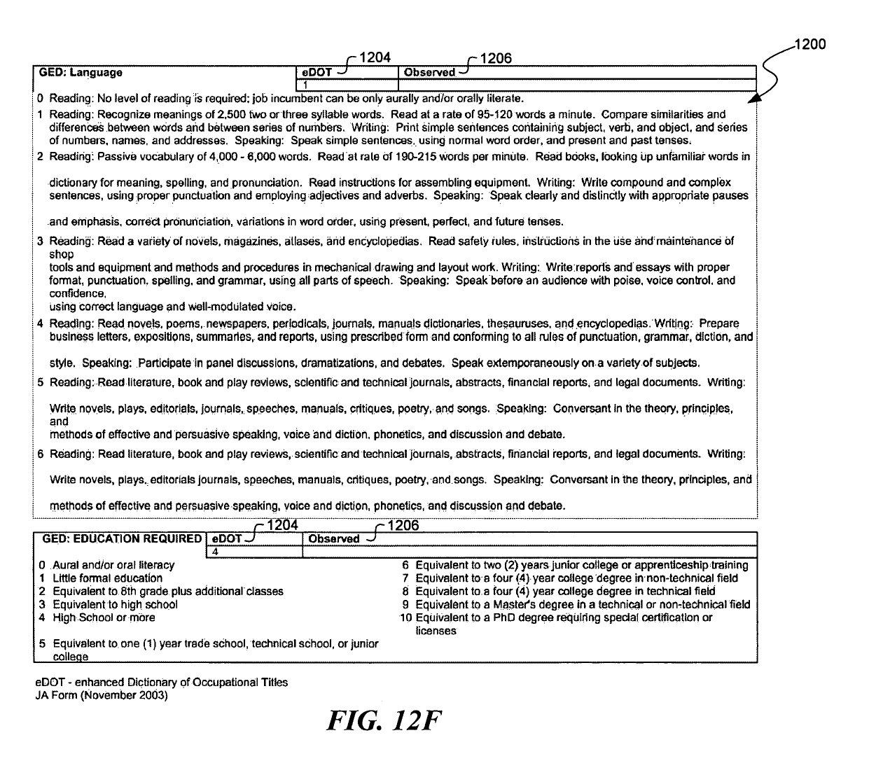

FIGS. 12A-12F are display diagrams showing an example of a generic job analysis form 1200. This form 1200 may be accessed via a job analysis form tab (not shown) provided in the client computer application. The form includes a job description portion 1202 (FIG. 12A). One function of this form 1200 is to provide basic information about a selected occupation (e.g., automobile mechanic) via an eDOT column 1204 (FIGS. 12B-12F) and to allow a user to input information for a particular application via an observed column 1206 (FIGS. 12B-12F). Each time an average work measure (e.g., kneeling=occasionally) reflected on the form 1200 changes (e.g., as a result of user input events), this change is noted in the eDOT columns 1204 of the generic job analysis form. In addition, the generic job analysis form 1200 may also identify measures that have remained consistent despite new user input. While in such cases the measures themselves may not have changed, a job count may still be tabulated on the job availability survey (see, e.g., FIG. 9) as a result of the user input. This is one of many practical examples of the cybernetic system described herein.

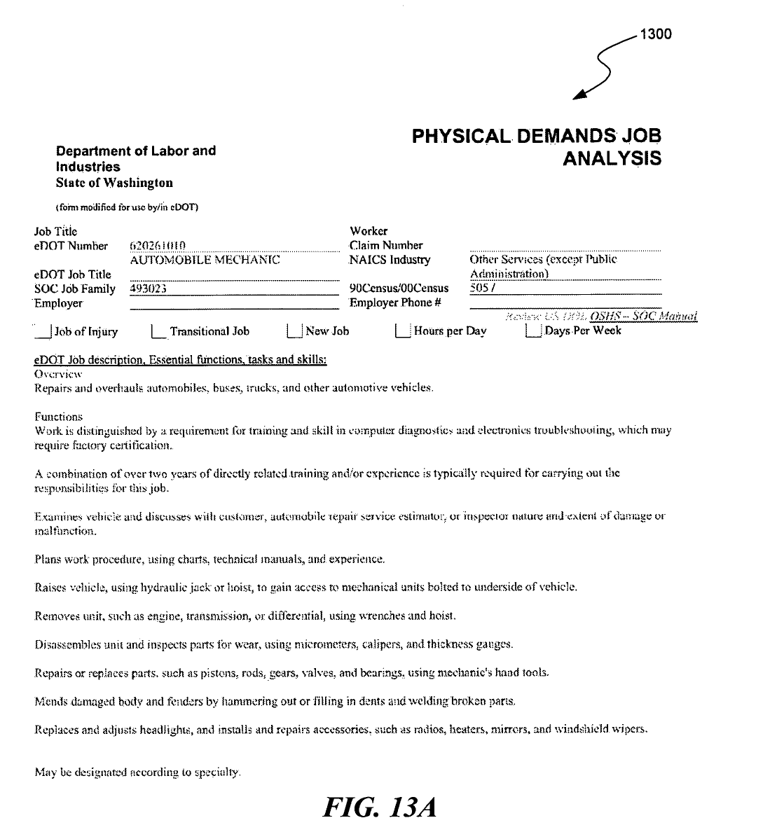

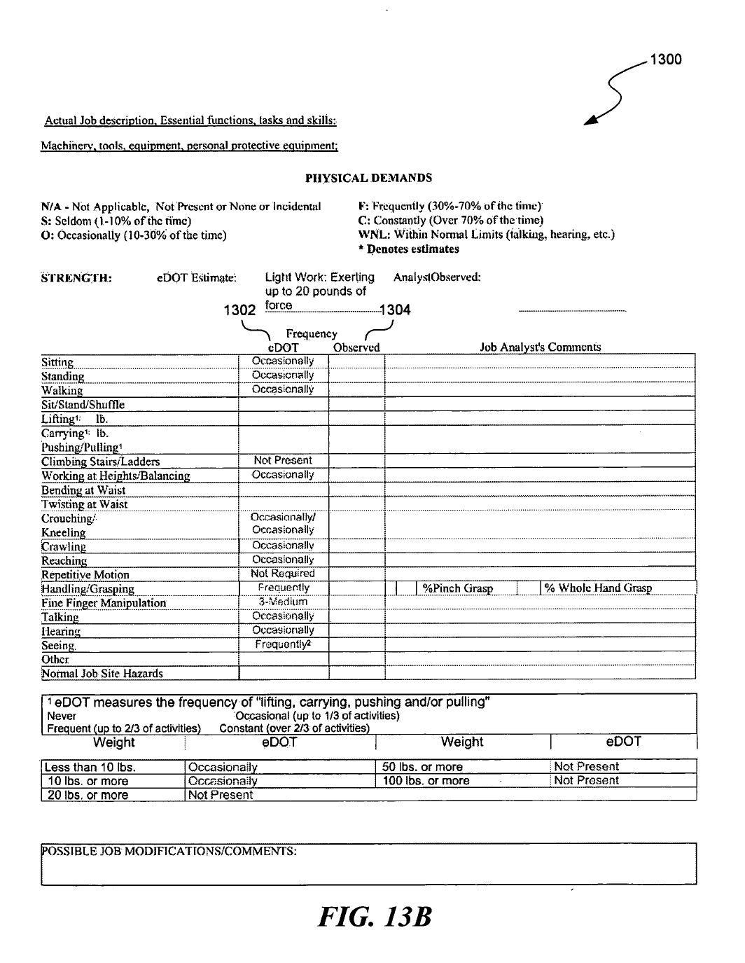

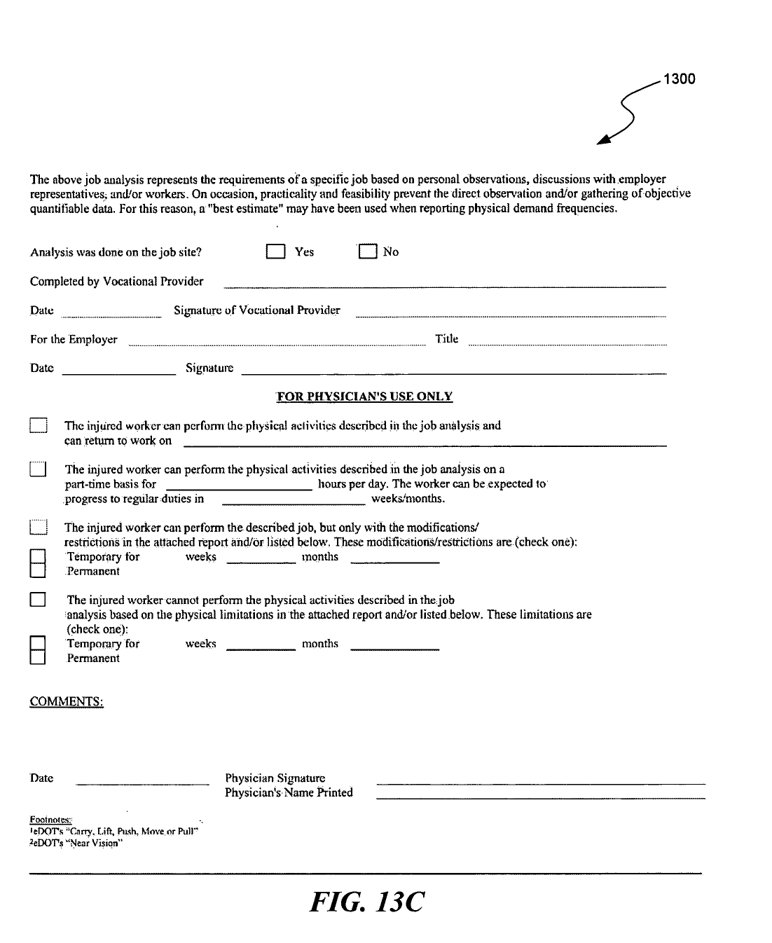

Referring to FIGS. 13A-13C, a state-specific job analysis form 1300 for the State of Washington may provide specific measures relevant to programs in that state (e.g., measures related to physical demands). Similar forms may be provided for other states or territories (e.g., Florida, New York, Puerto Rico, the Virgin Islands, etc.). This type of form may be useful where each state has its own Insurance Commissioner and process by which short-term work accident insurance is provided. Like the generic form 1200 of FIGS. 12A-12F, the information reflected on this form 1300 may change according to user input via the use of an eDOT column in combination with an observed column 1304. As with the form 1200 of FIGS. 12A-12F, data input made using the form 1300 is communicated to the raw data site on the server computer.

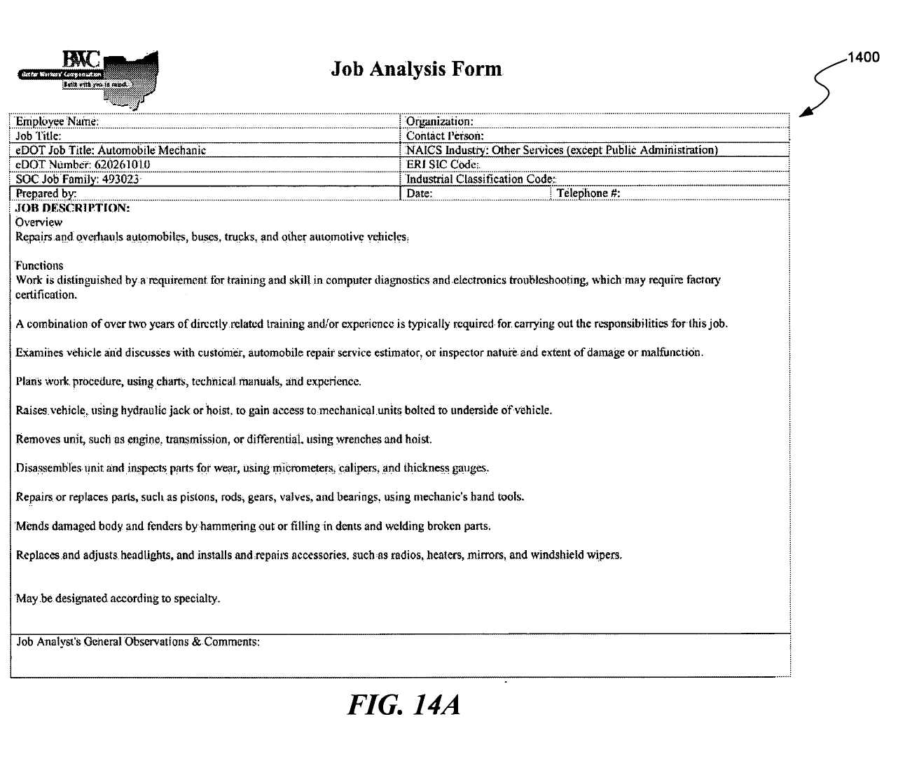

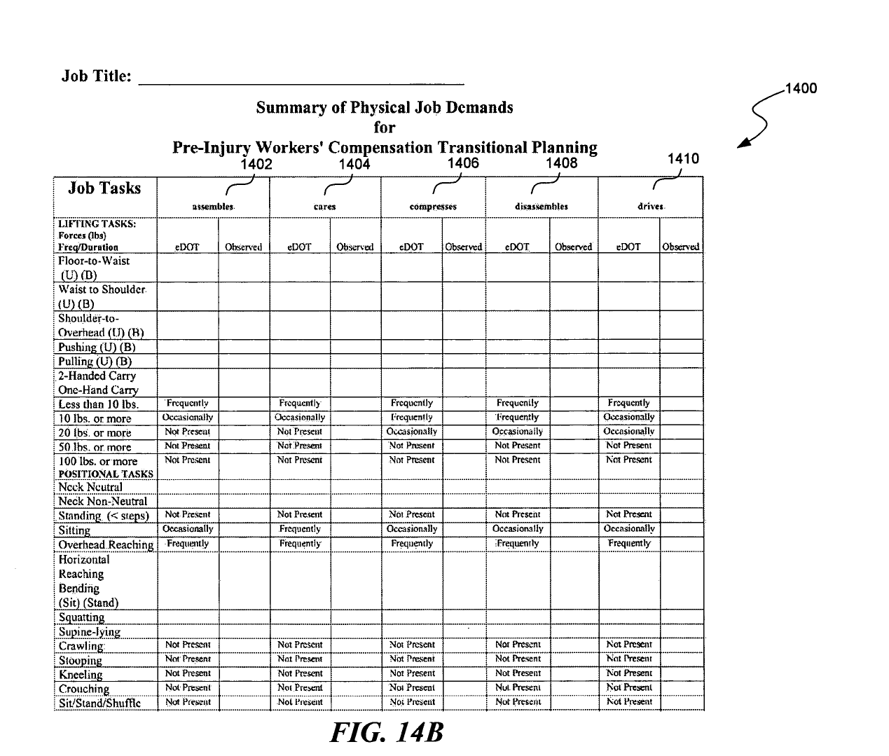

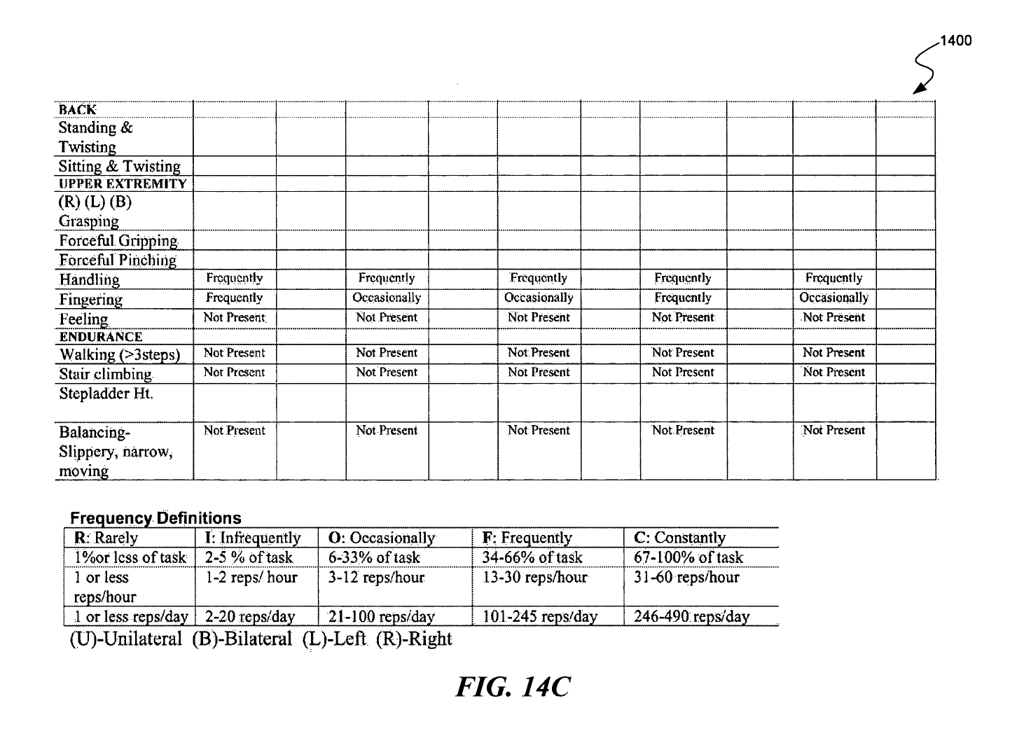

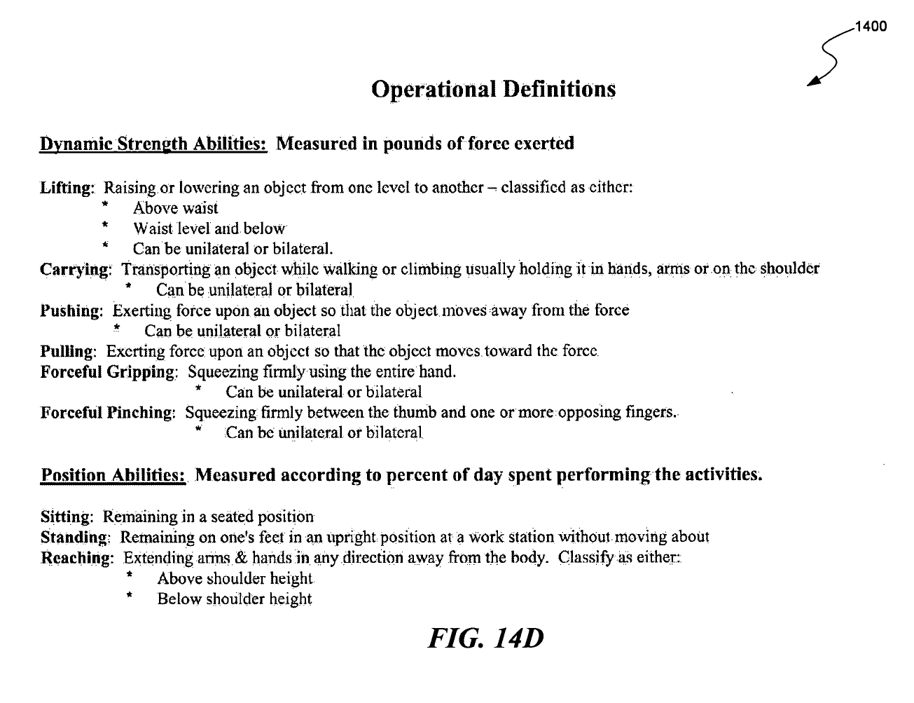

Referring to FIGS. 14A-14D, a job analysis form for the State of Ohio 1400 has additional state-specific features. For example, Ohio's programs focus on skills-based measures (rather than work-based measures). This focus on skills-based measures is reflected in the form 1400 via skills columns (1402-1410), which are shown most completely in FIG. 14B. When information relating to this form 1400 is collected, the client computer application communicates both the skills selected and the ordering (importance) of those skills in a rank order by column (not shown). State forms can also be configured for facilitating workers compensation determinations and unemployment insurance determinations.

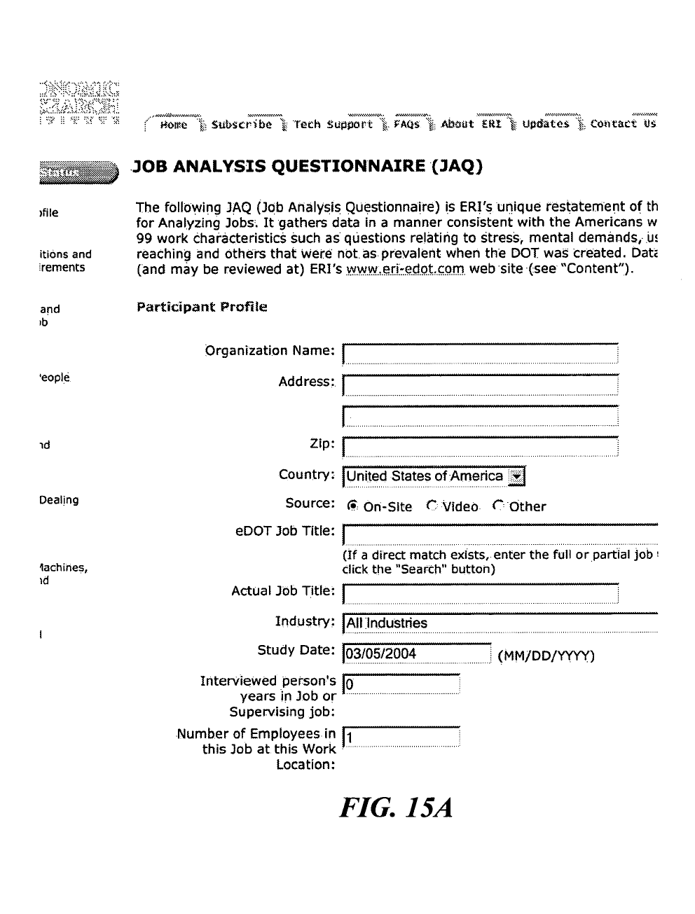

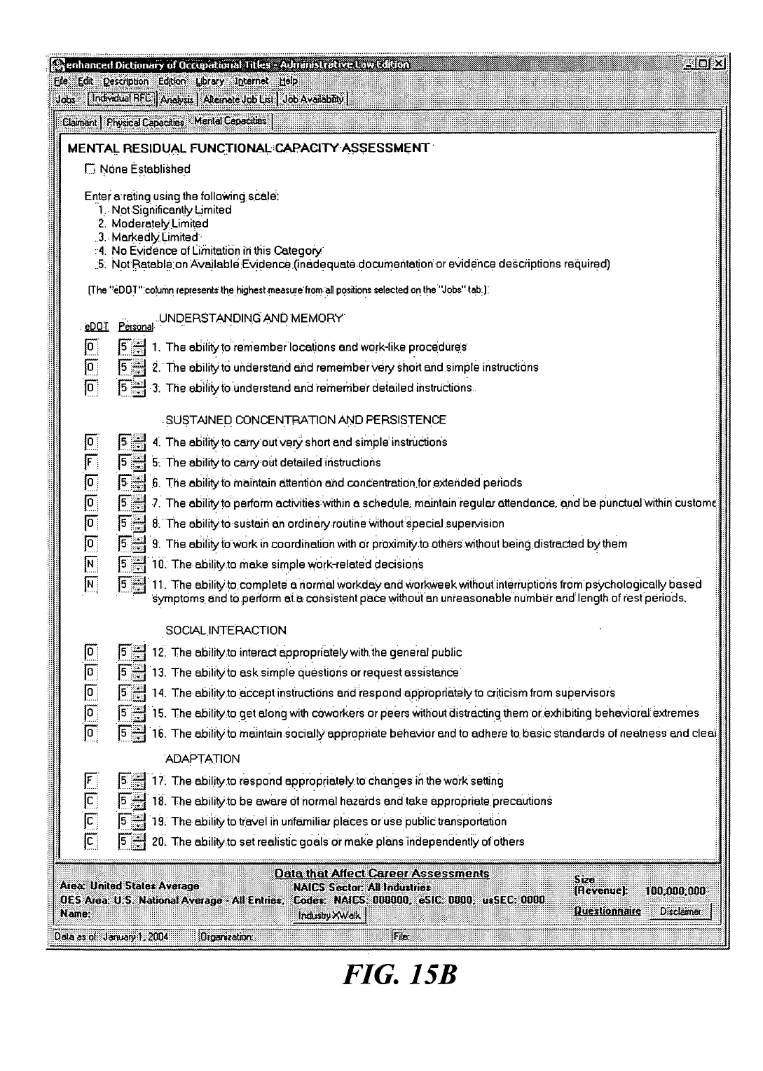

While job analysis forms provide one means for collecting and providing occupational information, a job analysis questionnaire (JAQ) or similar forms can also be used. Referring to FIG. 15A, the client computer application may provide a JAQ form 1500 that is accessed by a tab in the user interface of the client computer application. When a user is using this form 1500, information collected from the user about the various measures are communicated to the server computer raw database.

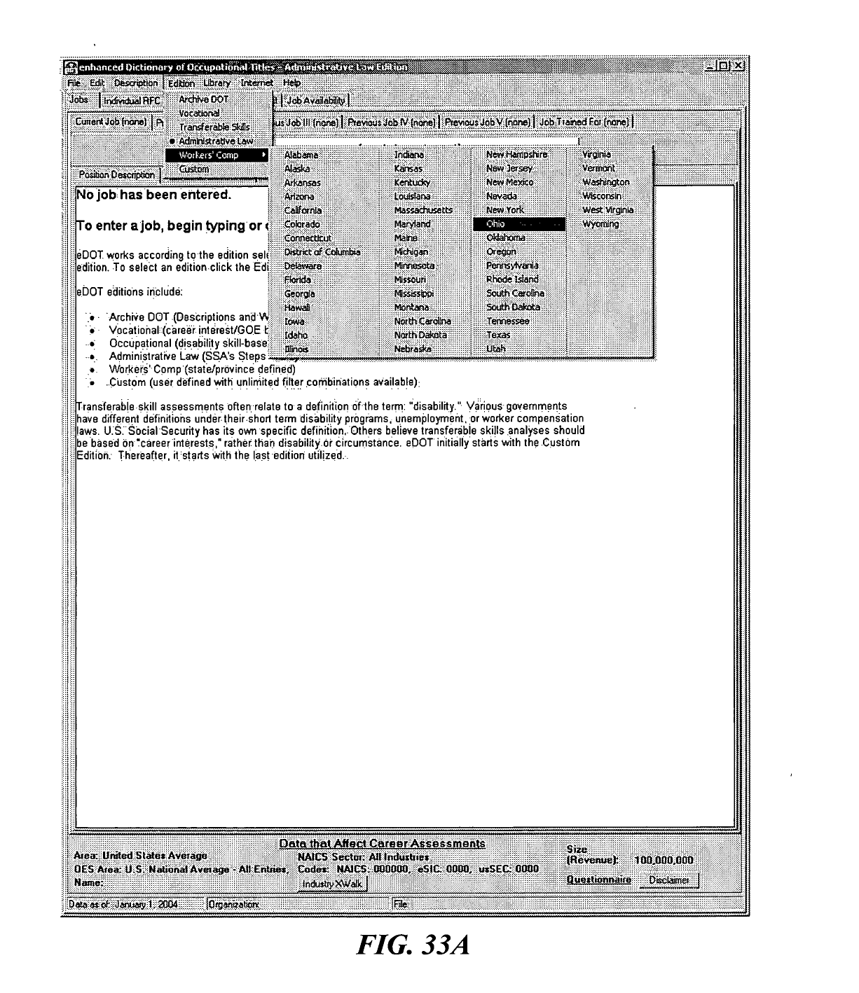

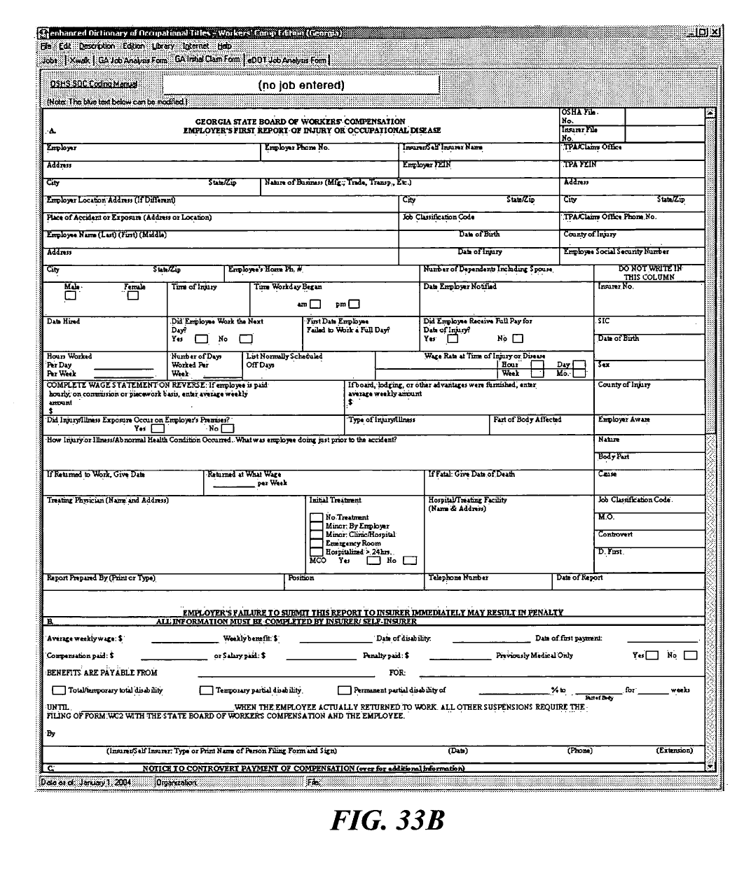

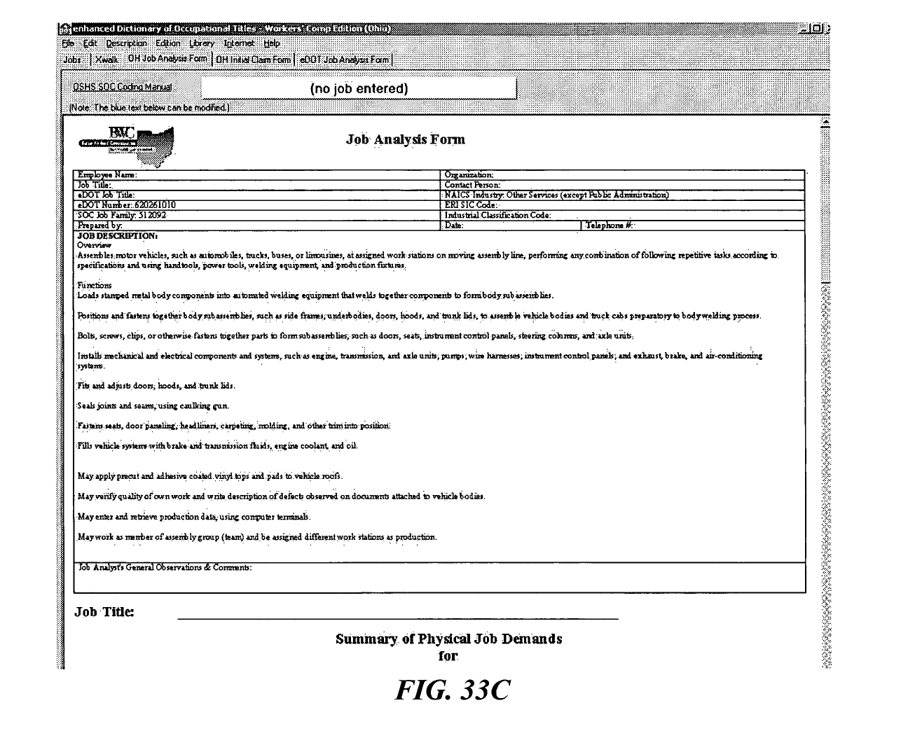

The format of the JAQ form 1500 (and like forms) may vary. For example, referring to FIG. 15B, a format of a questionnaire form 1520 from a workers' compensation edition (described in more detail with respect to FIGS. 33A-33C) models publicly available work desk papers used by disability determination adjudicators.

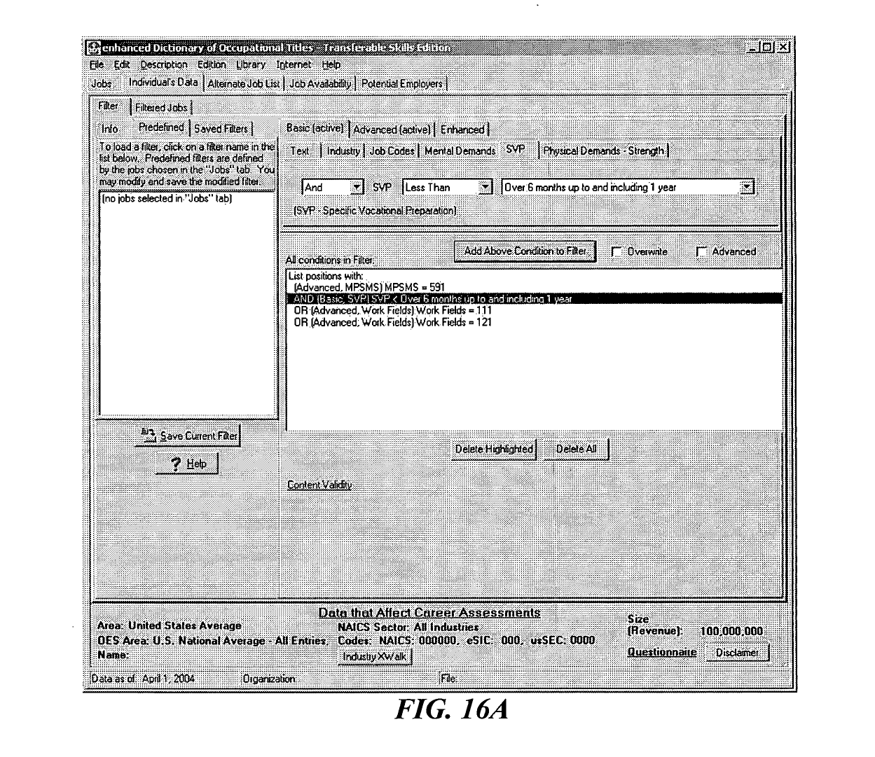

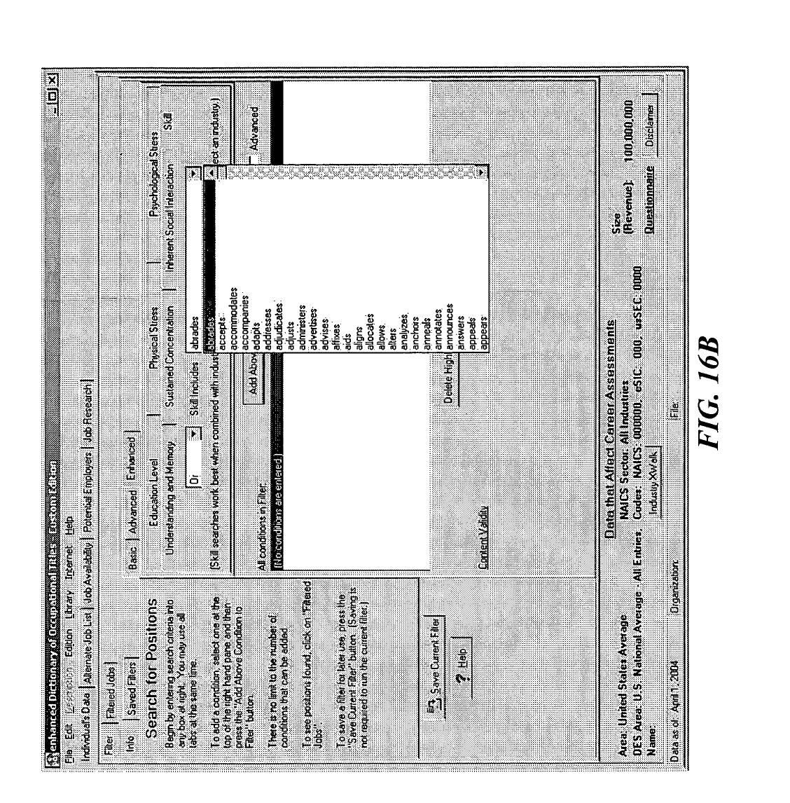

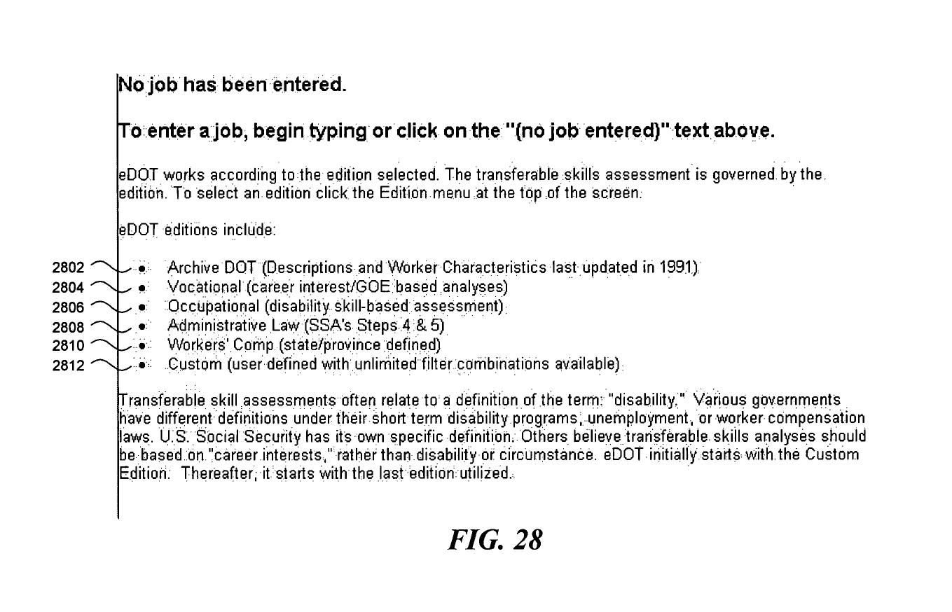

Referring to FIGS. 16A and 16B, one or more job skills filters allow users of the client computer application to find job descriptions in the collection that correspond to certain selected skills. As shown in FIG. 16A, the user may select to display a skill listing and query for jobs that correspond to those skills using the interface provided by the client computer application. Any skills input from the user is communicated to the server computer's raw database. Various editions of the client computer application (described in more detail with respect to FIGS. 28-34) may utilize the server computer and its associated databases to perform queries. The client computer application may also have the ability to create a filter based on work fields and MPSMS (materials, products, subject matter, or services) codes or phrases of the old DOT (using enhanced/updated work measures), or to create a filter based on new skill verbs.

FIG. 16B shows a drop down menu containing a list of skill words (verbs) that allow the user to identify a position description (or collection of jobs/descriptions) that have those verbs. In addition to user-identified skills, the client computer application may automatically identify the skills associated with an individual's past, present, and “prepared for” job history. The client computer application automatically selects all other jobs that contain those skill verbs. A user may also change this preset assumption to the skills filter (clear all) and input whatever skill verbs they desire. These added skill verbs are ultimately collected by the server and may then be added to the collection.

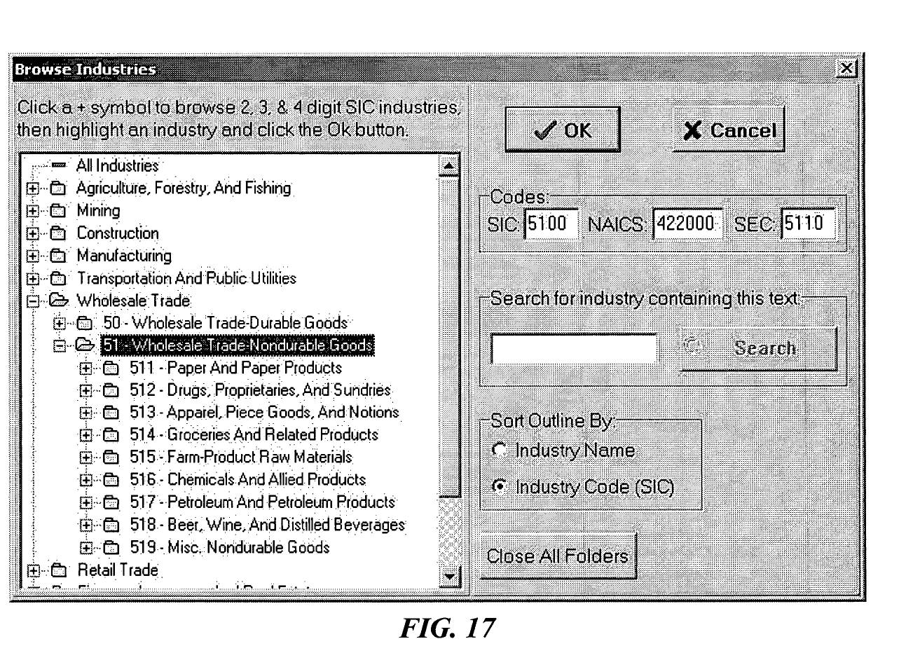

The facility allows specific job descriptions to be associated with one or more job industries. Referring to FIG. 17, the client computer application provides a forum for users to change the industry in which a position resides. Such changes are then communicated to the server computer. Associations between specific jobs and industries may be used when providing crosswalks to various industry classification systems. In some embodiments, the facility uses default job/industry associations provided by systems such as the new North American Industrial Classification System (“NAICS”).

Each of the above-described sources (FIGS. 11-17) provides data to the client computer application and ultimately to the server computer databases. As professional users change measures or identify specific jobs of interest, this data is communicated and logged on the server computer. In turn, the server computer creates average measures and specific job availability statistics from this data for use by the client computer. The result is a cybernetic system of maintaining a specific occupational (job) database.

B. Data Collected from Sources Other than the Client Computer Application

As shown, the sources of information used for updating and maintaining the collection of job information may vary, and many different sources may be employed, including sources external to the client computer application. Such sources include, for example, free Internet sites (e.g., SalaryExpert.com of Vancouver, Wash.), computer-based field analysis by experts (e.g., a job analyst questionnaire), salary survey services (e.g., a salary survey wizard), content raw data sites, etc.

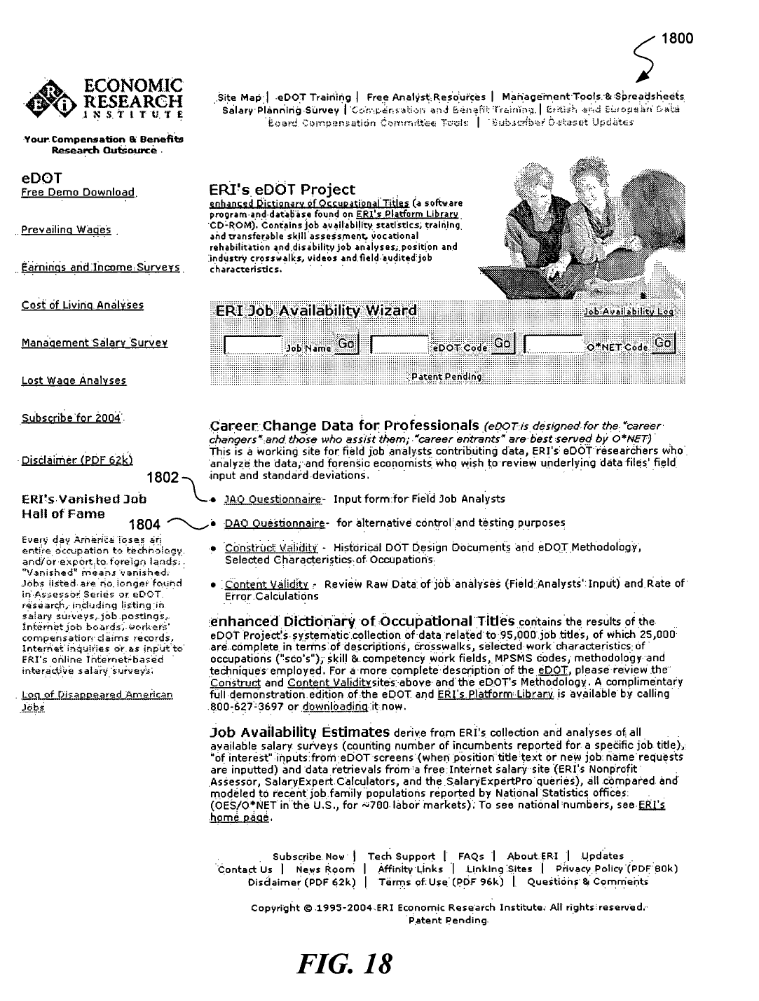

For example, referring to FIG. 18, the system may include a working site 1800 for professional field job analysts. Field job analysts who use the working site (e.g., researchers who analyze data and forensic economists who wish to review underlying field input and standard deviation information) provide a steady stream of raw data by using the site. Users such as researchers, attorneys, and expert witnesses can then review the input of field analysts via a raw data site, described in more detail below.

As illustrated in FIG. 18, the working site 1800 may include a home page from which different raw data site tools can be accessed. For example, various JAQ and DAQ questionnaires can be accessed from this site via links (1802 and 1804, respectively). An example of a JAQ form is provided in FIG. 15. As described with respect to that Figure, the JAQ and DAQ questionnaires may also be accessed via the client computer application. The system logs the information collected from the JAQ or DAQ into a raw data database. The data may then be used directly or aggregated with other information to provide data for the collection of job information or the raw data site.

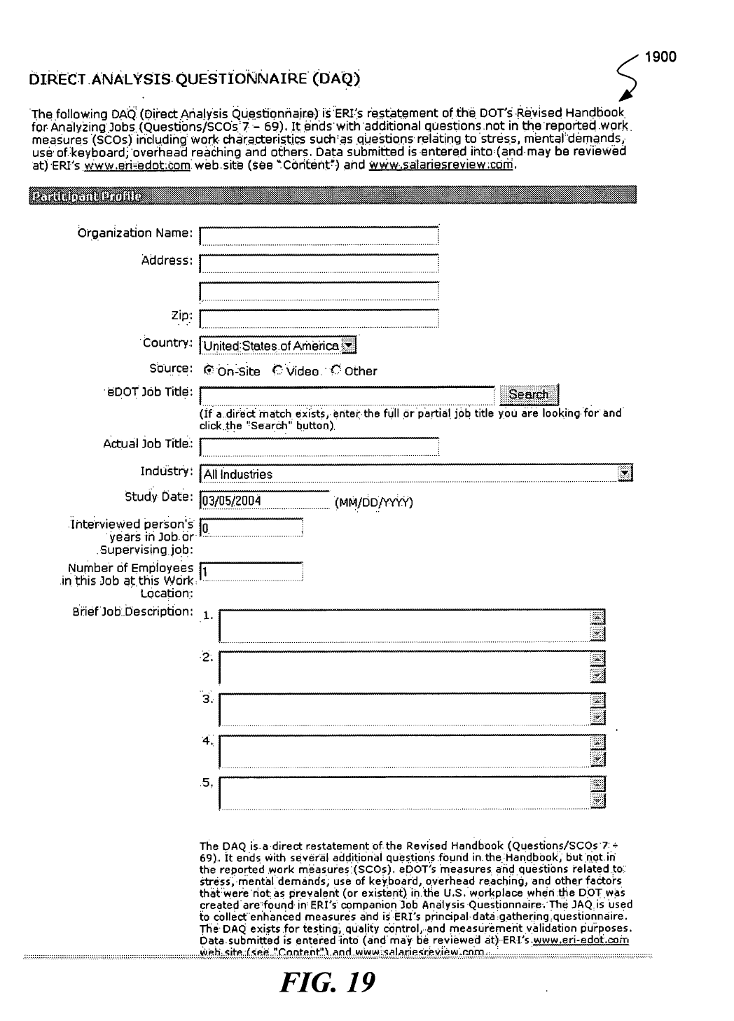

An example of DAQ form 1900 is illustrated in FIG. 19. The types of questions may be similar to those on the JAQ form, but unlike the JAQ form, specially configured questions on the DAQ form 1900 allows it to be submitted directly to a raw data work measures database.

Both the JAQ and the DAQ forms may come “filled-in” with default answers so that if a field analyst wishes to change only one/entry/measure, he or she can do so without having to fill in the entire questionnaire. The questionnaires may be associated with algorithms to convert questionnaire answers into system measures. Information may then be collected from this site and incorporated into the system's collection of information. Similar techniques based on user input and data gathering via the Internet and within a software application (e.g., a cold-fusion program for the Web, Delphi Pascal for the PC) may also be implemented. As the facility transfers input to one or more raw data sites, it may also update measures associated with the inputs in terms of what is displayed to users.

Aside from the data collection methods described above, the facility may implement various methods for interviewing or submitting written questions to multiple job holders or managers about the functions and attributes of a specific job. The facility may then use the results of those interviews/answers to develop a mathematics-based categorization of the physical and mental requirements of that specific job. As a next step of this process, the facility can employ a mathematical computation to identify other jobs for which a person would be qualified. The facility can also support the process of interviewing or submitting written questions to multiple jobholders or managers regarding the compensation being paid for a specific job. The facility can then use the results of those interviews/answers to develop a range of compensation (including such factors as geographic location, industry, experience, etc.) for a specific job. Using such questionnaires, employee self-job analyses may also be performed. Approaches to improve data self-collection, including assisting in developing Internet collection sites, may be implemented.

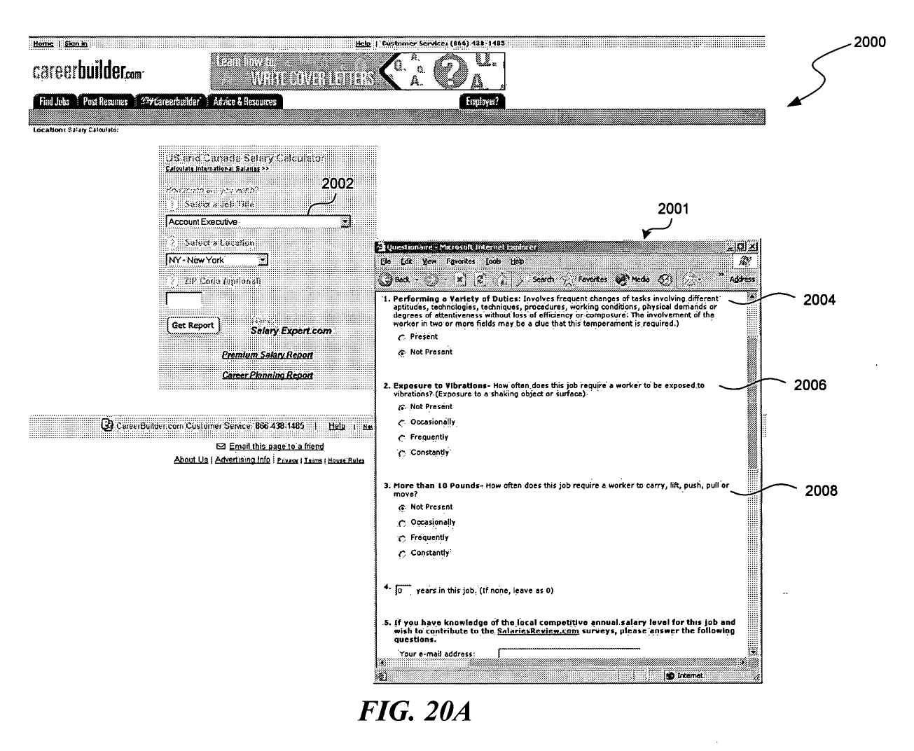

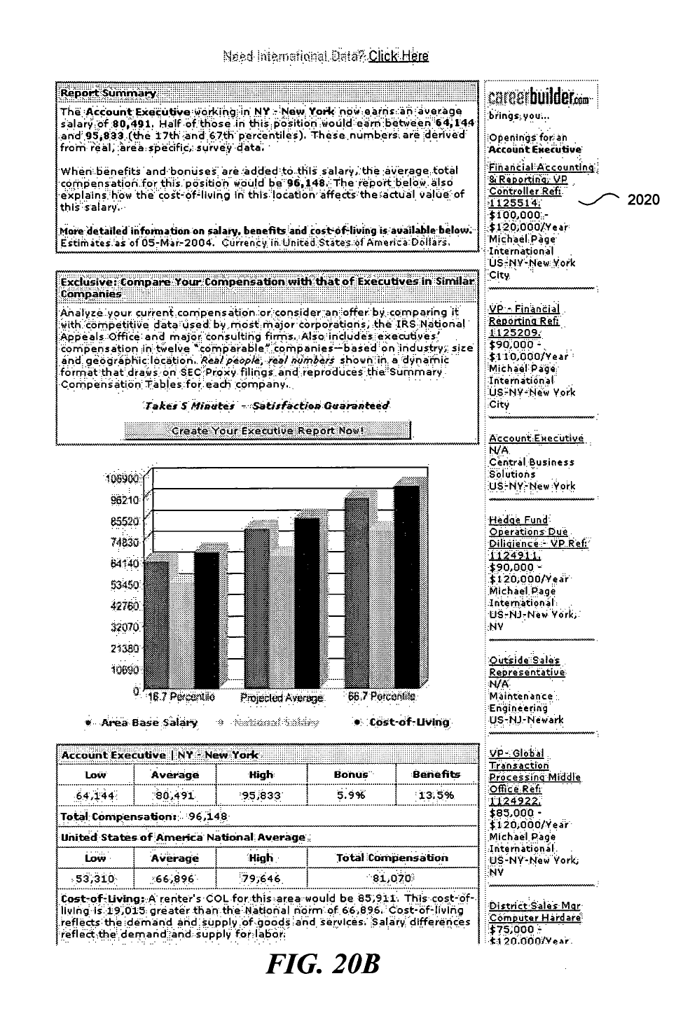

The collection of occupational information may also be updated using one or more Internet sources, such as related free data sites (e.g., job board sites and sites offering salary information, etc.) that use techniques such as a submit button to gather data regarding new jobs. Free Internet data sites may also collect information about populations of specific jobs reported by private and public salary surveys. In this way, the system can facilitate the creation of specific job availability estimates. Examples of such sites are the careerbuilder.com™ site (FIGS. 20A and 20B) and the SalaryExpert ePro site (FIGS. 21A-21D). Millions of users visit these types of Internet sites annually and may thus provide reliable raw data for job availability. For example, each time a query regarding a specific job is made, an interest in that job is logged. The facility may employ techniques on these Internet sites that are specially created to assist in the revision and analysis of occupations listed in the collection of occupational information.

Referring to FIG. 20A, a page 2000 from the careerbuilder.com™ Web site shows a pop-up screen 2001 from which users can submit answers to questions about various worker measures for a selected job or position 2002 (e.g., account executive). To encourage the user to answer the questions, the user may be offered some incentive for submitting input on the pop-up screen. For example, as illustrated, the user is offered a salary report for answering questions related to performing a variety of duties 2004, exposure to vibrations 2006, and work with more than ten pounds 2008. When users provide answers to the questions, their input is then submitted to the system servers of the facility. These sites may include free versions (e.g., 24,000 job titles) or for fee versions (e.g., 100,800 job titles). In exchange for submitting their input, referring to FIG. 20B, the careerbuilder.com Web site may provide a report summary based on the provided information. The Web site may also post various job openings 2020.

Referring to FIG. 21A, a SalaryExpert site 2100 allows users to obtain salary information for a selected job. When the user requests the salary information, a pop-up screen 2102 with questions appears (similar to the pop-up screen 2001 of FIG. 20A). The pop-up screen may provide fields to collect text data (as well as radio buttons or checkboxes). For example, the site may provide a field 2104 for the user to enter information known about competitive salaries or a set of fields 2106 for a user to enter information about skills used in a selected occupation. Like the careerbuilder.com site 2000, information collected from the users of the site contributes worker measure and job count data to the facility. The user may provide the information requested in the pop-up screen 2102 voluntarily or in exchange for information that the user is requesting. Additional examples of questions that the site may pose to the user (in exchange for a salary report) are illustrated in FIG. 21B. These questions may relate to the various measures tracked by the facility in association with the collection of occupational information. In addition, via a set of blank skills text fields 2108, users may be asked to provide information about key skills associated with a job so that the facility can create new skills and measures

Referring to FIG. 21C, the SalaryExpert site may also offer a premium salary report 2110 that obtains additional information from a user, which the facility may also use as raw data. The obtained information may include personal information 2112, position information 2114, education and training information 2116, location information 2118, compensation information 2120, etc. In addition, a special section provides skills information to the user.

Referring to FIG. 21D, after the user submits answers to the question on the premium salary report input form, the SalaryExpert site provides the user with a report 2130 for the selected position (e.g., accountant).

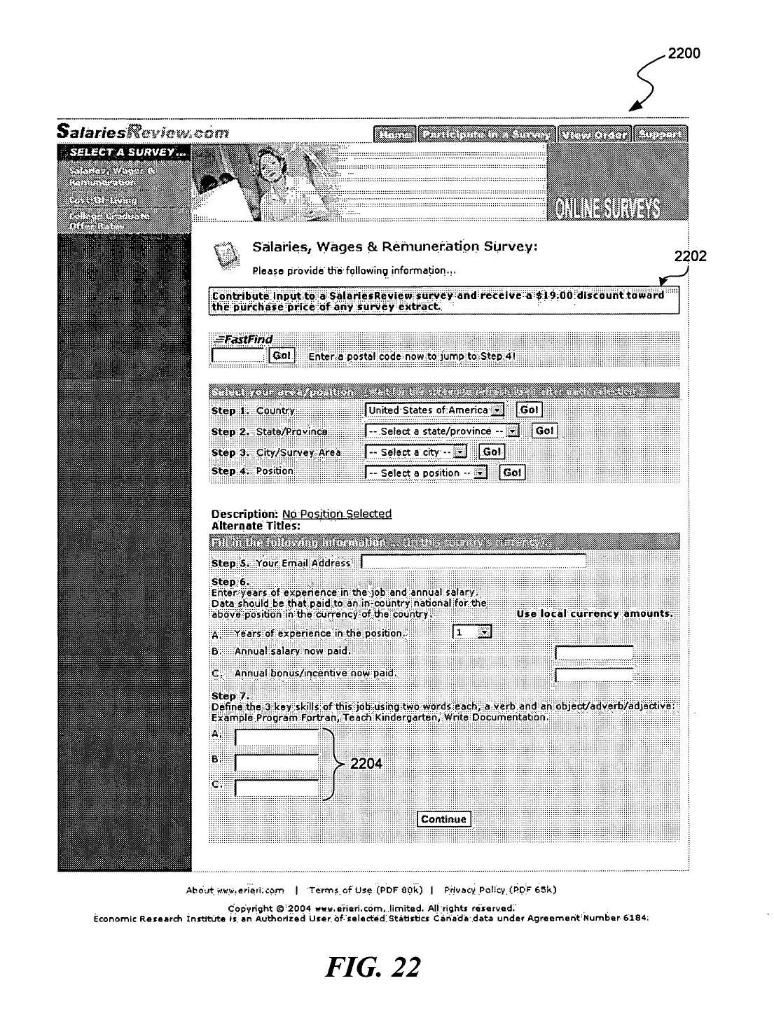

FIG. 22 shows a similar site, SalariesReview.com 2200. This site provides a salaries, wages, and remuneration survey that allows the user to obtain a price discount 2202 on requested information. Like the pop-up screen on the SalaryExpert ePro site, this survey collects skills information 2204 for a selected job or occupation, as well as other information that may be employed by the facility.

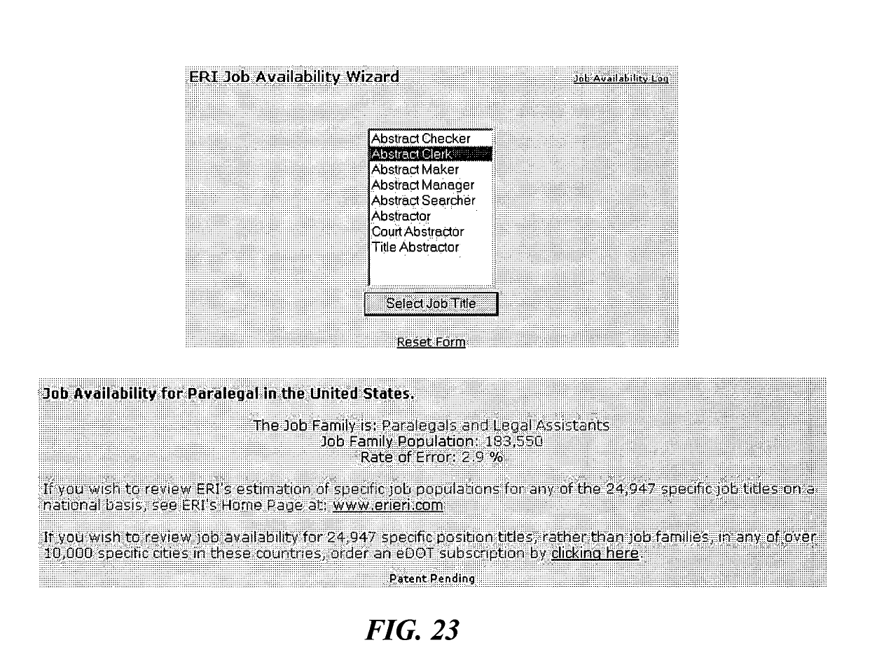

Referring to FIG. 23, other sources of information for job availability estimates include a job availability service wizard that allows visitors to register their interest in a position by querying for job availability information surveys by position name, job code, area, industry, etc. The job availability service wizard then provides information about job populations. In the example shown in FIG. 23, the facility may log an interest in a position (e.g., abstract clerk) each time the database is queried for a selected position's data. Likewise, information may be logged from services that provide career reports, etc.

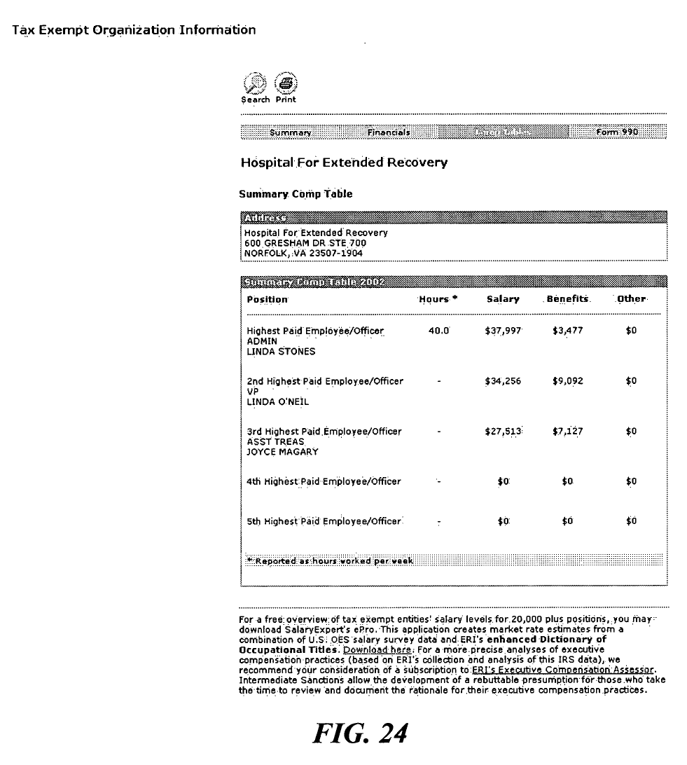

Referring to FIG. 24, yet another example of a source for job information collected by the system is an executive database (such as a database used by tax-exempt organizations). While access to this type of database may not be public (e.g., via the Internet), such databases may be linked to the server computer and databases of the facility, allowing additional occupational information to be collected.

IV. Metadata

Not only does the facility collect raw data and related information, but it also provides access to metadata (the ability to view and update the facility's datasets). For example, field audit content is not only used to create work measures but also to provide reasons and support for these measures. In this way, users may qualify and verify the information provided by the facility for certain uses. In some instances, independent researchers may recombine the collected data for a particular use.

The facility's metadata may be available through various means. For example, in some embodiments, the metadata is available, at least in part, via the raw data site. In some embodiments, the raw data is available through a module of the client computer application (a module that accesses the server computer's raw datasets).

Job analysts and other users may access construct validity (e.g., historic DOT design documents and methodology reports), content validity (allowing for review of raw data), and rate of error calculations via the working site or the client computer application. The provisions of several mass-market reports may also be included as they too contribute counts to the total and daily logs found in the job availability survey.

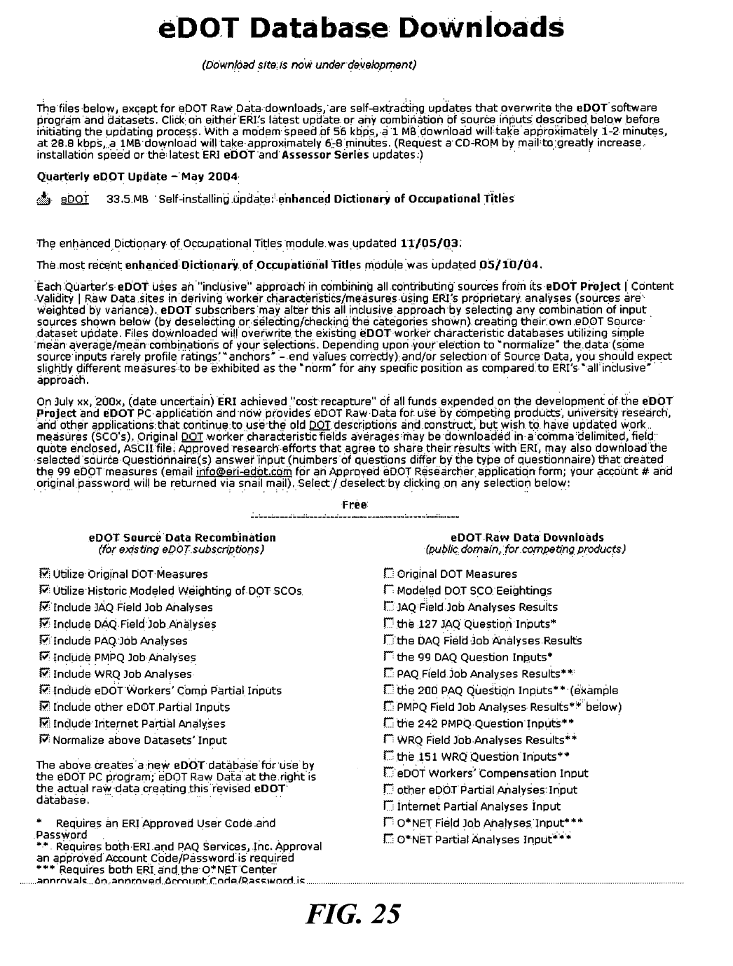

Referring to FIG. 25, a database downloads site is provided for independent researchers to download metadata for further research and/or for users of the system to create databases of slightly differing weights based upon the data sources that are selected. Users may provide their own weightings and measures by downloading differing mixes of raw data. How the facility itself weights the data for use in providing information associated with the collection of occupational information is a matter of proprietary interest. The weighting of full and partial analyses may vary over time based on the variance found in various data sources or the subjective judgment of those who periodically capture norms for use on the client computer application.

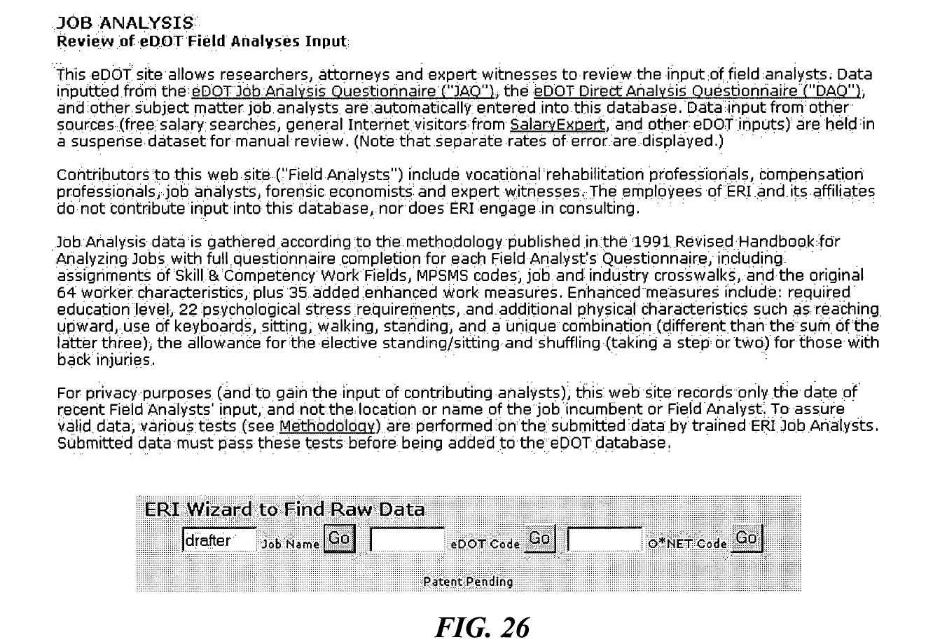

FIG. 26 displays an example of a method by which a user reviews raw data collected by the facility beginning with data collected at a project database home page. To assure valid data, various tests or review of inputted data from raw data sites or Internet sites may be made before depositing into a system database. For example, JAQ data entered from the raw data site may be coded differently than data entered from within the program for accessing the collection of occupational information. In a further example, data collected using the raw data site can be specially marked (e.g., coded with an “xx” identifying its source) so that a professional job analyst or researcher can review it manually before it is added to results such as mean and/or standard deviation calculations. The facility can then compute a standard deviation for each of the available job attributes and work measure or characteristic ratings using data entered into the raw data site. The rounded average rating will most likely not change as a result of new input, while the standard deviation will almost always change. Using the measures last published by the U.S. government as “seed” data, the facility can capture variances of each of these measures (their ability to estimate all other measures).

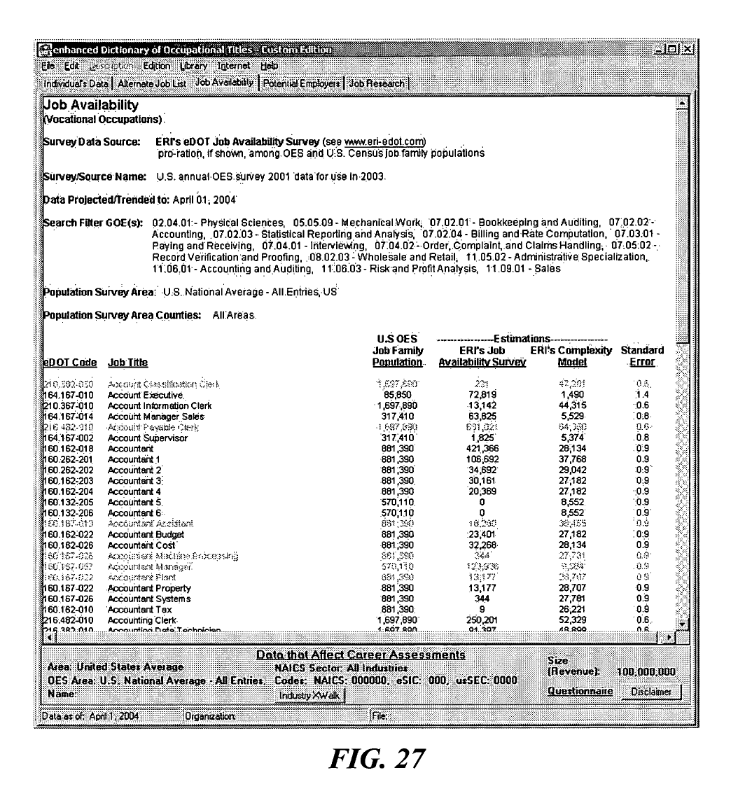

FIG. 27 illustrates the application of data from a data source for the creation of specific job ratios for use by the facility. This screen may be accessed on the Server Computer as found in any Job Availability Tab on Client Computer program editions.

V. Editions and Filters

The client computer application associated with the collection of occupational information may provide several screens as part of an interface shown in FIGS. 28-53 (and also in Appendix A of U.S. Provisional Patent Application No. 60/456,838, which has been incorporated herein by reference). In some embodiments, the interface of the client computer application allows users to move about the client computer program with the use of key strokes (e.g., Alt-T, Alt-S, etc.) with the intention of enabling those with disabilities to also have the opportunity to access and utilize this data and program(s).

The various screens of the client computer application may be associated with a particular “edition” or version of the collection of occupational information (e.g., custom, archive, workers' compensation, occupational, career interest, disability determination, vocational, professional, etc.). In some embodiments, the edition or version corresponds with a particular user group (e.g., government job analysts, career counselors, disability determination analysts, etc.). For example, users who are trying to assess workers with disabilities may find one version or edition more useful than another, depending on the definition of “disability” being used. To illustrate, a person can be disabled under a company disability plan and/or Workers'Compensation that varies by state and not receive Social Security disability benefits. Alternatively, one can receive Social Security disability benefits without qualifying under other types of coverage under a state's disability determination plan. The reason for this is that Social Security, Workers' Compensation, and private disability plans all have differing definitions of disability (the State of California allows “psychiatric” and is unique among all other state plans, the State of Ohio utilizes “skills” to assess disability, Social Security assesses all these plus job availability in their unique Step 1-5 Disability Determination Process, etc.) The area of disability assessment alone produces a demand for differing editions. As a result, the facility may provide several editions (e.g., there are 54 differing state workers' compensation subeditions).

Referring to FIG. 28, an introductory screen is used to describe various editions of the client computer application, each of which provides access and contributes to the facility's raw data collection and job availability survey data. The editions may include an archive DOT edition 2802, a vocational (career interests) edition 2804, an occupational (disability skill-based) edition 2806, an administrative law edition 2808, a workers' comp edition 2810, a vocational rehabilitation edition, a custom edition 2812, etc.

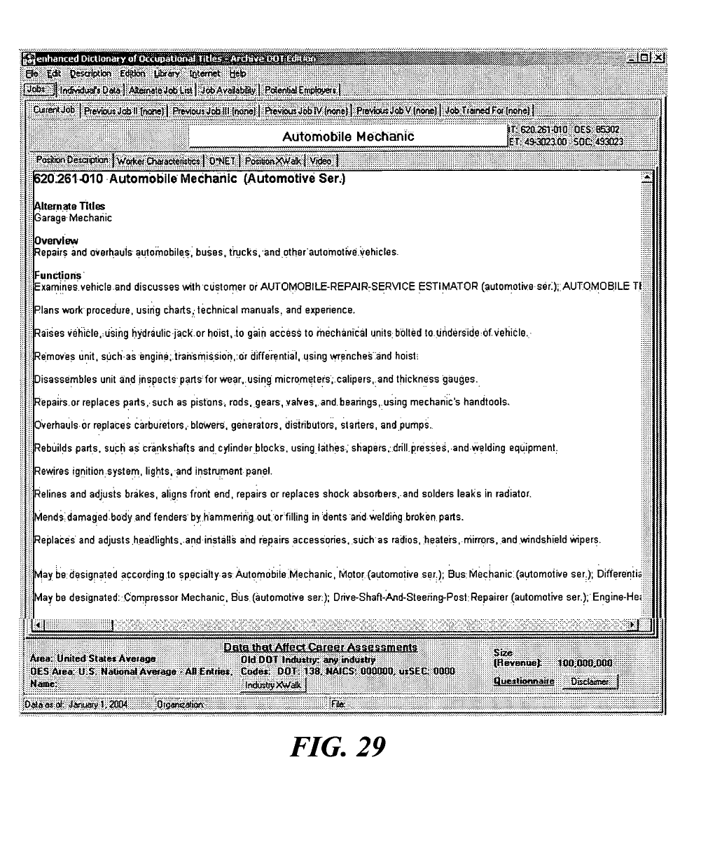

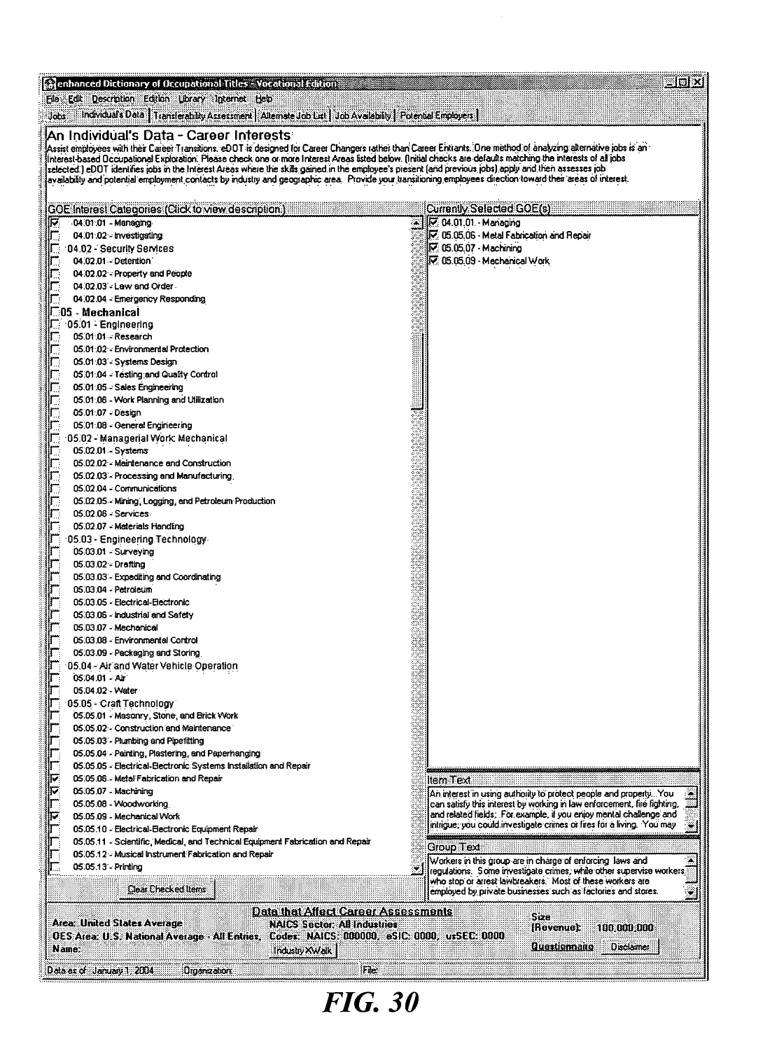

Referring to FIG. 29, the archive DOT edition operates off a read-only archived noncopyrighted database from the 1991 Dictionary of Occupational Titles. Available to users without a license code, this data is useful in comparisons of work as it existed in 1974 as compared to 2004. For example, in the 1970s, computer diagnostics were not part of the automotive mechanic's job description. One identifying feature of each of the different editions is the edition's filter capabilities. For example, in the illustrated embodiment, the filter in the archive edition is similar only to that in the custom edition. The various filters are described in more detail with respect to FIGS. 30-59.

Referring to FIG. 30, the vocational (career interests) edition may have its own version of a job screen from which a user can access several tabs. An individual's data tab assists individuals with career transitions by providing a tool for interest-based occupational exploration. The user checks one or more interest areas. The career interest edition utilizes an updated version of the Guide for Occupational Exploration code. This code (and its associated database) is originally found in the historical collection of occupational information (old DOT), but it had not been updated since the late 1970s and was abandoned. The career interests edition also utilizes work measures related to interests. This format is especially useful to workers who have labored in professions in which they have little interest (e.g., an automobile mechanic who wishes to explore occupations that are artistic in nature).

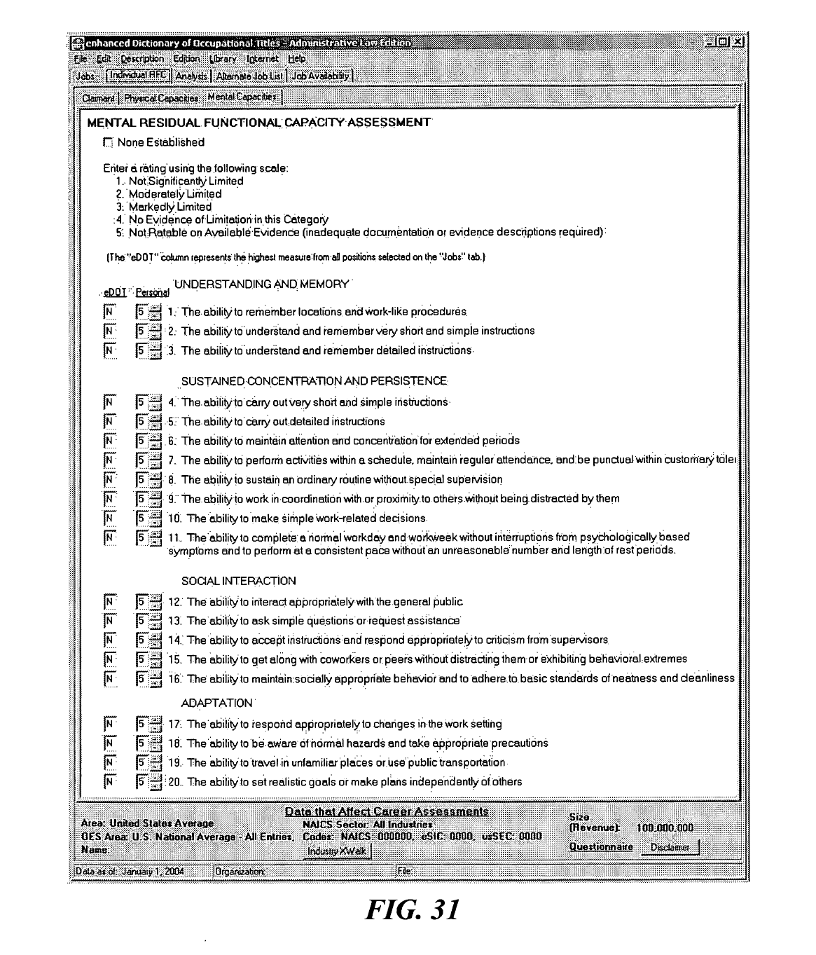

Referring to FIG. 31, the administrative law edition may have its own versions of a job screen from which a user can access a set of tabs or filters used for selecting alternative jobs. The facility may provide this set of tabs or filters based on, for example, residual functional capacity reviews typically performed by making a disability determination. In some embodiments, the first tab of the jobs screen of the vocational edition may provide input fields for a user's current or past jobs. This allows for advanced, inclusive, and complicated searches using any combination of text, industries, jobs, work characteristics, temperaments, skills, or specific occupational characteristics. In this specific edition, however, since many do not utilize a “black box” approach, alternative job listings are provided using their manual technique listings.

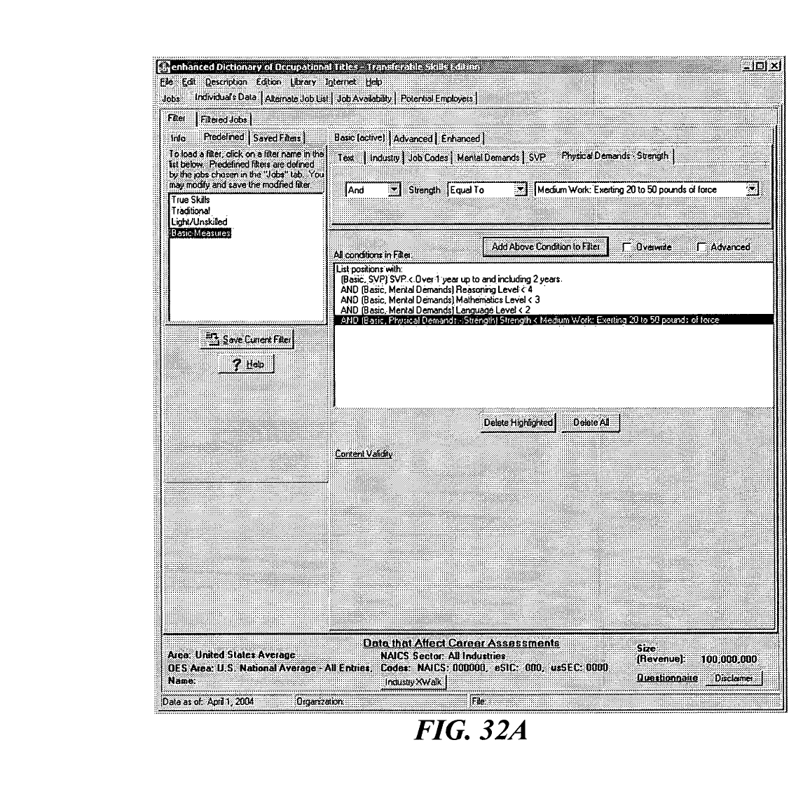

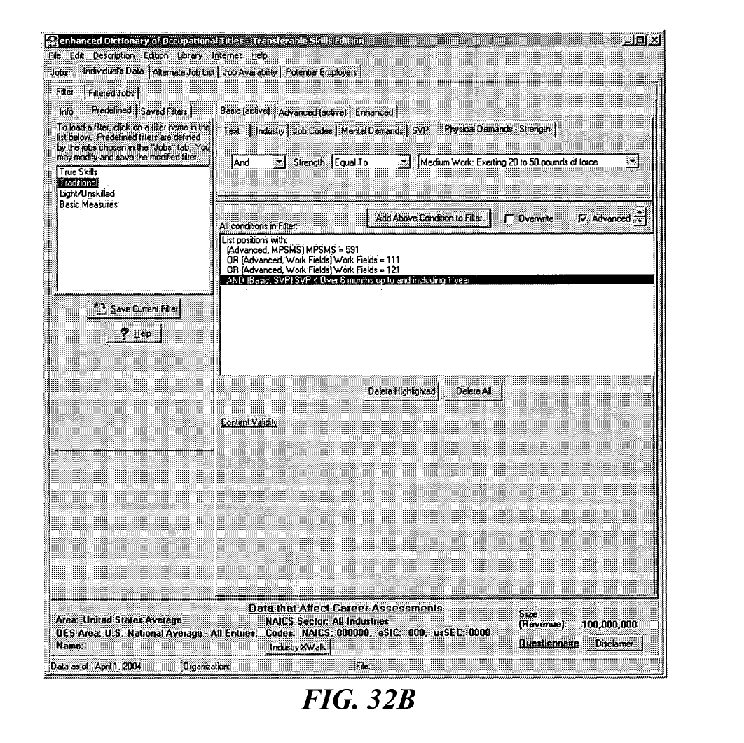

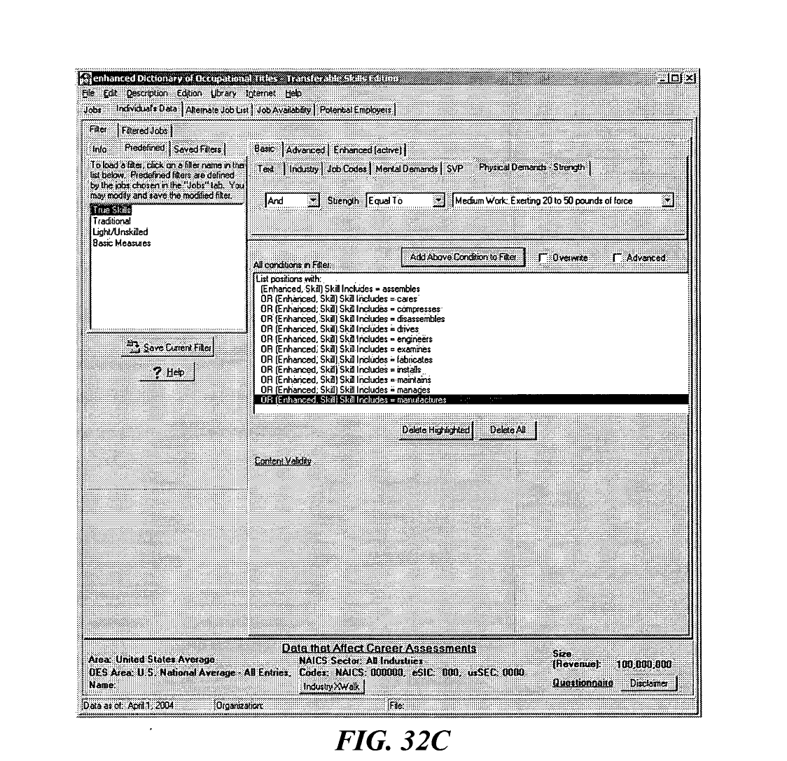

Referring to FIG. 32A, the occupational (transferable skills) edition includes a basic menu, which is the first of many “macro” filters provided in this edition. In addition, users may create their own basic menus and save them to a custom version of a job screen. The listing generated by the basic menu filter is a listing of occupations, not skills. Thus, a more accurate name for this filter might be a “transferable occupations assessment” filter.

Referring to FIG. 32B, the occupational (transferable skills) edition includes a traditional macro filter that provides a transferable occupation assessment using several factors common to commercial products (e.g., work fields, specific vocational preparation, etc.). Various codes associated with this type of assessment are captured into a buffer as a result of a job selection by the user (present, previous, and trained for). Once entered, these series of the facility accumulate these codes into the filter. The facility then selects jobs that have any of these codes (as the filter uses a logical “or”). The result is a listing that users in the vocational rehabilitation community may quickly understand.

Referring to FIG. 32C, the occupational (transferable skills) edition includes a true skills filter that provides a true list of skills and an assessment of transferable skills. This focus on skills, rather than job titles, physical or mental demands, or other work measures is not found in other systems. It uses a skills inventory initiated by the facility, which has “scraped” (or captured) these skills across all occupations in the collection. The true skills filter is applicable in the areas of workers' compensation, organization planning, recruitment/staffing, and compensation. The true skills filter is useful to illustrate these skills and their relationships and gives an overview of other ongoing system designs that are creating skills-based pay analyses, searching and capturing jobs on Internet job boards, and, as shown in FIG. 33C, an application in the workers' compensation edition. Skills as used in this way by the facility are typically depicted as verbs.

Referring to FIG. 33A, the workers' compensation edition menu screen describes the diversity of approaches and forms found in this accident-based, short-term welfare insurance system. In the U.S., each state has, under states' rights, the ability to set its own standards, regulations, and laws. The process, however, is always the same: a worker is hurt, the part of the job that relates to the injury is analyzed, the form is either sent to a physician or sent with a physician's statement to the insurance entity (which may be a state-owned fund, a self-funded organizational plan administrator, or a private carrier). Because each state has its own laws and definitions of disability, the forms for job analysis differ. Via the workers' compensation edition, the facility captures and incorporates each state's form, creating a way to contribute changes made to work measures to the raw data database found on the server computer.

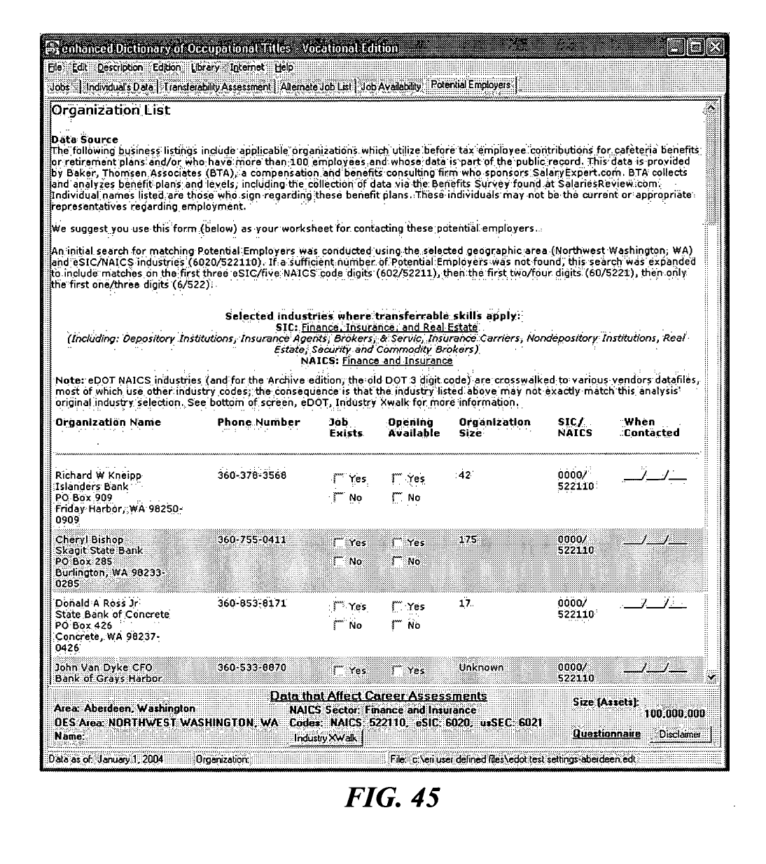

Referring to FIG. 33B, the workers' compensation edition may provide different forms for different states. These forms mirror the initiation form for claims for either unemployment compensation and/or the filing of a workers' compensation claim. They are not job analysis forms completed by a user reviewing the work content of a job, but rather the form that creates the basis by which a claim is first opened. The provided forms may be either skill or occupational title based and lead to assessments of other jobs in the marketplace by which an unemployed or injured worker may gain meaningful employment. The forms produce a listing of potential employers shown in FIG. 45.

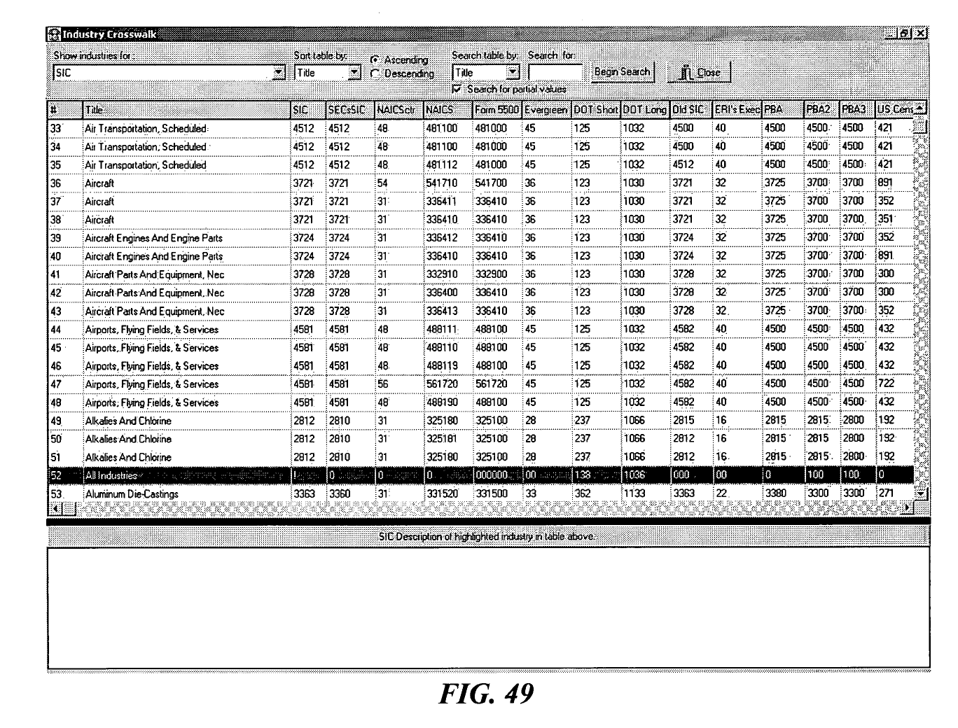

Referring to FIG. 33C, the workers' compensation edition (as well as the vocational rehabilitation edition) may have its own version of a job screen from which a user can access several tabs. FIG. 49 illustrates the State of Ohio's unique approach that is now being utilized in that state's transitional grant program. Instead of allowing for assessment of the occupation, the forms allow for the determination of the measures for each skill associated with that occupation. With a skills-based assessment, this functionality may be used to determine that a worker is not disabled if the injured worker's occupation can be redefined into one with skill sets that are not affected by an injury.

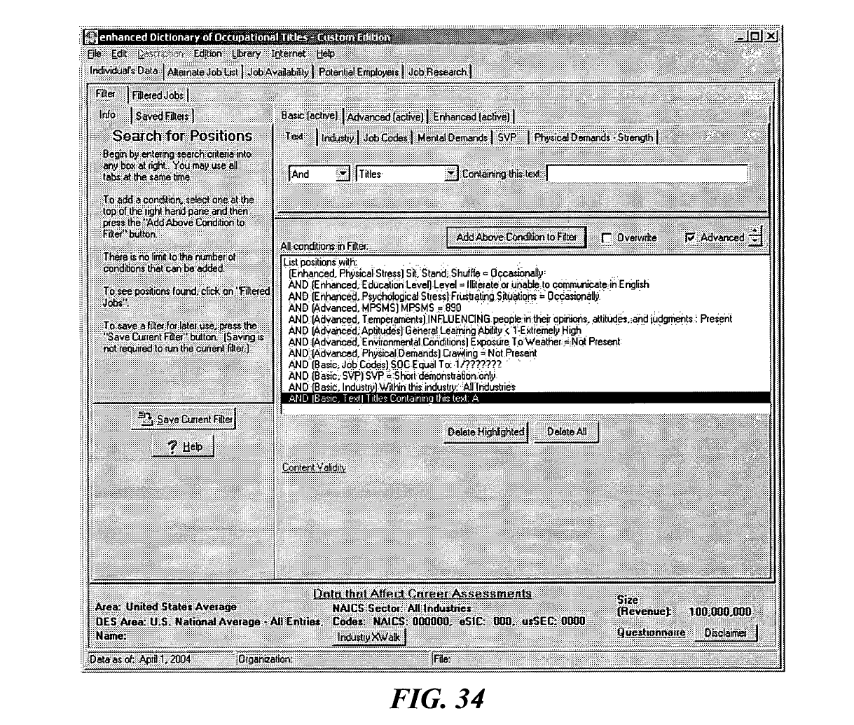

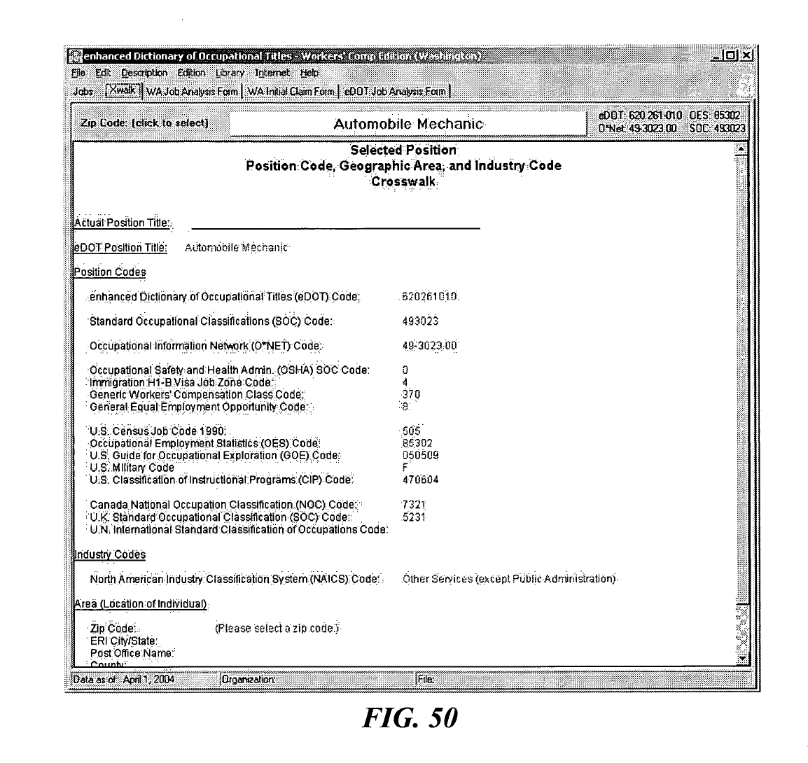

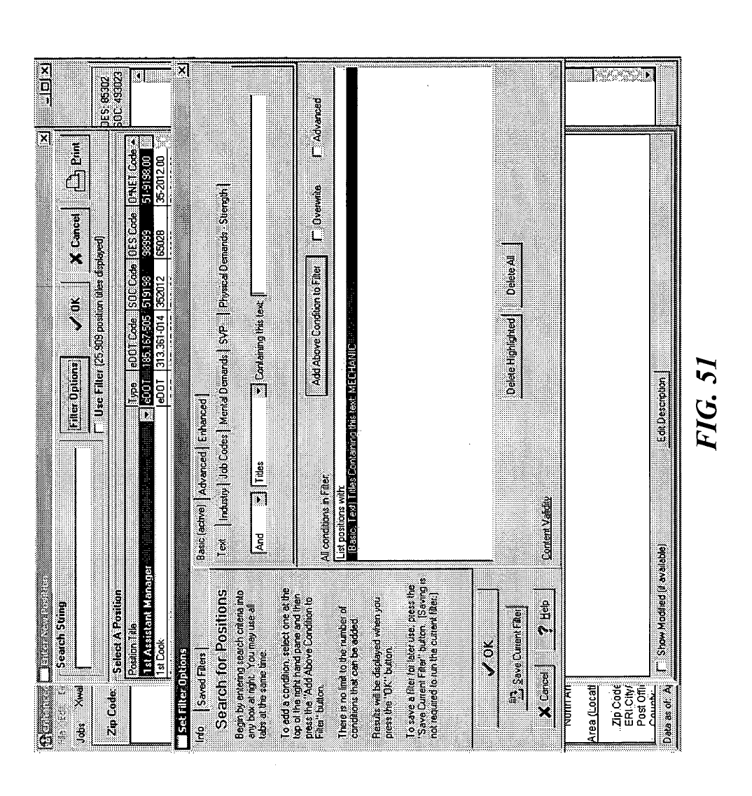

Referring to FIG. 34, the custom edition may have its own versions of a job and other screens from which a user can access several tabs. A set of tabs or filters for selecting alternative jobs may be provided based on, for example, the measures selected by which to sort and select other jobs. The custom edition may provide basic, advanced, and enhanced work measure options. FIG. 50 illustrates a collection of many possible filters selected by a user on a “custom” basis to be further described in FIGS. 51-60. These filters allow the user to search for jobs based on key words in the job title or description. The user can also use work measures to further refine search results.

As described in part above, the system employs one or more macro filters that allow users to extract information from the collection of occupational information. In this way, different users can use the information in the collection for different purposes. For example, some users may wish to conduct a transferable skills analysis, while others may simply be seeking information to facilitate career decisions. Various professions have, over the years, defined the manner in which these assessments are made and these “macros” are captured.

The implementation details for these filters may vary. For example, a user may select a preset filter associated with a specific use (e.g., vocational planning, disability assessment (varying by state), transitional skills assessments, etc.). Preset editions and filters exist from an assessment of an individual's “interests” to that of using the U.S. Social Security Administration's Residual Functional Capacity desktop worksheets. Likewise, the facility may provide a powerful, all-inclusive filter (or set of macro filters) for selection of positions, as shown in FIGS. 35-39F. The following Figures and associated text illustrate the application of a unique “custom” filter capability available for use on a client computer.

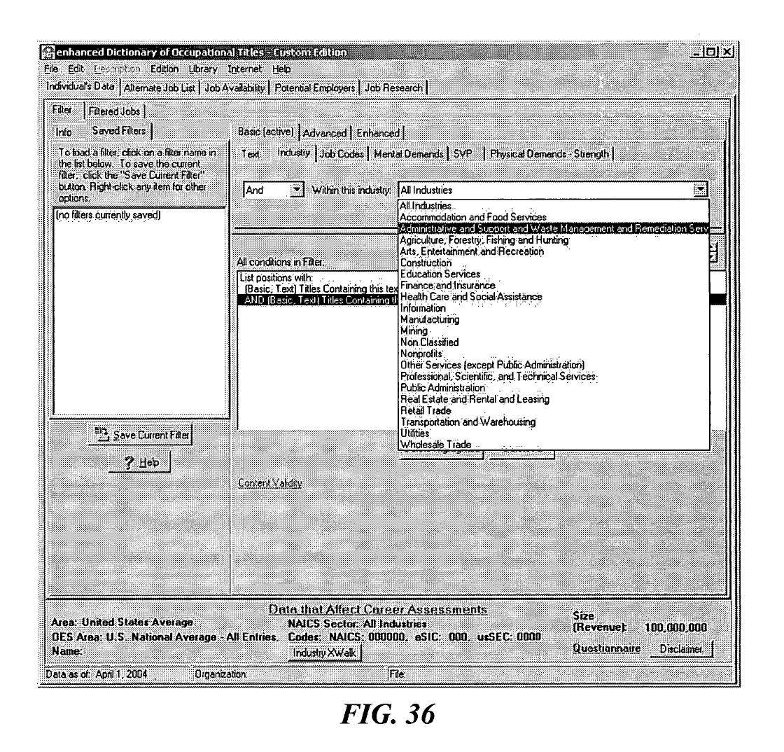

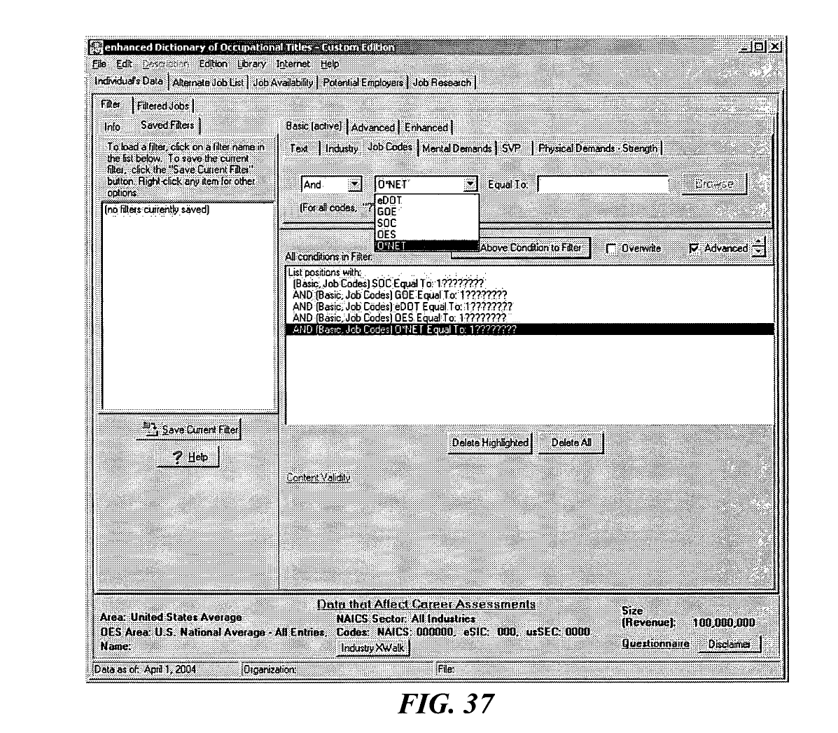

Referring to FIGS. 35-39F, filters can be grouped into divisions. For example, as shown in FIGS. 35 and 36, the facility can utilize a text and industry filter (text-based searching based on the job title or the job description, searching whole words or text strings). Referring to FIG. 37, a job codes filter provides searching based on the most common of the U.S. job codes, such as the General Occupational Exploration code or the SOC, OES, or O*NET. The job codes filter includes a basic attributes filter, which provides searching based on the five most commonly used attributes of the DOT's occupational characteristics (SVP, math, language, reading, strength, etc.).

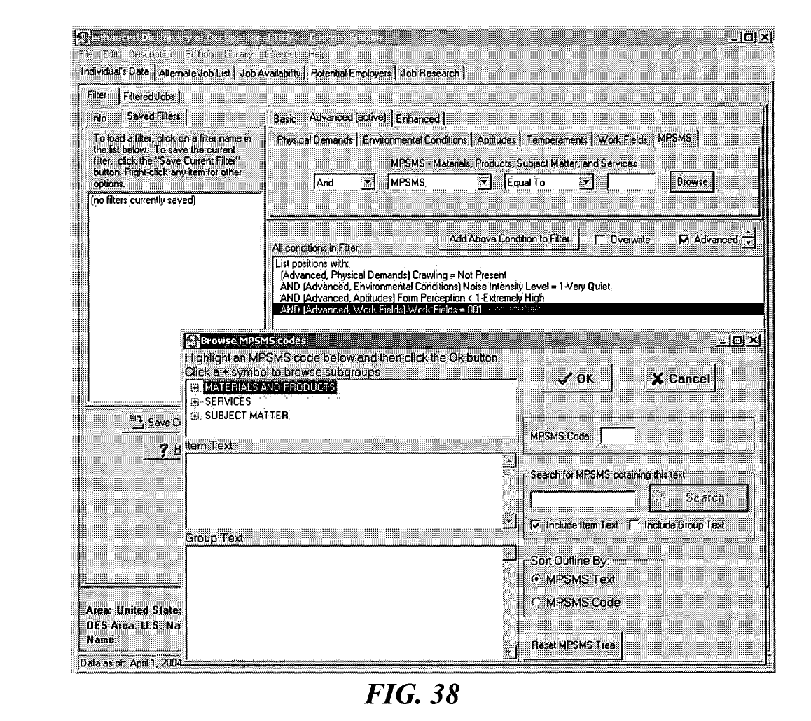

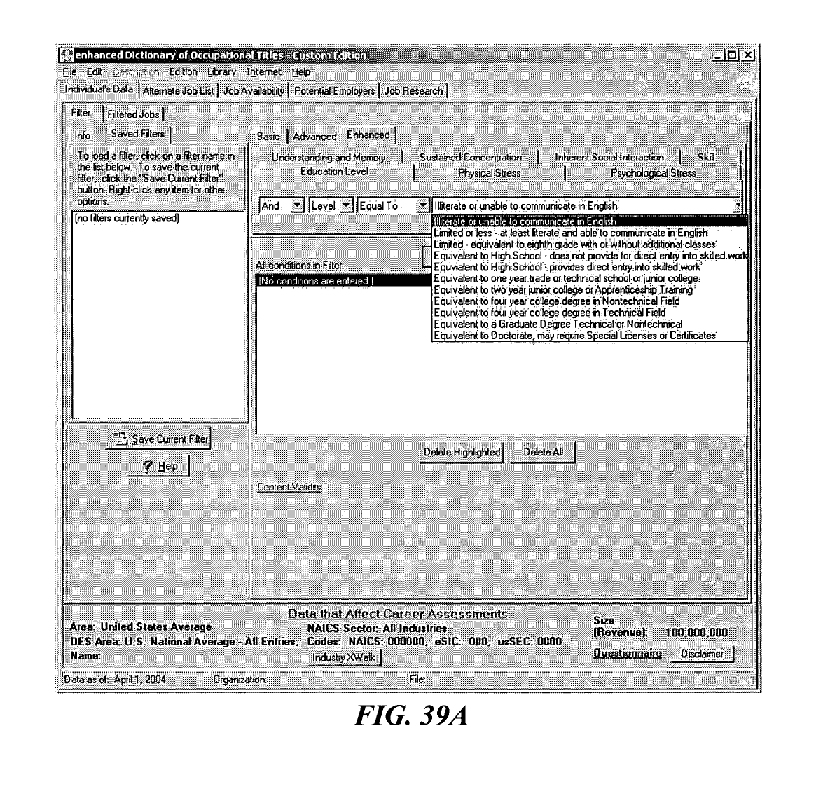

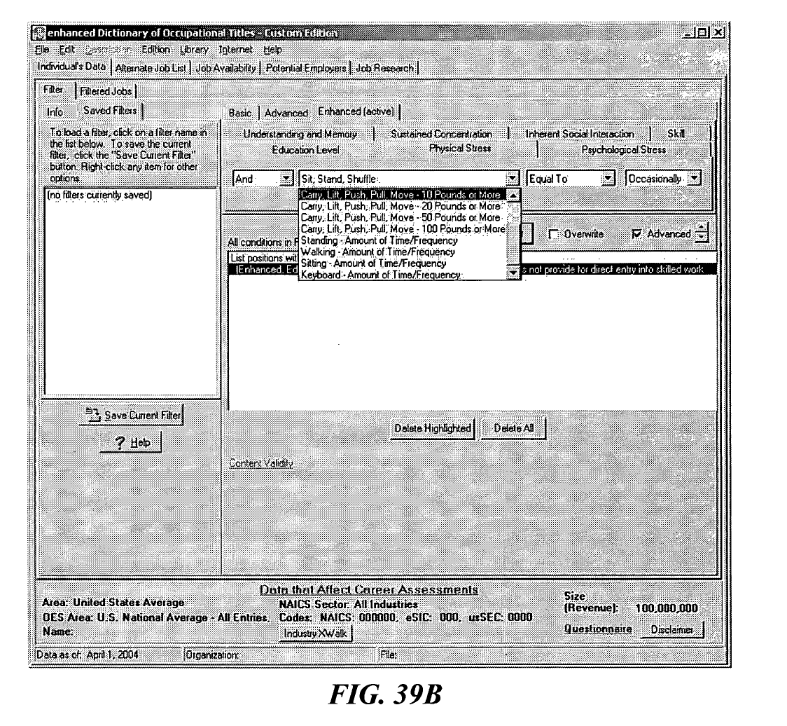

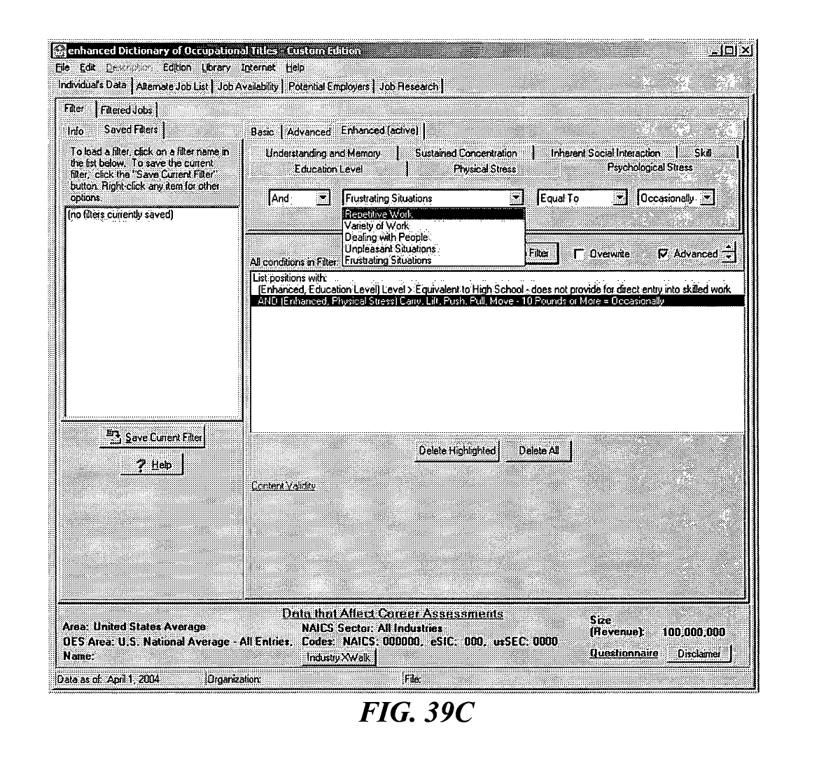

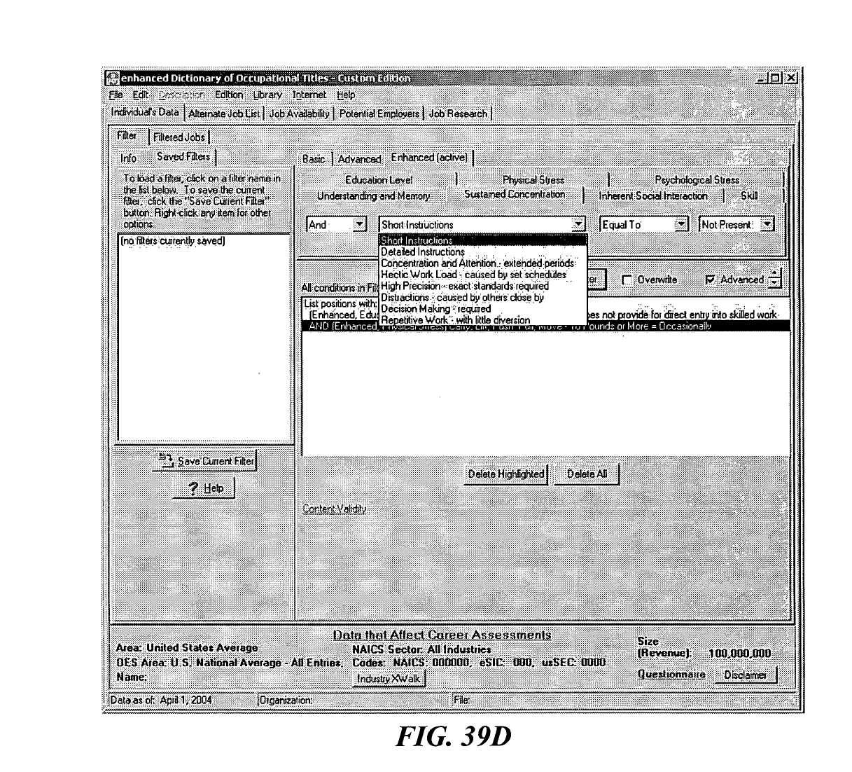

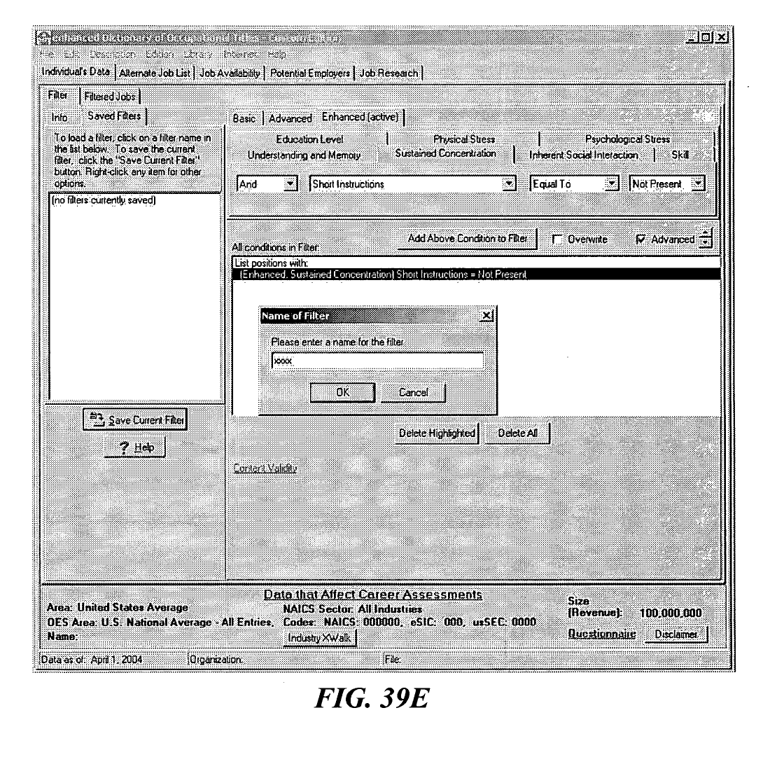

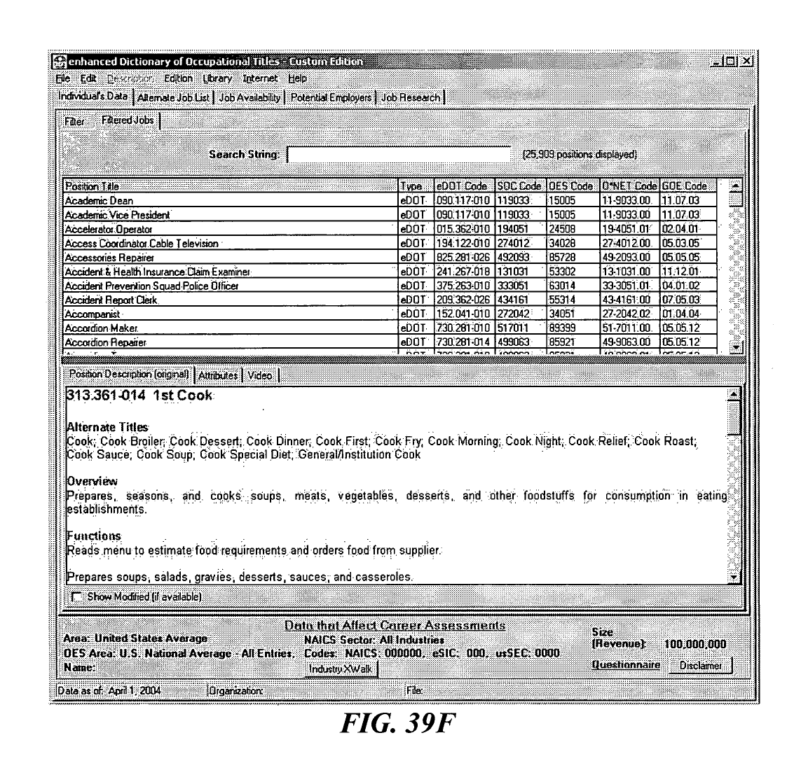

FIG. 38 illustrates an advanced filter that provides searching based on sixty-one attributes of the DOT's occupational characteristics, which are then broken down into categories, including physical demands, environmental aptitudes, temperaments, work field, and MPSMS (materials, products, subject matter, or services). Referring to FIGS. 39A-39F, the facility may provide enhanced filters using new measures identified as necessary for disability determinations and accuracy in describing work in modern-day America. These categories can be divided into educational level, physical stress, psychological stress, understanding and memory, sustained concentration, inherent social interaction, and skills (true skills).

These filters utilize an enhanced filter's sort/search methodology where greater than, equal to, and/or less than comparisons may be set. By the use of the words “or” or “and,” these searches may be combined in various combinations as shown in FIG. 39D. FIG. 39E illustrates that these filters, once determined, may be saved by a user for future use. FIG. 39F illustrates an example of a filter result using some of the search alternatives previously described.

VI. Results Screens (Tabs and Records)

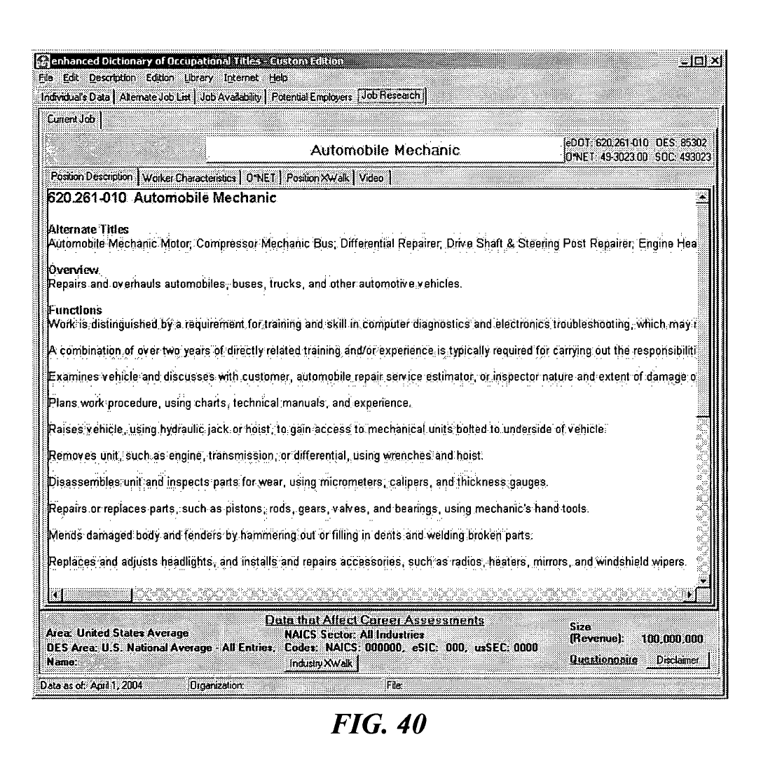

Referring to FIG. 40, a jobs tab screen includes several options for a user to view information. Each time a position is added to the jobs tab, the work measures are collected into a program buffer on the client computer application. Up to five previous positions can be added (with all those measures also being added to the buffer). The facility allows the inputting of “job trained for” information for disability and employment assessments. This provides a complete coverage of job demand and work measures that can be utilized. In the illustrated embodiment, the job example shown (automobile mechanic) has computer diagnostics as a task requirement. When compared to the archive edition's similar screen shown in FIG. 40, a more modern description is provided. For example, computer diagnostics were not part of an auto mechanic's job description in the 1970s.

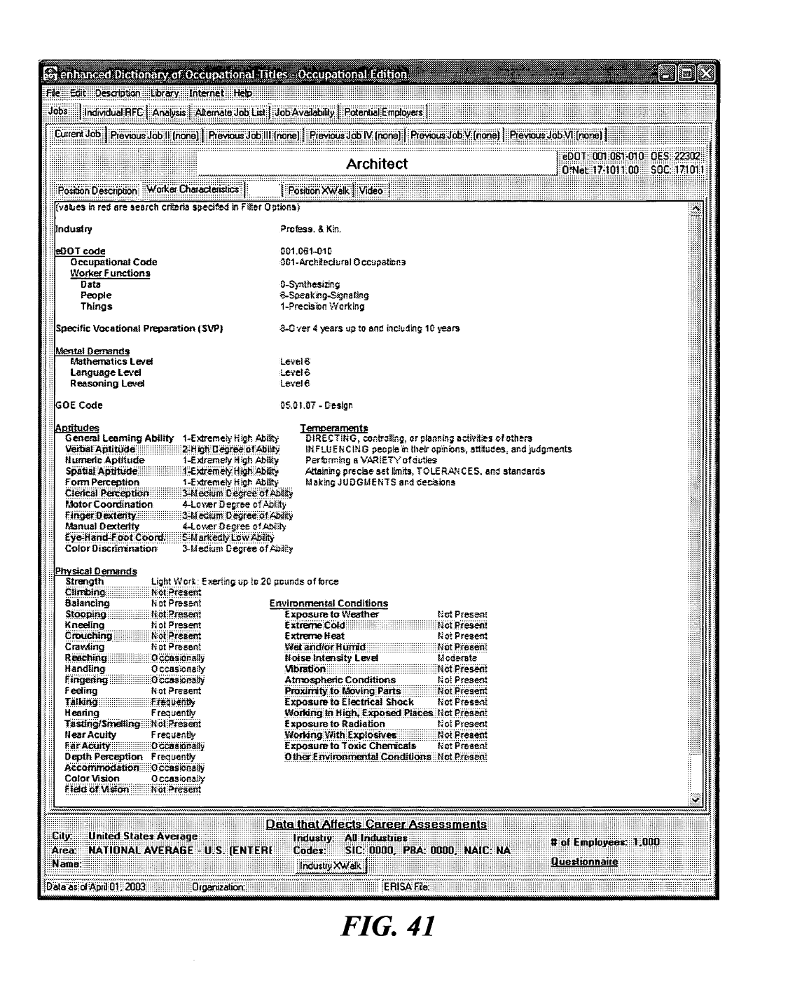

Referring to FIG. 41, the facility provides a worker characteristics or demands screen for a selected job (e.g., architect). The screen can be viewed in a worker characteristics tab of the jobs screen on any edition. This screen includes original DOT measures, should they exist. For new jobs that have emerged into the economy since the last DOT was published, the DOT column is left blank. The old comparison measures are, of course, always blank for the new worker measures (also called “specific characteristics of occupations”) added into the system as described in FIGS. 39A-39F. The column of measures for the system may contain data different from the archive edition as these measures are drawn from averages created from the server computer's raw data database (reflecting the changing nature of work in America). A third column illustrates Standard Deviations of these computed measures—a “rate of error” calculation required for use in Federal Courts under Daubert Challenge rules.

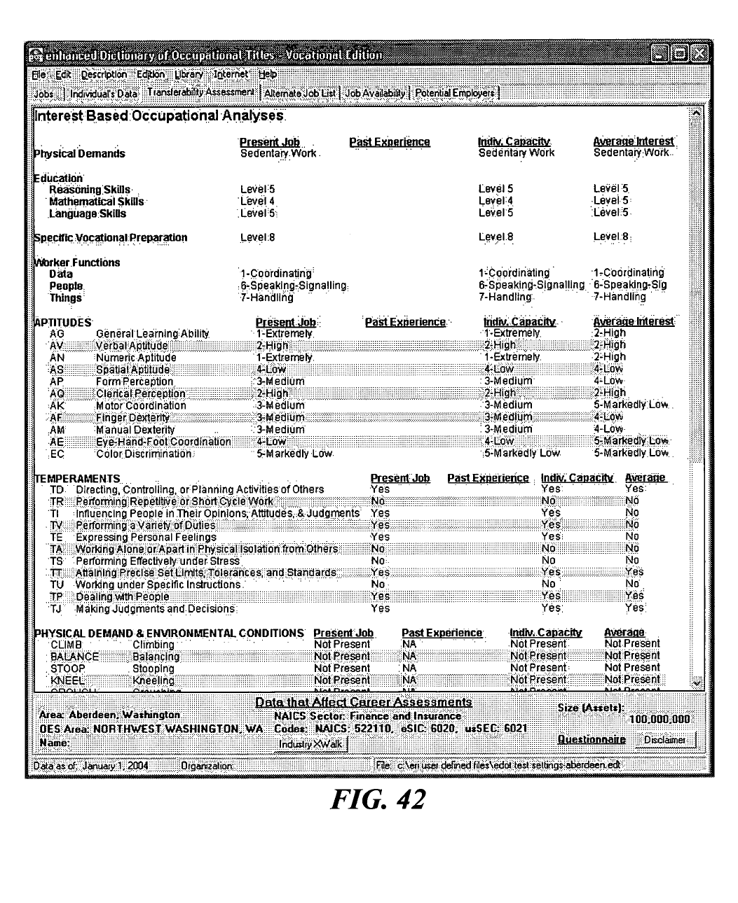

Referring to FIG. 42, the facility provides a transferable analysis assessment. Worker measures, skills, and other job demand attributes are captured for present, previous, and trained-for jobs (depending upon the edition) and held in a buffer. The accumulation of these measures is compared to a second column that may, for example, be the present capabilities of the individual. A third column illustrates any differences between the two, allowing the user to judge the shortfalls that may occur. This format, although now abandoned by the U.S. government, was created during World War II so that soldiers and sailors could quickly be slotted into jobs where their skills and abilities would best fit.

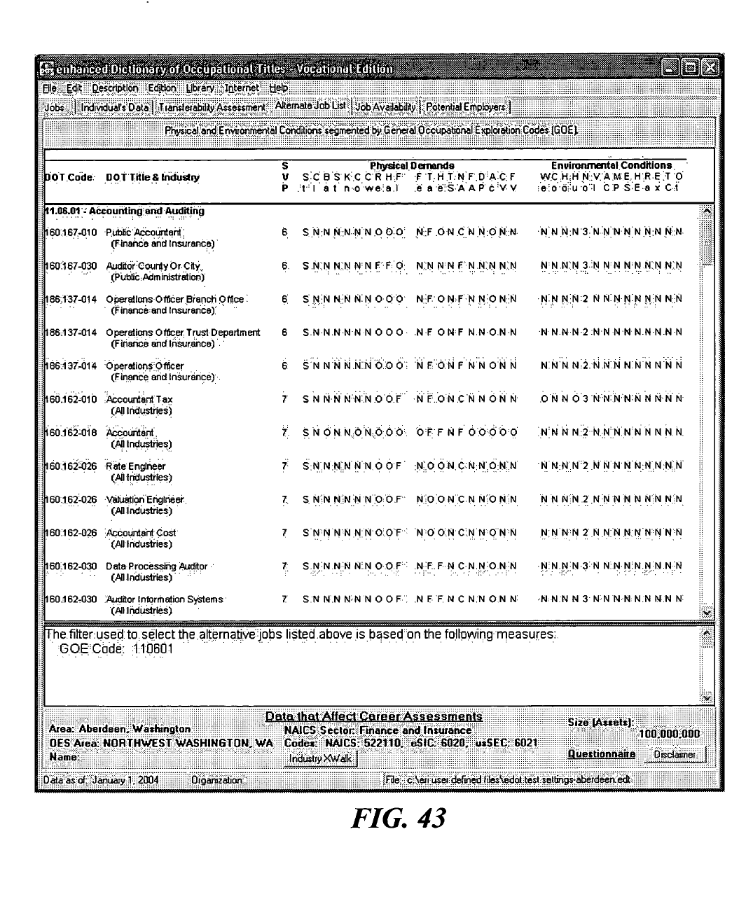

Referring to FIG. 43, the facility may provide an alternative jobs listing. The jobs listed fit the analyses of FIG. 42 in which the facility identified worker measures, skills, etc. that an incumbent might be able to handle. This technique works well if it is applied against a database of updated jobs, job titles, skills, and worker measures, as provided by the facility.

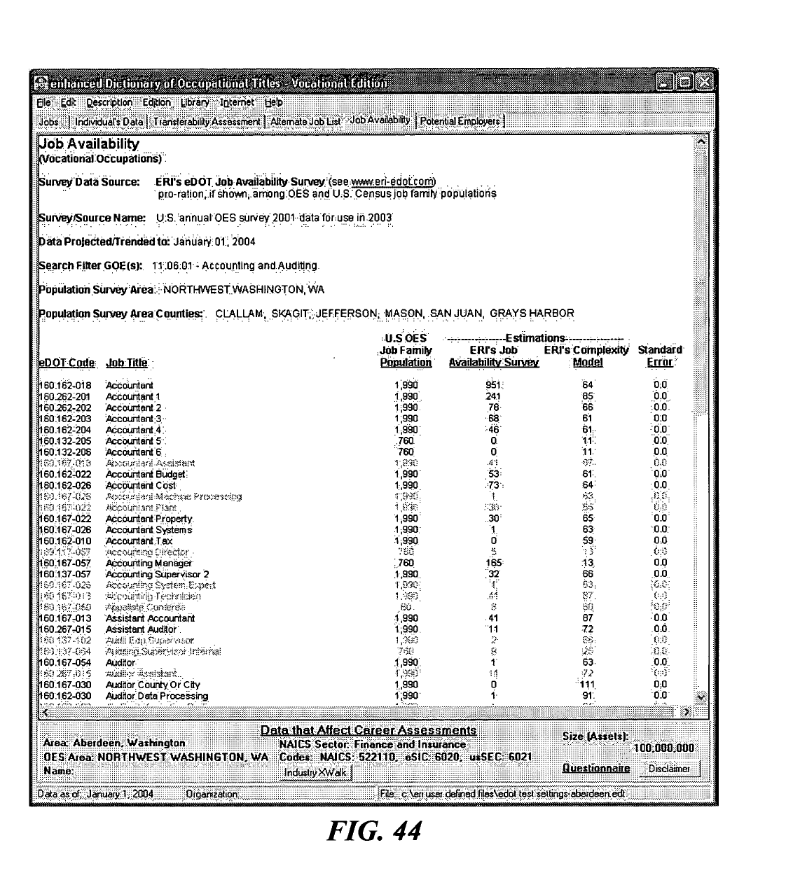

FIG. 44 shows a job availability listing where the alternative jobs identified in FIG. 43 are matched to the job availability survey and modeled under a complexity model that estimates probable specific job populations from within publicly available job family population numbers. The determination of whether alternative jobs exist is meaningless if those jobs do not exist within one's geographic location, country, and/or industry (as older workers are often trapped by industry-specific skills). This information is useful during litigation involving potential employment of a divorced spouse, an unemployed (wrongfully) employee, someone disabled, etc.

Referring to FIG. 45, a potential employers tab allows the user to review a list of potential employers, possibly within given parameters. From this tab, the user can view industry-specific and geographic area-specific listings and listings of potential employers within a specified commuting area and/or industry. In addition, the system may be configured to provide further information and direction to a job seeker (e.g., places to visit, people to call, etc.) The basic data for this aspect of the facility may come from such providers as Info American, Dun & Bradstreet, Larkspur, etc.

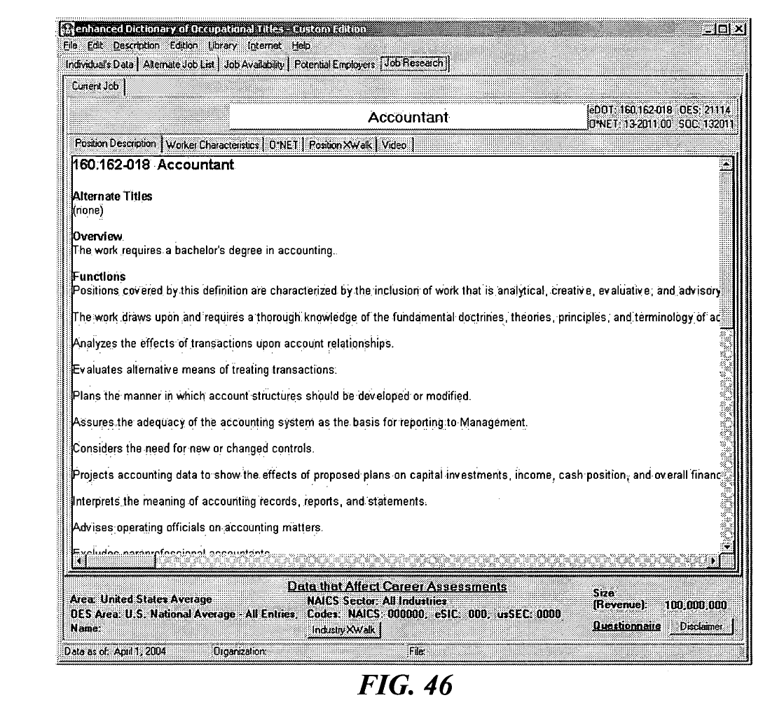

Referring to FIG. 46, the client computer application may provide a link to a job board. As with FIG. 45, this illustrates turning the computer client application (where the screen is supplied by Delphi or other code) into a primitive browser so that an Internet offering may be made. Shown here and described in related patent applications, other examples can be found in FIGS. 15A, 33B, 53, and 54.

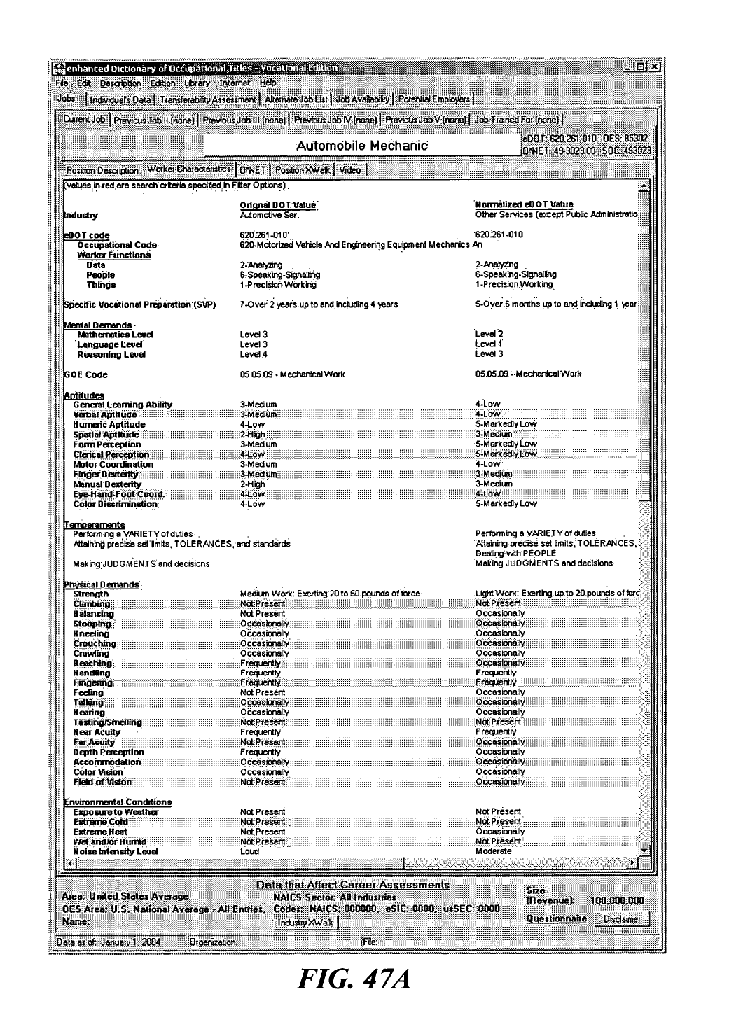

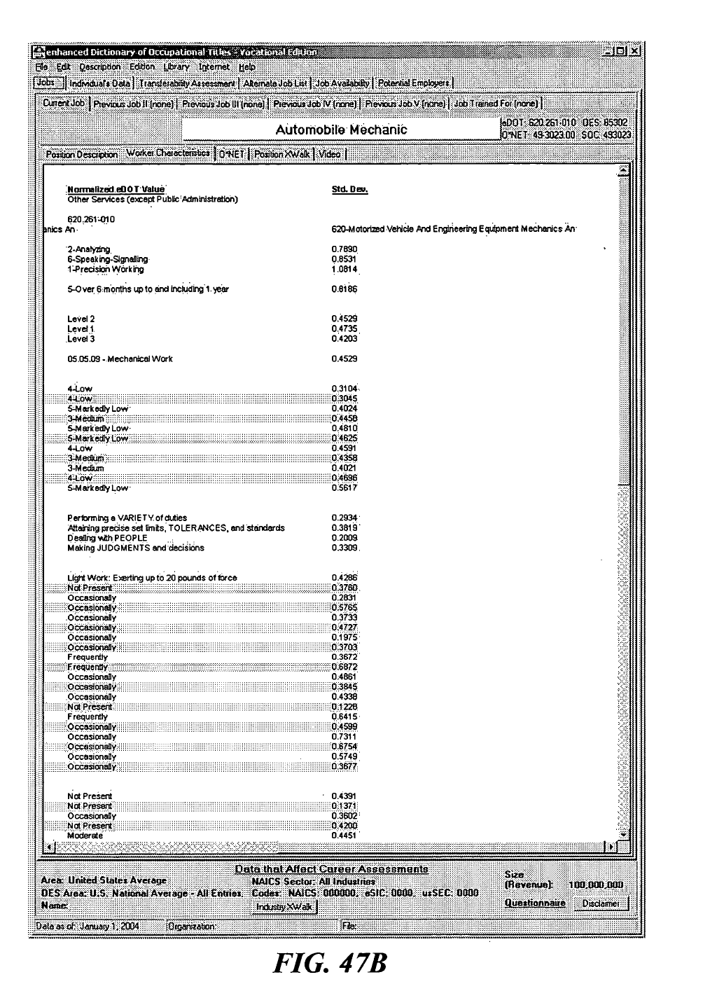

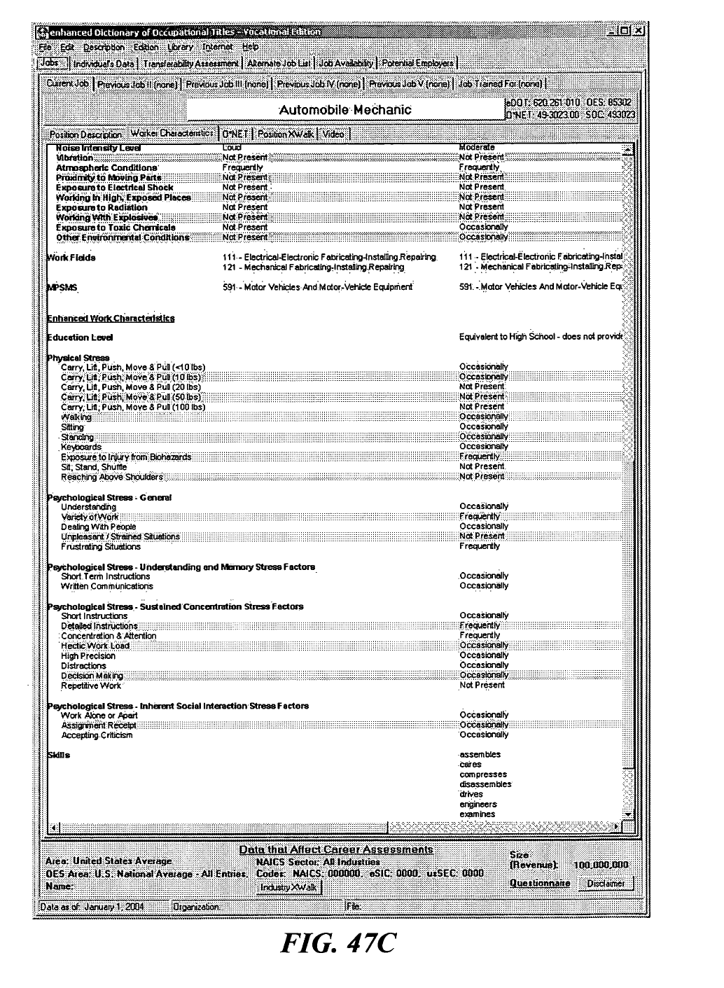

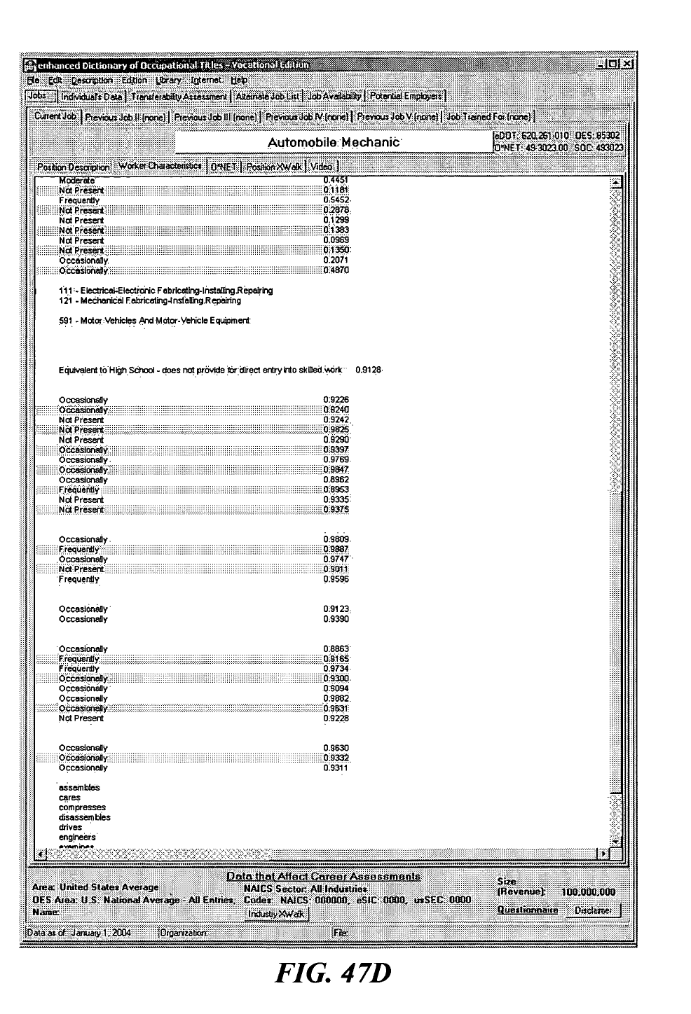

Referring to FIGS. 47A-47D, the facility may provide a generic display of worker characteristics. This display shows the old DOT measures, many older than thirty years, as compared to the measures associated with the collection (along with their related standard deviation). The average of each measure is at a specified level plus or minus a standard deviation or range of measures. The provision of the third column, the standard deviation, now makes this presentation acceptable to Federal Courts that sometimes require a “rate of error.”

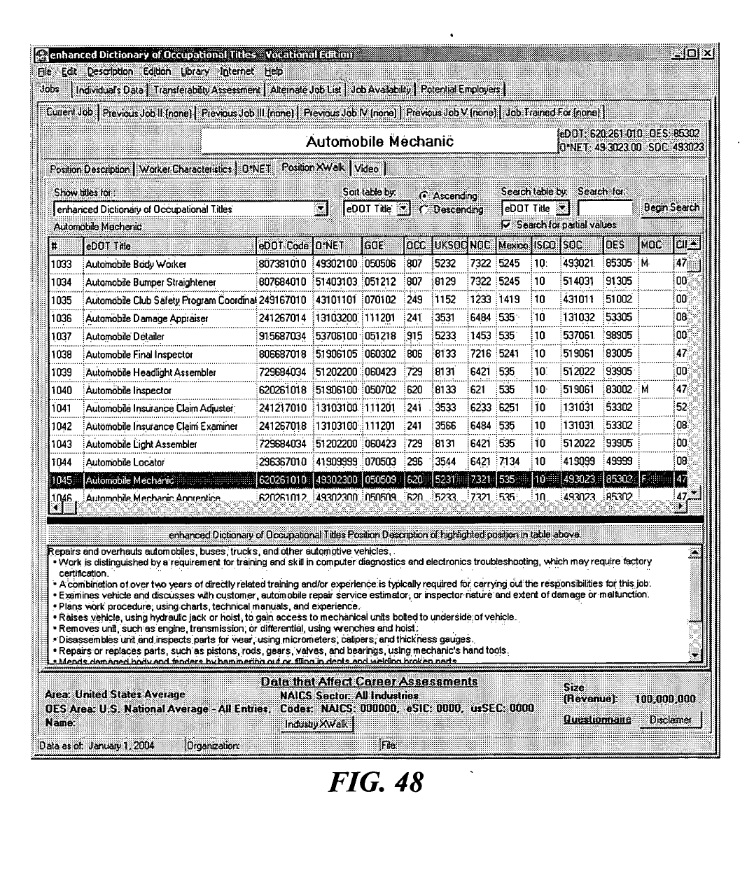

Referring to FIGS. 48 and 49, the system may reference occupations within the collection using a sequence of job codes and industry codes. Some of these codes may correspond to codes associated with other systems. Accordingly, the system may provide one or more screens for job code crosswalks. Users can use the crosswalks to link the collection's job codes with older job code references and the job code references of other systems, such as those used in other countries. FIG. 48 shows an example of a position crosswalk that cross-references multiple job codes. In the illustrated embodiment, the position crosswalk is accessible through a tab on the jobs screen in any edition.

FIG. 49 shows an example of an industry crosswalk that cross-references multiple industry codes. In the illustrated embodiment, the industry crosswalk is accessible via a button at the bottom of many of the job screens, including the job screen shown in FIG. 35. The industry crosswalk of the illustrated embodiment is a conclusive crosswalk of industry codes tying together older U.S. government's systems with the new NAICS (North American Industrial Classification Systems) (Canada has its own NAICS), as well as foreign code systems (e.g., codes from the U.K., Mexico, the UN, and other countries). Results from the crosswalks can be sorted by code, titles, and in a variety of other ways. In some embodiments, both the job code crosswalk and the industry code crosswalk are derived from databases created and maintained by system administrators, but external sources may also be used.

Referring to FIG. 50, an application of these crosswalks can be found on the Workers'Compensation edition. Both the U.S. OMB and OPM have mandated that agencies utilize the new O*NET-SOC classification system, and that it replaces the DOT in its entirety. This places burdens on state governments that have been using the DOT codes for 65 years. FIG. 40 illustrates a report outcome (via screen or printed report) by which individuals may crosswalk all codes found in these various systems. (Note: although the U.S. government may “mandate” use of a new system, for example, use of the NAICS industry code, certain governmental entities (such as the SEC) continue to use their own SIC codes. As another example, state governments are required to report “on the job deaths” to the U.S. OSHA in a format where a specific job is identified (not just by the O*NET-SOC job family number).

Referring to FIG. 51, the facility may use mathematical algorithms to assist in its identification and selection of jobs filtered for selection. These algorithms and a browse function available via a job, position description, past or prepared-for job screen allows a series of preset filters to segregate jobs. These browse functions and algorithms are characteristic to all claimant's products as described in FIG. 3 (348a-348e).

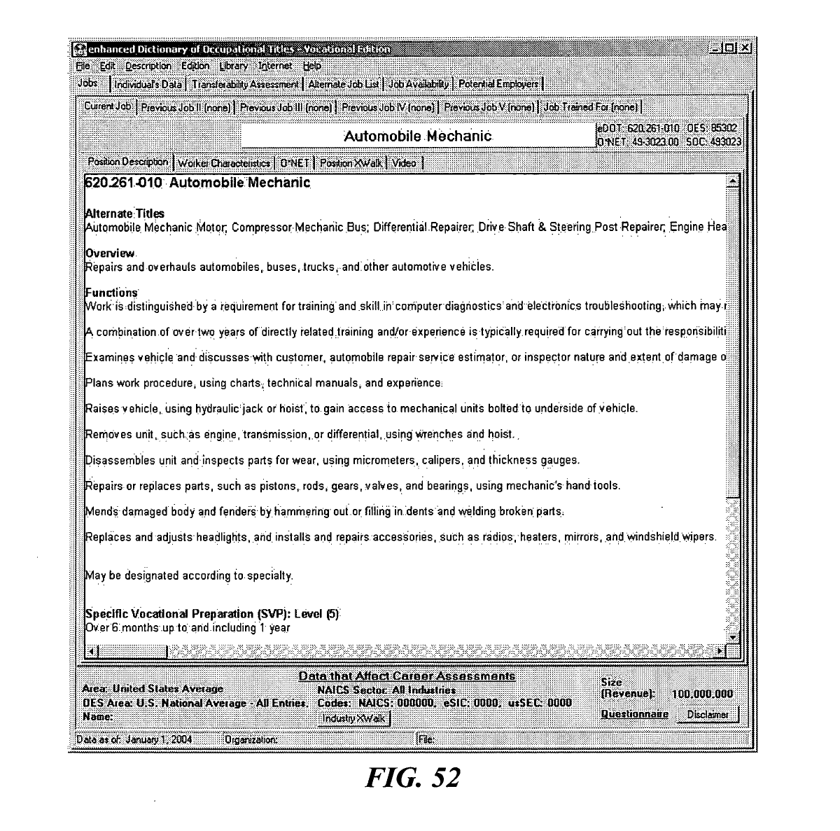

Referring to FIG. 52, the client computer application contains a job screen. This screen is designed, for example, for the automobile mechanic who has gone to law school at nights and passed the bar exam. Transferability assessments that focus on only present or previously held positions would miss these added capabilities, which may or may not be included in a Transferability Assessment, as shown in FIG. 42.

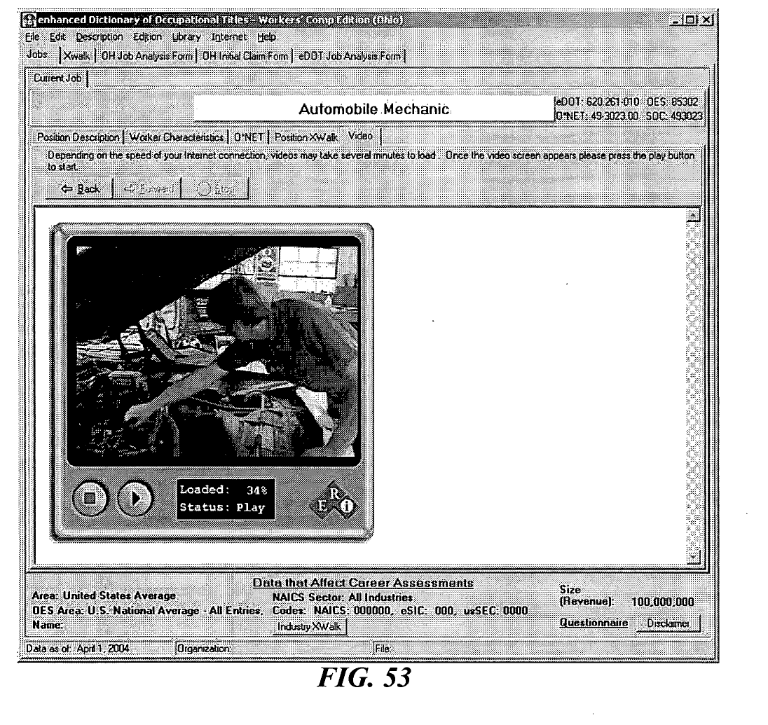

Referring to FIG. 53, additional features that may be provided include video streaming that shows video descriptions of job positions. These videos may be incorporated within a Delphi Pascal browser shell so that they might be an integral part of a job description presentation and/or used for job analyses. Videos can also be implemented using a Flash insert or projector. The facility houses the ability to utilize nonproprietary videos obtained from sources, as well as in-house video productions. Videos can be created for job families or for all jobs found within the collection of occupational information. These videos can be used for information purposes, JAW applications for the blind, and other unique implementations.

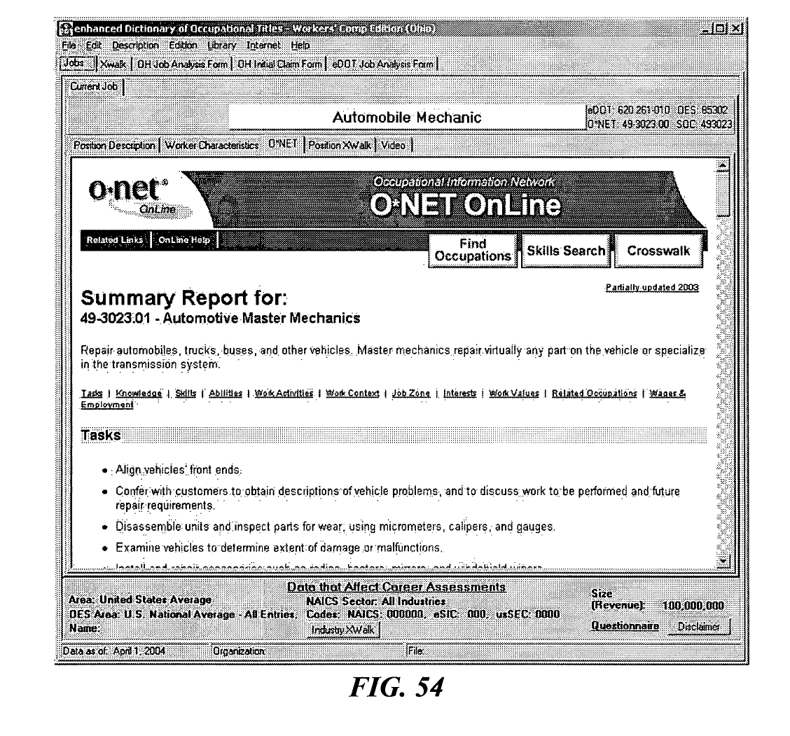

Referring to FIG. 54, an example screen illustrating the integration of other source data, noncopyrighted sources such as the O*NET-SOC data available in the public domain (linking the facility's specific job to the O*NET-SOC job family).

Aside from the features described in relation to the various screens and tabs above, the system may also provide other features associated with the collection of occupational information. For example, a course such as a distance learning course may be offered that is specifically designed to assist in the training of job analysts. Such courses are supplemented with the job description information provided by the system. Certificates of course completion may be provided as a means of recognition and quality control. Videos may be used to analyze jobs as part of the course curriculum. Further details associated with similar courses can be found in the description associated with U.S. patent application Ser. No. 09/849,454 (incorporated herein by reference).

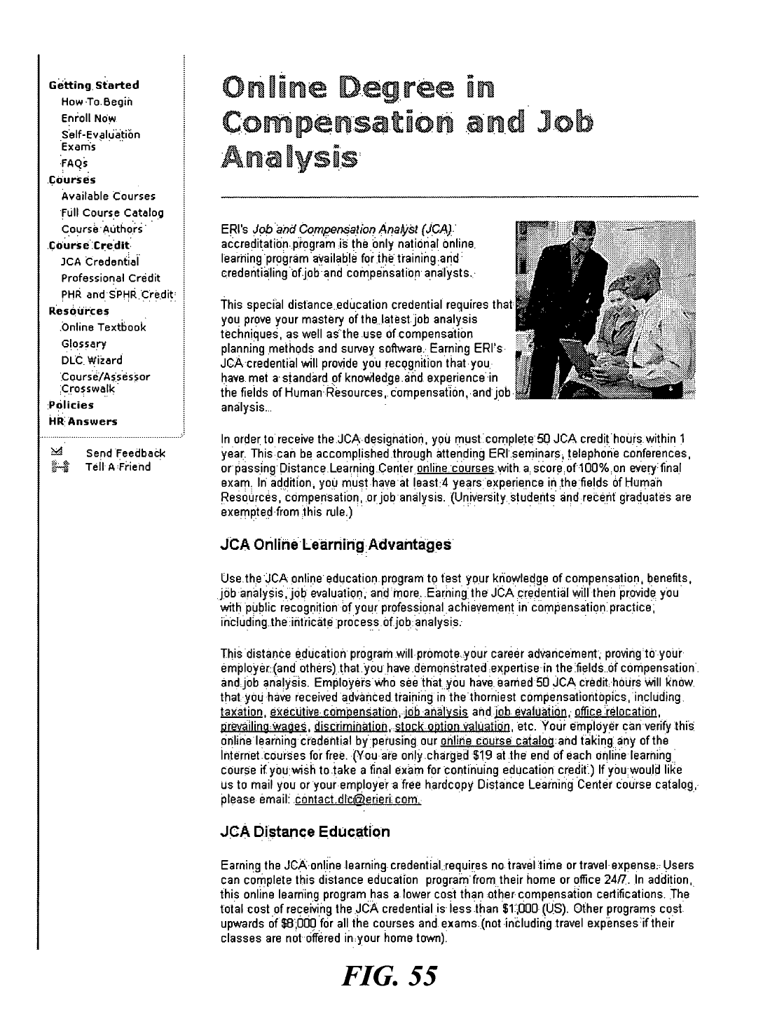

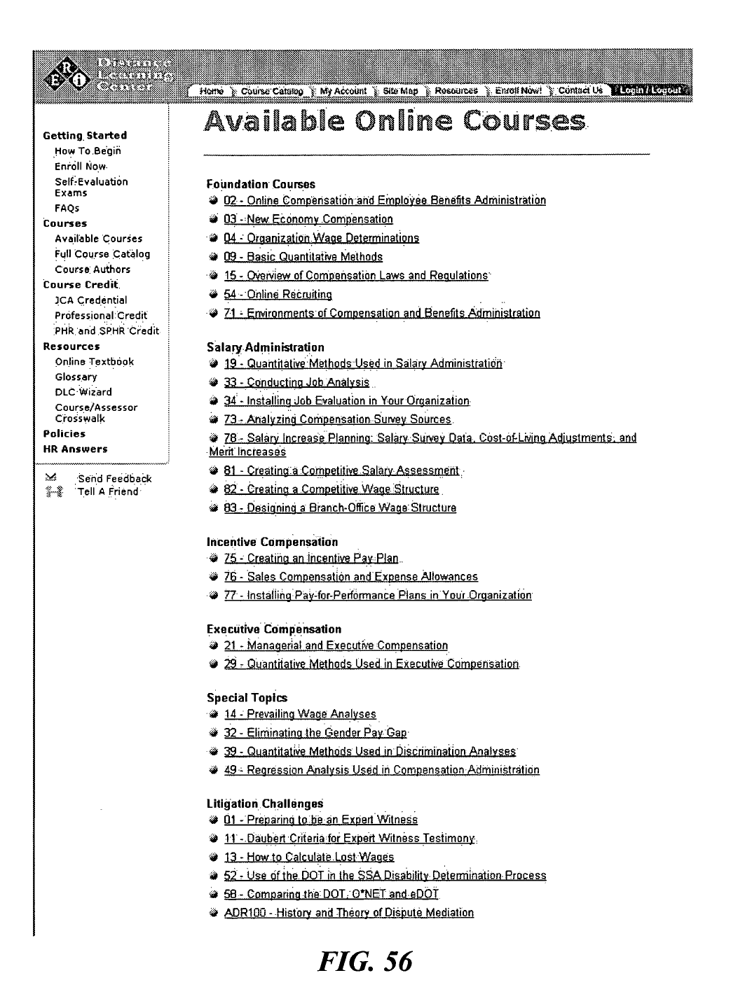

Referring to FIG. 55, a certificate program (e.g., Job and Compensation Analyst (JAC)) may be offered in conjunction with the collection of occupational information. In some embodiments, the certificate program may be similar to an automobile mechanic's certification. It may be especially designed for users of the facility, including related database products and those who use the JAQ, DAQ, and other job analysis questionnaires, such as those described in FIGS. 15A and 15B. As illustrated, it may be offered as on online course through a distance learning program. Examples of courses that may be made available for this course are illustrated in FIG. 56 and may include foundation courses (e.g., Basic Qualitative Measures, Online Recruiting, etc.), salary administration courses, incentive compensation courses, etc.

### VII. CONCLUSION

One skilled in the relevant art will appreciate that the concepts of the invention can be used in various environments (e.g., those other than the Internet). In general, a display description may be in HTML format, email format, or any other format suitable for displaying information (including character/code-based formats, algorithm-based formats (e.g., vector generated), and bitmapped formats). Also, various communication channels may be used, such as a local area network, a wide area network, or a point-to-point dial-up connection, instead of the Internet. The server system may comprise any combination of hardware or software that can support these concepts. In particular, a Web server may actually include multiple computers. A client system may comprise any combination of hardware and software that interacts with the server system. The client system may include television-based systems, Internet appliances, and various other consumer products through which auctions may be conducted, such as wireless computers (palm-based, wearable, mobile phones, etc.). Moreover, the concepts of the present invention may be applied to auctions that are not supported by computer systems or that are only partially supported by computer systems.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Additionally, the words “herein,” “above,” “below,” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. Where the context permits, words in the above Detailed Description using the singular or plural number may also include the plural or singular number, respectively.

The teachings of the invention provided herein can be applied to other systems, not necessarily the system described herein. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I/we claim:

1. A system for collecting and providing occupational information for use by consumers of occupational information, wherein at least some of the collecting and providing of occupational information is facilitated via a communication network, the system comprising:
a network for facilitating communication between or among one or more aspects of the system;
a server computer connected, at least at times, to the network, the server computer comprising:
at least one data storage component storing information associated with a collection of occupational information;
an access component for providing access to the collection of occupational information via the one or more networks; and
a data collection component associated with collecting information for updating and maintaining the collection of occupational information by communication with other computers via the network;
a client computer connected, at least at times, to the network, the client computer comprising:
a client computer application including data associated with a collection of occupational information, wherein the client computer application provides an interface for a user of the client computer to access at least a portion of the data associated with the collection of occupational information, and wherein the client computer application collects user input provided by the user of the client computer via the interface and transmits it to the server computer via the network; and
a processor for processing instructions associated with the client computer application; and
a peripheral server computer connected, at least at times, to the network, the peripheral computer includes a server application that provides occupational information to users of client computers via the network and collects occupational information from the users of client computers via the network.

2. A method for collecting and providing occupational information, the method comprising:
providing occupational information via a plurality of access points, wherein the access points include access points associated with a client computer application and access points associated with a server computer application;
collecting data indicating an interest in a job or position by a user of the provided occupational information, wherein the collecting of data is associated with a user's access of the provided occupational information; and
incorporating the collected data into a job count, wherein the job count provides estimates of available jobs based on the collected data, and wherein the job count counts specific jobs and not job families.

3. A method for providing and collecting information associated with a collection of occupational information, the method comprising:
providing a publicly available web site for users of occupational information, wherein the publicly available web site allows the users of occupational information to access information associated with the collection of occupational information and to contribute information used to update the collection of occupational information;
providing access to information recently contributed via the publicly available web site, wherein the recently contributed information includes information contributed using questionnaire forms provided on the publicly available web site, wherein the questionnaire forms are configured for completion by the users of occupational information, and wherein user input associated with the completed questionnaire forms is used to update the collection of occupational information; and
updating the collection of occupational information based on receiving a submission of an at least partially completed questionnaire form.

4. A computer-readable medium containing a data structure for use in a method for providing and maintaining occupational information, the data structure comprising:
a first set of work measures relating to stress induced by a specific occupation;
a second set of work measures relating to skills used in the specific occupation;
a third set of work measures relating to demands associated with the specific occupation; and
wherein each of the work measures in the first, second, and third sets is associated with standard deviation information.

5. In a computer system, a method for maintaining a collection of occupational information, the method comprising:
collecting occupational data from a computer resource distinct from the collection of occupational information, wherein the computer resource obtains occupational data from a user by a method comprising:
receiving a request for information from the user, wherein the information is associated with a specified occupation;
in association with receiving the request for information, requesting that the user provide occupational data about the specified occupation; and
receiving and storing the requested occupational data; and
updating the collection of occupational information using the collected occupational data.

6. The method of claim 5 wherein the computer resource is a salary information resource and wherein the request for information from the user is a request for salary information.

7. The method of claim 5 wherein the computer resource is a job availability resource and wherein the request for information from the user is a request for information about available jobs.

8. The method of claim 5 wherein the computer resource is a career reporting resource and wherein the request for information from the user is a request for a career report based on information provided by the user.

9. The method of claim 5 wherein the computer resource is a disability assessment resource and wherein the request for information from the user is a request for a disability estimate based on information provided by the user.

10. In a computer system, a method for maintaining a collection of occupational information including descriptions of specific occupations, the method comprising:
providing end users with access to the collection of occupational information, including providing access to a questionnaire for receiving input from a user of the collection, wherein the questionnaire is for association with a specified occupation for which information is maintained in the collection of occupational information;
receiving the questionnaire from the end user;
analyzing the information in the received questionnaire;
providing the user with results of the analysis of the questionnaire; and
updating the collection of occupational information to include information extracted from the questionnaire.

11. The method of claim 10 wherein the questionnaire is a job analysis questionnaire.

2. The method of claim 10 wherein the questionnaire is a job analysis questionnaire and wherein the questionnaire is pregraded for the specified occupation.

13. In a computer system, a method for maintaining a collection of occupational information to be accessed by users of the computer system wherein the collection of occupational information includes information for a plurality of distinct occupations, the method comprising:
receiving requests from end users to access information from the collection of occupational information, wherein each request is associated with a specific occupation, and wherein each request includes information provided by an end user;
for each occupation in the plurality of distinct occupations, tracking the frequency of end user requests for information about the specific occupation; and
periodically updating the collection of occupational information, based on the tracking.

14. The method of claim 13 wherein the information provided by the end user includes a title of a distinct occupation.

15. The method of claim 13 wherein the information provided by the end user includes a date of employment.

16. The method of claim 13 wherein the information provided by the end user includes geographic information.

17. The method of claim 13 further comprising for each request, processing the request including generating one or more pages of information about the occupation to be provided to the end user.

18. The method of claim 13 further comprising:
allowing for and tracking the submission of requests for occupations currently not included in the collection of occupational information; and
periodically updating the collection of occupational information, based on the tracking of requests for occupations currently not included in the collection.

19. The method of claim 13 wherein the updating includes removing from the collection occupations for which users do not request information during a given time frame.

20. In a computer system, a method for providing information maintained in a collection of occupational information including information about multiple distinct occupations, the method comprising:
providing multiple search tools, wherein each of the multiple search tools can be used to identify occupations of interest within the collection of occupational information;
receiving from a user a selection of one or more of the search tools;
receiving criteria for each of the selected search tools;
searching the collection of occupational information based on the received criteria; and
providing results of the searching, including providing a list of one or more identified occupations.

21. The method of claim 20 wherein the search tools include a job codes filter that provides user input fields for multiple job code types, and wherein the job codes filter is configured to identify occupations from the collection based on job code type.

22. The method of claim 20 wherein the search tools include an interests filter that provides user input fields for individual interests of a user, and wherein the interests filter is configured to identify occupations from the collection based, at least in part, on interests.

23. A system for providing occupation information, the system comprising:
means for collecting occupational information for multiple distinct occupations, wherein the collection of occupational information includes descriptive information for each of the multiple distinct occupations;
means for providing users with a selection to display specific aspects of each of the multiple distinct occupations; and
means for displaying information for selected aspects of each of the multiple distinct occupations.

24. The system of claim 23 wherein the specific aspects of each of the multiple distinct occupations include an occupation description.

25. The system of claim 23 wherein the specific aspects of each of the multiple distinct occupations include interests-based occupational information.

26. The system of claim 23 wherein the specific aspects of each of the multiple distinct occupations include alternative occupations.

27. The system of claim 23 wherein the specific aspects of each of the multiple distinct occupations include job availability information.

28. The system of claim 23 further comprising means for displaying statistical information about data used in maintaining the collection of occupational information.

29. The system of claim 23 wherein the specific aspects of each of the multiple distinct occupations include job statistics information.
